(19) United States
(12) Patent Application Publication
(10) Pub. No.: US 2024/0072554 A1
(43) Pub. Date: Feb. 29, 2024

(54) PACK DETECTION WITH GALVANIC ISOLATOR FOR PORTABLE POWER PACK CHARGING PLATFORM

(71) Applicant: MILWAUKEE ELECTRIC TOOL CORPORATION, Brookfield, WI (US)

(72) Inventors: Benjamin C. Tesch, Milwaukee, WI (US); David Brochtrup, Menomonee Falls, WI (US)

(21) Appl. No.: 18/454,187

(22) Filed: Aug. 23, 2023

Related U.S. Application Data
(60) Provisional application No. 63/402,315, filed on Aug. 30, 2022.

(51) Int. Cl. H02J 7/00; H01M 10/42; H01M 10/44

(52) U.S. Cl. CPC H02J 7/0042; H01M 10/425; H01M 10/441; H02J 7/0047

(57) ABSTRACT

A portable power supply includes a housing, a control area network (“CAN”) bus, a battery core configured to be charged by a battery core charger, a battery pack charger connected to the battery core and to the CAN bus via a galvanic isolation barrier. A battery management system is connected to the battery pack charger via the CAN bus and a power line and configured to control an operation of the battery pack charger and the battery core charger. A battery pack detection circuit is connected to one or more charging ports of the one or more charging modules. The battery pack detection circuit configured to draw current from a battery pack and produce a battery pack detection signal at battery management system via a galvanic isolation device.

### CROSS-REFERENCE TO RELATED APPLICATIONS

This application claims the benefit of U.S. Provisional Patent Application No. 63/402,315, filed Aug. 30, 2022, the entire content of which is hereby incorporated by reference.

### SUMMARY

A portable power supply may be configured to draw power from a battery core to charge one or more battery packs. A portable power supply including a galvanically isolated battery pack detection circuit may be configured to detect the connection of a battery pack to a battery pack charging port of the portable power supply and begin safely charging the battery automatically.

Embodiments described herein provide a portable power supply including s portable power supply including a housing, a control area network (“CAN”) bus disposed in the housing, a battery core disposed in the housing and configured to be charged by a battery core charger, a battery pack charger connected to the battery core via a power line and to the CAN bus via a galvanic isolation barrier, the battery pack charger including one or more charging modules, a battery management system connected to the battery pack charger via the CAN bus and the power line and configured to control an operation of the battery pack charger and the battery core charger, and a battery pack detection circuit connected to one or more charging ports of the one or more charging modules, the battery pack detection circuit configured to draw current from a battery pack connected the one or more charging ports and produce a battery pack detection signal at battery management system via a galvanic isolation device. The battery pack charger is disposed on a battery pack charger side of the galvanic isolation device, and the battery management system is disposed on a battery management system side of the galvanic isolation device.

Embodiments described herein provide a battery detection circuit include a battery pack charger side including a galvanic isolation device, a capacitor connected in series with the galvanic isolation device and configured to stop a flow of current to the galvanic isolation device when fully charged. The battery management system side of the battery detection circuit includes a transistor including a collector, a base, and an emitter, and a positive logic supply voltage connected to a battery pack detection signal line and to the collector of the transistor.

Embodiments described herein also provide a method of detecting a connection of a battery pack to a portable power source. The method includes conducting a flow of current from a battery pack to a battery pack charger side of a galvanic isolator device, charging a capacitor with the current until the capacitor is fully charged and stops the flow of current to the battery pack charger side of the galvanic isolator device, producing a signal on a battery management system side of the galvanic isolator device in response to the battery pack charger side of the galvanic isolation device receiving the current from the battery pack, and changing a voltage of a battery pack detection signal line based on the signal produced by the battery management system side of the galvanic isolator device.

Before any embodiments are explained in detail, it is to be understood that the embodiments are not limited in application to the details of the configurations and arrangements of components set forth in the following description or illustrated in the accompanying drawings. The embodiments are capable of being practiced or of being carried out in various ways. Also, it is to be understood that the phraseology and terminology used herein are for the purpose of description and should not be regarded as limiting. The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### BRIEF DESCRIPTION OF THE DRAWINGS

FIG. 1A illustrates a perspective view of a portable power supply device, according to embodiments described herein.

FIG. 1B illustrates a portable power supply configured to receive a plurality of charging modules in a plurality of charge ports, according to embodiments described herein.

FIG. 1C illustrates the portable power supply of FIG. 1B including a plurality of charging modules connected to the charge ports, according to embodiments described herein.

FIG. 2A is a block diagram of a portable power supply including a battery core charger, a battery core, a battery management system, and battery pack charger, according to embodiments described herein.

FIG. 2B illustrates a detailed schematic of the battery core of the portable power supply connected to the battery management system, according to embodiments described herein.

FIG. 2C illustrates the battery pack charger of the portable power supply including a galvanic isolation barrier configured to galvanically isolate a CAN communications circuit (e.g., a CAN transceiver) from the CAN bus itself, according to embodiments described herein.

FIG. 3 illustrates a hardware schematic for on the portable power supply including a battery core, a battery management system (BMS), and a battery pack charger subsystem including a galvanic isolator and a battery pack detection circuit.

FIG. 4 illustrates a first configuration for a galvanically isolated battery pack detection circuit including an optocoupler, according to embodiments described herein.

FIGS. 4A-4D illustrate a plurality of modified configurations of the galvanically isolated battery pack detection circuit of FIG. 4, according to embodiments described herein.

FIG. 5 illustrates a second configuration for the galvanically isolated battery pack detection circuit including an optocoupler, according to embodiments described herein.

FIGS. 5A-5D illustrate a plurality of modified configurations of the galvanically isolated battery pack detection circuit of FIG. 5, according to embodiments described herein.

FIG. 6 illustrates a third configuration for the galvanically isolated battery pack detection circuit including an optocoupler, according to embodiments described herein.

FIG. 6A illustrates a modified configuration of the galvanically isolated battery pack detection circuit of FIG. 6, according to embodiments described herein.

FIG. 7 illustrates a fourth configuration for the galvanically isolated battery pack detection circuit including an optocoupler, according to embodiments described herein.

FIG. 7A illustrates a modified configuration of the galvanically isolated battery pack detection circuit of FIG. 7, according to embodiments described herein.

FIG. 8 illustrates a fifth configuration for the galvanically isolated battery pack detection circuit including an optocoupler, according to embodiments described herein.

FIG. 8A illustrates a modified configuration of the galvanically isolated battery pack detection circuit of FIG. 8, according to embodiments described herein.

FIG. 9 illustrates a sixth configuration for the galvanically isolated battery pack detection circuit including an optocoupler, according to embodiments described herein.

FIG. 9A illustrates a modified configuration of the galvanically isolated battery pack detection circuit of FIG. 9, according to embodiments described herein.

FIG. 10 illustrates a seventh configuration for the galvanically isolated battery pack detection circuit including an optocoupler, according to embodiments described herein.

FIGS. 10A-10C illustrate a plurality of modified configurations of the galvanically isolated battery pack detection circuit of FIG. 10, according to embodiments described herein.

FIG. 11 illustrates an eighth configuration for the galvanically isolated battery pack detection circuit including an optocoupler, according to embodiments described herein.

FIGS. 11A-11C illustrate a plurality of modified configurations of the galvanically isolated battery pack detection circuit of FIG. 11, according to embodiments described herein.

FIG. 12 illustrates a ninth configuration for a galvanically isolated battery pack detection circuit including an optocoupler, according to embodiments described herein.

FIGS. 12A-12C illustrate a plurality of modified configurations of the galvanically isolated battery pack detection circuit of FIG. 12, according to embodiments described herein.

FIG. 13 illustrates a tenth configuration for the galvanically isolated battery pack detection circuit including an optocoupler, according to embodiments described herein.

FIGS. 13A-13C illustrate a modified configuration of the galvanically isolated battery pack detection circuit of FIG. 13, according to embodiments described herein.

FIG. 14 illustrates an eleventh configuration for the galvanically isolated battery pack detection circuit including an optocoupler, according to embodiments described herein.

FIG. 15 illustrates a twelfth configuration for the galvanically isolated battery pack detection circuit including an optocoupler, according to embodiments described herein.

FIG. 16 illustrates a thirteenth configuration for the galvanically isolated battery pack detection circuit including an optocoupler, according to embodiments described herein.

FIG. 17 illustrates a fourteenth configuration for the galvanically isolated battery pack detection circuit including an optocoupler, according to embodiments described herein.

FIG. 17A illustrates a modified configuration of the galvanically isolated battery pack detection circuit of FIG. 17, according to embodiments described herein.

FIG. 18 illustrates a fifteenth configuration for the galvanically isolated battery pack detection circuit including an optocoupler, according to embodiments described herein.

FIG. 18A illustrates a modified configuration of the galvanically isolated battery pack detection circuit of FIG. 18, according to embodiments described herein.

FIG. 19 illustrates a sixteenth configuration for the galvanically isolated battery pack detection circuit including an optocoupler, according to embodiments described herein.

FIG. 20 illustrates a seventeenth configuration for a galvanically isolated battery pack detection circuit including an optocoupler, according to embodiments described herein.

FIG. 21 illustrates a constant current element configurable to limit the charge current of a current limiting capacitor in an isolated battery pack detection circuit including an optocoupler, according to embodiments described herein.

FIGS. 21A-21G illustrate a variety of constant current elements configurable to limit the charge current of a current limiting capacitor in the isolated battery pack detection circuit including an optocoupler, according to embodiments described herein.

FIG. 22 illustrates a first configuration for the galvanically isolated battery pack detection circuit including a transformer, according to embodiments described herein.

FIGS. 22A and 22B illustrate a plurality of modified configurations of the galvanically isolated battery pack detection circuit of FIG. 22, according to embodiments described herein.

FIG. 23 illustrates a second configuration for a galvanically isolated battery pack detection circuit including a transformer, according to embodiments described herein.

FIGS. 23A and 23B illustrate a modified configuration of the galvanically isolated battery pack detection circuit of FIG. 23, according to embodiments described herein.

FIG. 24 illustrates a third configuration for a galvanically isolated battery pack detection circuit including a transformer, according to embodiments described herein.

FIGS. 24A and 24B illustrate a modified configuration of the galvanically isolated battery pack detection circuit of FIG. 24, according to embodiments described herein.

FIG. 25 illustrates a fourth configuration for the galvanically isolated battery pack detection circuit including a transformer, according to embodiments described herein.

FIGS. 25A and 25B illustrate a modified configuration of the galvanically isolated battery pack detection circuit of FIG. 25, according to embodiments described herein.

FIG. 26 illustrates a fifth configuration for the galvanically isolated battery pack detection circuit including a transformer, according to embodiments described herein.

FIGS. 26A and 26B illustrate a plurality of modified configurations of the galvanically isolated battery pack detection circuit of FIG. 26, according to embodiments described herein.

FIG. 27 illustrates a sixth configuration for the galvanically isolated battery pack detection circuit including a transformer, according to embodiments described herein.

FIGS. 27A and 27B illustrate a plurality of modified configurations of the galvanically isolated battery pack detection circuit of FIG. 27, according to embodiments described herein.

FIG. 28 illustrates a seventh configuration for the galvanically isolated battery pack detection circuit including a transformer, according to embodiments described herein.

FIGS. 28A-28C illustrate a plurality of modified configurations of the galvanically isolated battery pack detection circuit of FIG. 28, according to embodiments described herein.

FIG. 29 illustrates an eighth configuration for the galvanically isolated battery pack detection circuit including a transformer, according to embodiments described herein.

FIGS. 29A-29C illustrate a plurality of modified configurations of the galvanically isolated battery pack detection circuit of FIG. 29, according to embodiments described herein.

FIG. 30 illustrates a ninth configuration for the galvanically isolated battery pack detection circuit including a transformer, according to embodiments described herein.

FIGS. 30A-30C illustrate a plurality of modified configurations of the galvanically isolated battery pack detection circuit of FIG. 30, according to embodiments described herein.

FIG. 31 illustrates a tenth configuration for the galvanically isolated battery pack detection circuit including a transformer, according to embodiments described herein.

FIGS. 31A-31C illustrate a modified configuration of the galvanically isolated battery pack detection circuit of FIG. 31, according to embodiments described herein.

FIG. 32 illustrates an eleventh configuration for the galvanically isolated battery pack detection circuit including a transformer, according to embodiments described herein.

FIG. 33 illustrates a twelfth configuration for the galvanically isolated battery pack detection circuit including a transformer, according to embodiments described herein.

FIG. 34 illustrates a thirteenth configuration for the galvanically isolated battery pack detection circuit including a transformer, according to embodiments described herein.

FIG. 35 illustrates a fourteenth configuration for the galvanically isolated battery pack detection circuit including a transformer, according to embodiments described herein.

FIG. 35A illustrates a modified configuration of the galvanically isolated battery pack detection circuit of FIG. 35, according to embodiments described herein.

FIG. 36 illustrates a fifteenth configuration for a galvanically isolated battery pack detection circuit including a transformer, according to embodiments described herein.

FIG. 36A illustrates a modified configuration of the galvanically isolated battery pack detection circuit of FIG. 36, according to embodiments described herein.

FIG. 37 illustrates a sixteenth configuration for the galvanically isolated battery pack detection circuit including a transformer, according to embodiments described herein.

FIG. 38 illustrates a seventeenth configuration for the galvanically isolated battery pack detection circuit including a transformer, according to embodiments described herein.

FIG. 39 illustrates a first configuration for the galvanically isolated battery pack detection circuit including a capacitor-based galvanic isolator, according to embodiments described herein.

FIG. 39A illustrates a modified configuration of the galvanically isolated battery pack detection circuit of FIG. 39, according to embodiments described herein.

FIG. 40 illustrates a second configuration for the galvanically isolated battery pack detection circuit including a capacitor-based galvanic isolator, according to embodiments described herein.

FIGS. 40A-40C illustrate a modified configuration of the galvanically isolated battery pack detection circuit of FIG. 40, according to embodiments described herein.

FIG. 41 illustrates a third configuration for the galvanically isolated battery pack detection circuit including a capacitor-based galvanic isolator, according to embodiments described herein.

FIGS. 41A-41C illustrate a modified configuration of the galvanically isolated battery pack detection circuit of FIG. 41, according to embodiments described herein.

FIG. 42 illustrates a fourth configuration for the galvanically isolated battery pack detection circuit including a capacitor-based galvanic isolator, according to embodiments described herein.

FIG. 42A illustrates a modified configuration of the galvanically isolated battery pack detection circuit of FIG. 42, according to embodiments described herein.

FIG. 43 illustrates a fifth configuration for the galvanically isolated battery pack detection circuit including a capacitor-based galvanic isolator, according to embodiments described herein.

FIG. 43A illustrates a modified configuration of the galvanically isolated battery pack detection circuit of FIG. 43, according to embodiments described herein.

FIG. 44 illustrates a sixth configuration for the galvanically isolated battery pack detection circuit including a capacitor-based galvanic isolator, according to embodiments described herein.

FIG. 44A illustrates a modified configuration of the galvanically isolated battery pack detection circuit of FIG. 44, according to embodiments described herein.

FIG. 45 illustrates a schematic representing a plurality of additional battery pack detection circuits including a galvanic isolator, according to embodiments described herein.

FIG. 46 illustrates a flow chart for detecting a battery pack connected to a portable power supply, according to embodiments described herein.

### DETAILED DESCRIPTION

Embodiments described herein relate to a portable power supply that includes a CAN bus configured to communicate data between system modules.

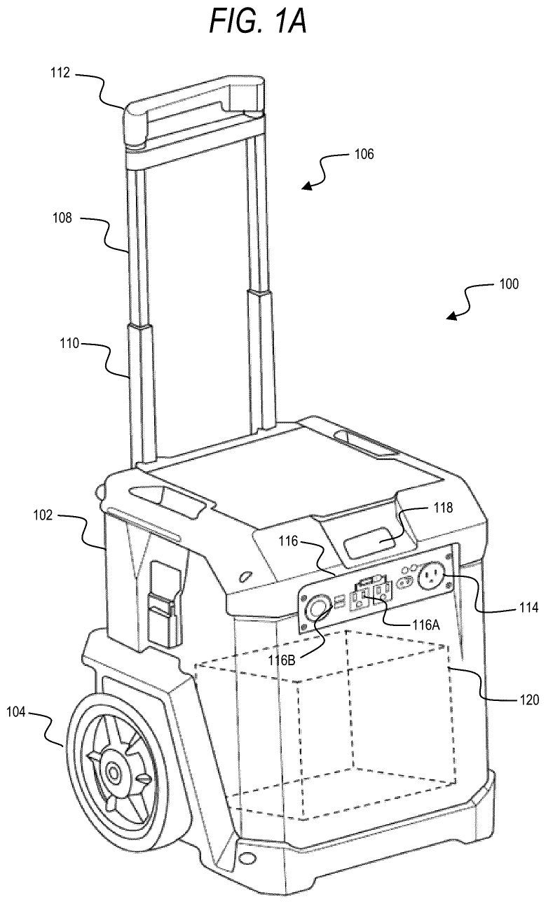

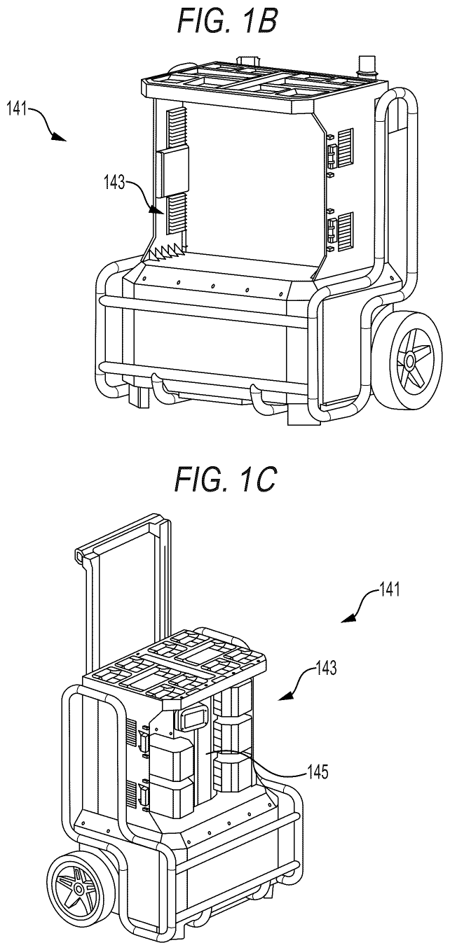

FIG. 1A illustrates a portable power supply device or power supply 100. The power supply 100 includes, among other things, a housing 102. In some embodiments, the housing 102 includes one or more wheels 104 and a handle assembly 106. In the illustrated embodiment, the handle assembly 106 is a telescoping handle movable between an extended position and a collapsed position. The handle assembly 106 includes an inner tube 108 and an outer tube 110. The inner tube 108 fits inside the outer tube 110 and is slidable relative to the outer tube 110. The inner tube 108 is coupled to a horizontal holding member 112. In some embodiments, the handle assembly 106 further includes a locking mechanism to prevent inner tube 108 from moving relative to the outer tube 110 by accident. The locking mechanism may include notches, sliding catch pins, or another suitable locking mechanism to inhibit the inner tube 108 from sliding relative to the outer tube 110 when the handle assembly 106 is in the extended position and/or in the collapsed position. In practice, a user holds the holding member 112 and pulls upward to extend the handle assembly 106. The inner tube 108 slides relative to the outer tube 110 until the handle assembly 106 locks in the extended position. The user may then pull and direct the power supply 100 by the handle assembly 106 to a desired location. The wheels 104 of the power supply 100 facilitate such movement.

The housing 102 of power supply 100 further includes a power input unit 114, a power output unit 116, and a display 118. In the illustrated embodiment, the power input unit 114 includes multiple electrical connection interfaces configured to receive power from an external power source. In some embodiments, the external power source is a DC power source. For example, the DC power source may be one or more photovoltaic cells (e.g., a solar panel), an electric vehicle (“EV”) charging station, or any other DC power source. In some embodiments, the external power source is an AC power source. For example, the AC power source may be a conventional wall outlet, such as a 120 V outlet or a 240 V outlet, found in North America. As another example, the AC power source may be a conventional wall outlet, such as a 220V outlet or 230V outlet, found outside of North America. In some embodiments, the power input unit 114 is replaced by or additionally includes a cable configured to plug into a conventional wall outlet. In some embodiments, the power input unit 114 further includes one or more devices, such as antennas or induction coils, configured to wirelessly receive power from an external power source. The power received by the power input unit 114 may be used to charge a core battery or battery core 120, disposed within the housing 102 of power supply 100.

The power received by the power input unit 114 may also be used to provide power to one or more devices connected to the power output unit 116. The power output unit 116 includes one more power outlets. In the illustrated embodiment, the power output unit 116 includes a plurality of AC power outlets 116A and DC power outlets or receptacles 116B. It should be understood that number of power outlets included in the power output unit 116 is not limited to the power outlets illustrated in FIG. 1A. For example, in some embodiments of the power supply 100, the power output unit 116 may include more or fewer power outlets than the power outlets included in the illustrated embodiment of power supply 100.

In some embodiments, the power output unit 116 is configured to provide power output by the battery core 120 to one or more peripheral devices. In some embodiments, the power output unit 116 is configured to provide power provided by an external power source directly to one or more peripheral devices. The one or more peripheral devices may be a smartphone, a tablet computer, a laptop computer, a portable music player, a power tool, a power tool battery pack, a power tool battery pack charger, or the like. The peripheral devices may be configured to receive DC and/or AC power from the power output unit 116.

In some embodiments, the DC power outlets 116B also include one or more receptacles for receiving and charging power tool battery packs. In such embodiments, power tool battery packs received by, or connected to, the battery pack receptacles 116B are charged with power output by the battery core 120 and/or power received directly from the external power source. In some embodiments, power tool battery packs connected to the battery pack receptacles 116B are used to provide power to the battery core 120 and/or one or more peripheral devices connected to outlets of the power output unit 116. The battery pack receptacles 116B may include guide rails to receive slide-on style battery packs and latching mechanisms to secure the battery packs to the receptacle 116B. In such embodiments, the power supply 100 includes a plurality of charging modules or charging blocks for charging various battery packs. The charging modules can have different power ratings and can be interchangeable within different charging slots within the power supply 100. As a result, the power supply 100 can be configured with various combinations of battery pack chargers for charging battery packs of different voltages, at different charging rates, etc.

In some embodiments, the power output unit 116 includes tool-specific power outlets. For example, the power output unit may include a DC power outlet used for powering a welding tool. In some embodiments, the DC power outlets 116B are configured to support charging of battery packs with various nominal voltage ratings (e.g., 12V, 18V, 36V, 72V, etc.).

A display 118 is configured to indicate a state of the power supply 100 to a user, such as state of charge of the battery core 120 and/or fault conditions. In some embodiments the display 118 includes one or more light-emitting diode (“LED”) indicators configured to illuminate and display a current state of charge of battery core 120. In some embodiments, the display 118 is, for example, a liquid crystal display (“LCD”), a light-emitting diode (“LED”) display, an organic LED (“OLED”) display, an electroluminescent display (“ELD”), a surface-conduction electron-emitter display (“SED”), a field emission display (“FED”), a thin-film transistor (“TFT”) LCD, an electronic ink display, an electrochromic display, a flip dot/flip disc display, etc. In some embodiments, the display 118 is a touch screen configured to be used as a human-machine interface. The display 118 may be configured to display a graphical user interface. The power supply 100 may include user input components such as keys, trackpads, dials, knobs, touchscreens, etc., for accepting user input and updating the display 118. In other embodiments, the power supply 100 does not include a display.

FIGS. 1B and 1C illustrate another embodiment of a power supply 141 that is similar to the power supply 100 and which may include similar features. The power supply 141 may further include a compartment 143 that is configured to receive one or more charging modules 145. For example, the power supply 100, 141 may be configured with any combination of charging modules (e.g., 12V charging modules, 18V charging modules, etc.). The power supply 141 distributes, for example, a 24 V bus to the charging modules. In some embodiments, one or more of the charging modules accommodate one or more stem type battery packs or slide-on battery packs, or a combination of one or more stem battery packs and one or more slide-on battery packs, having a rated voltage between, for example, 3V and 83V (e.g., 12V, 18V, 72V, etc.). The charging modules may be configured to provide a charging current to a battery pack when the battery pack is received by at least one of the charging modules. One or more of the charging modules may be electrically coupled to one or more charging ports. The charging ports may include at least one USB C charging port that provides between 3.3 V and 21 V to a device coupled to the USB C charging port, and/or at least one USB A charging port that provides 5 V at 2.4 Amps to a device coupled to the USB A charging port. In some embodiments, devices may be electrically coupled to the charging ports via charging cables. One or more of the charging modules may include a fan for cooling a battery pack. The fan may be controlled by a controller of the power supply 100 and may automatically turn on when the battery pack is inserted into one or more of the charging modules, when a sensor coupled to the controller senses that the temperature of the battery pack has reached a certain threshold value, or when data indicating that the temperature of the battery pack has reached a certain threshold value is communicated to the controller (e.g., over a digital communications interface).

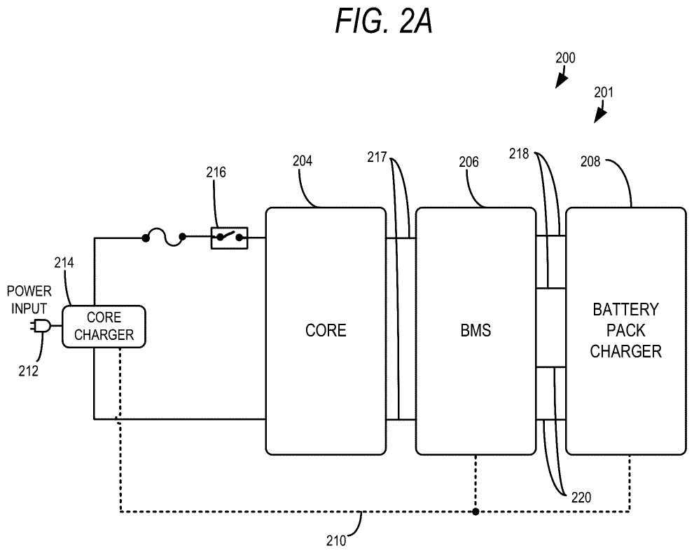

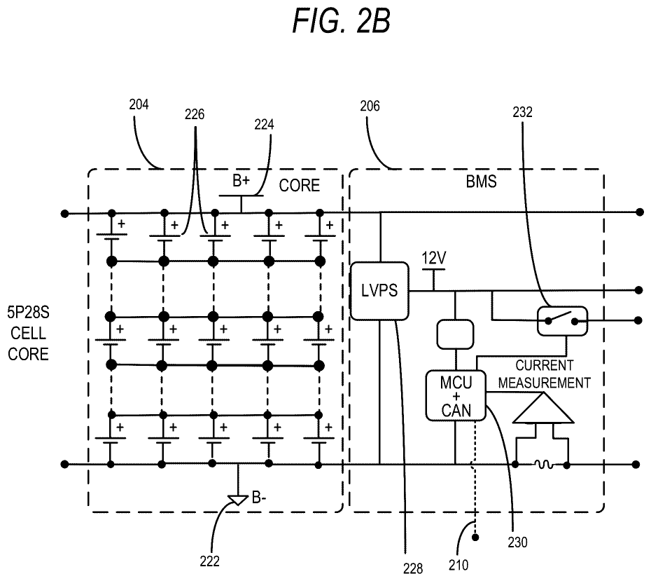

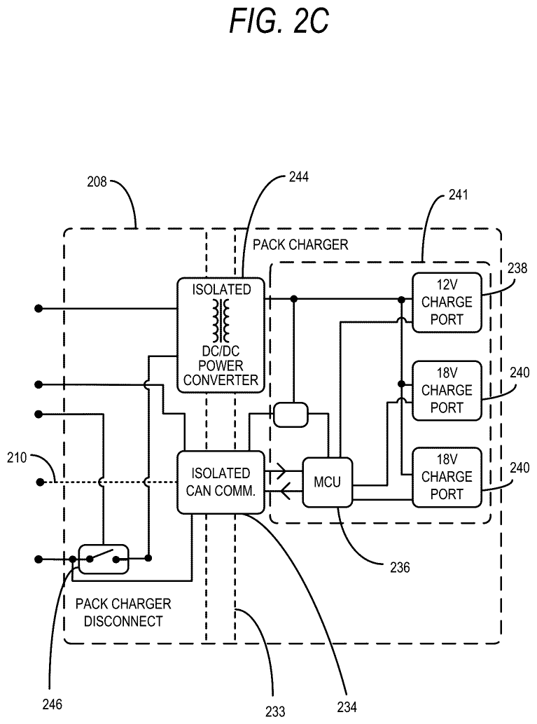

FIG. 2A illustrates a block diagram 200 of a portable power supply 201 (e.g., power supply 100, 141) including a battery core 204, a battery management system (“BMS”) 206, and a battery pack charger 208. The BMS 206 and the battery pack charger 208 are connected to the core charger 214 via a CAN bus 210. A power input 212 (e.g., a plug configured to draw electrical current through a wall socket) is connected to a core charger 214 configured to provide a charging current to the battery core 204. The core charger 214 may communicate, via the CAN bus 210, with the BMS 206 and the battery pack charger 208 for the purpose of monitoring the health of the battery core and managing the battery core and battery pack charging processes. A power supply disconnect switch 216 may be configured to disconnect the battery core 204, the BMS 206, and the pack charger 208 from current supplied by the core charger 214 via the power input 212. Power leads 217 are configured to provide current from the battery core 204 or the core charger 214 to the BMS 206 and the battery pack charger 208. Power leads 218 and 220 are configured to provide current from the BMS 206 to the battery pack charger 208. For example, the power leads 218 may be configured to supply current supplied by the battery core 204, or in some cases the core charger 214, directly to the battery pack charger 208, while power leads 220 are configured to provide, for example, a 12V signal, produced by a low-voltage power supply (“LPVS”) 228 (see FIG. 2B), to the battery pack charger 208.

FIG. 2B illustrates a detailed schematic of the battery core 204 of the portable power supply 100 connected to the battery management system 206. The battery core 204 includes a positive terminal 224 and a negative terminal 222. The battery core 204 further includes a plurality of core cells 226 connected in series and parallel and configured to be charged by the core charger 214. Although illustrated as being connected in series and parallel, the core cells 226 may be electrically connected in series, in parallel, and/or a combination thereof. In some embodiments, the core cells 226 are implemented as rechargeable 24V groups or packs. In some embodiments, the rechargeable groups or packs may be relatively high voltage (e.g., 72V, 100V, 120V, 240V, etc.). Additionally, The battery core 204 may include as many core cells 226 as desired. For example, the battery core 204 may include two, three, four, ten, twenty, twenty-three, twenty-eight, forty-six, seventy or more battery cells electrically connected in series.

The core cells 226 included in the battery core 204 may be rechargeable battery cells having a lithium ion chemistry, such as lithium phosphate or lithium manganese. In some embodiments, the core cells 226 may have lead acid, nickel cadmium, nickel metal hydride, and/or other chemistries. In some embodiments, the core cells 226 are pouch battery cells (e.g., lithium-based pouch battery cells). Each core cell 226 in the battery core 204 has an individual nominal voltage. The nominal voltage of an individual core cell 226 included in the battery core 204 may be, for example, 4.2V, 4V, 3.9V, 3.6V, 2.4V, or some other voltage value. Naturally, the nominal voltages of the individual core cells 226 included in each group or pack may be stacked. For example, if a group or pack of core cells 226 includes two core cells 226 having nominal voltages of 4V, and the two core cells 226 are connected in series, voltage of the group or pack of core cells 226 is equal to 8.0V. Additionally, the amp-hour capacity, or capacity, of battery core 204 may be increased by adding core cells 226 connected in a parallel-series combination to the battery core 204.

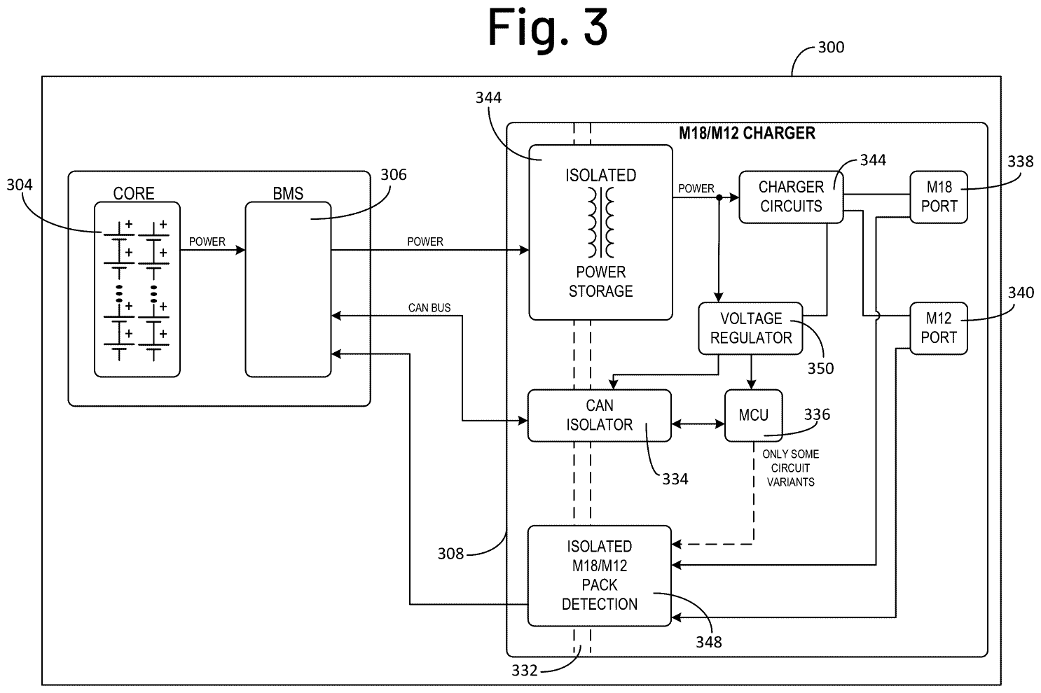

The BMS 206 is configured to provide current and voltage, as needed, from the battery core charger 214, the battery core 204, or the LVPS 228 to the battery pack charger 208. For example, the LVPS may be configured to provide a 12V power output to a galvanic isolation circuit (referred to herein generally as a “galvanic isolation barrier”) such as a galvanically isolated CAN transceiver (see FIG. 3) or a galvanic isolation circuit for a continuation of the CAN bus itself (see FIG. 3). The BMS may also include a controller or microcontroller (“MCU”) and CAN transceiver 230 configured to communicate according to the CAN protocol with the battery core charger 214 and the battery pack charger 308 to manage the provision of current from the battery core charger 214 to the battery core 204, and from the battery core 204 and the battery core charger 214 to the battery pack charger 308. The MCU and CAN transceiver 230 are also configured to measure current drawn by the battery pack charger 308 and to manipulate a BMS disconnect switch 232 based on the current measurement. For example, if the current drawn by the battery pack charger 308 spikes to an unsafe level, the MCU and CAN transceiver 230 may open the BMS disconnect switch 232, which may cause a battery charger disconnect switch 246 (shown in FIG. 2C) to open, thereby preventing the flow of charging current to a charging port (see FIG. 2C). Current drawn by the battery pack charger 308 may also be measured with respect to the battery core 204, and used by the BMS 206 for determining the state of charge of the battery core 204. Additionally, in some embodiments, in order to prevent the battery pack charger 208 from draining the battery core 204 when the battery pack charger 308 is not in active operation, the BMS 206 closes the BMS disconnect switch 232, which causes the battery pack charger disconnect switch 246 to disconnect the battery core 204.

FIG. 2C illustrates the battery pack charger 208 of the portable power supply 100 including a galvanic isolation barrier 233 configured to galvanically isolate a CAN communications circuit 234 (e.g., a CAN transceiver) from the CAN bus 210 and from other voltages in the battery core 204 and in the BMS 206. The configuration shown is not the only configuration contemplated herein. For example, as will be described below, a galvanically isolated continuation of the CAN bus 210) may extend into the battery pack charger 208, and a plurality of CAN transceivers in the battery pack charger may be configured to communicate with the BMS 206 and the battery core charger 214 via the galvanically isolated CAN bus continuation. The CAN communications circuit 234 is also configured to communicate via CAN protocol with a battery pack charger microcontroller 236 connected to a plurality of battery charging ports 238, 240. The charging ports 238, 240 are configured to charge devices connected to one or more charging modules 241 with an appropriate charging current at a specified voltage (e.g., 12V, 18V, etc.). In some embodiments, the charging modules 241 may be added to or removed from the battery pack charger 208 as desired. The battery pack charger microcontroller 236 is configured to control the charging ports 238, 240 (e.g., start charge, stop charge, pause charge, restart charge, etc.). The battery pack charger microcontroller 236 is configured to accept and execute CAN commands received from the BMS 206 via the CAN communications circuit 234. In this way the BMS 206 may manage the operation of charging ports 238, 240, via the battery pack charger microcontroller 236. A DC/DC power converter 244 is configured to condition current received from the BMS 206 to ensure an appropriate voltage charging signal is provided to the charging ports 238, 240. The battery pack MCU 236 may be configured to selectively interrupt the flow of current to charging ports 238, 240 in response to the conditioned current signal to protect one or more devices connected to the charging ports 238, 240. A battery pack charger disconnect switch 246 is configured to open in response to a signal received from the BMS disconnect switch 232, as described above, thereby preventing the flow of charging current to the charging ports 238, 240.

FIG. 3 illustrates a hardware schematic for a power supply including a battery core 304 (e.g., power supply 100), a battery management system (“BMS”) 306, and a galvanically isolated battery pack charger 308 including a galvanic isolation barrier 332 and a battery pack detection circuit 348. The battery pack detection circuit 348 may be configured to draw a low steady-state quiescent current (e.g., less than 50 μA) from a battery pack connected to one of the charging ports 338, 340 and communicate, to the BMS 306, a detection of the battery pack.

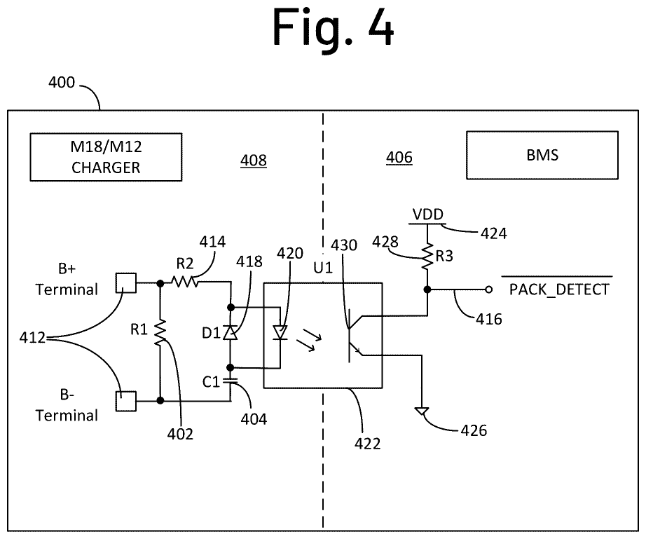

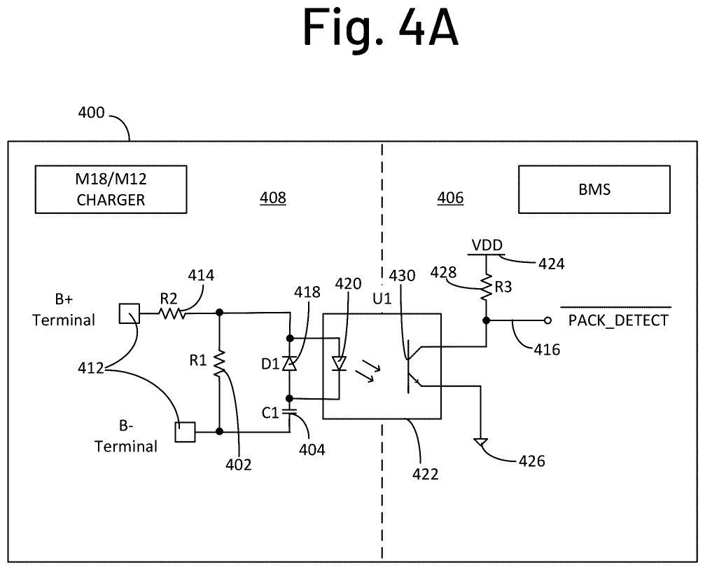

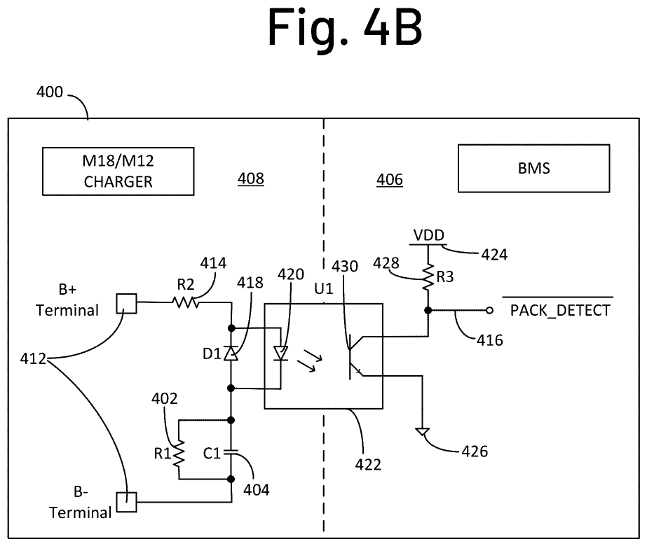

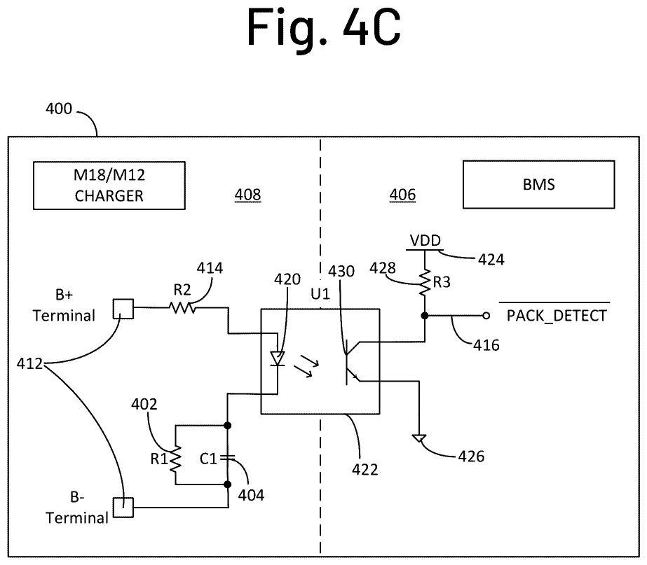

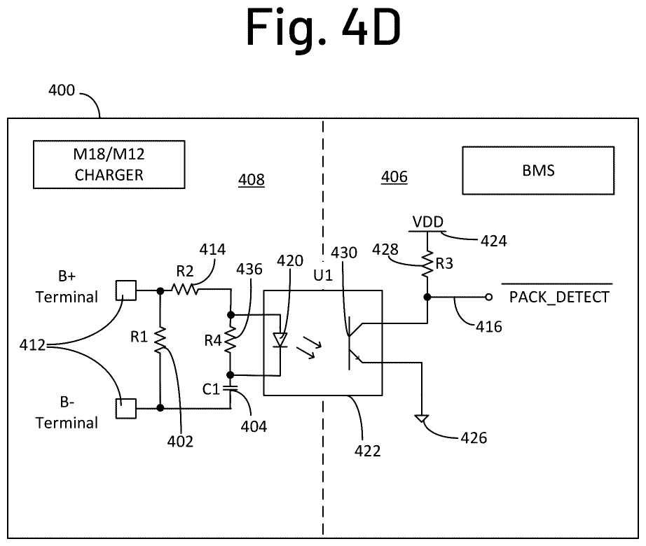

A plurality of circuits, described below, can be used as the battery pack detection circuit 348. The voltage drawn from a battery pack connected to the charging port 338, 340 may be used as the input signal to the battery pack detection circuit 348. When a battery pack is connected to the charging port 338, 340, the voltage between the positive and negative terminal connections (see FIG. 4) on that battery pack may charge a capacitor (see FIG. 4). Specifically, an initial current pulse from the battery pack may both charge the capacitor and drive the battery pack current detection circuit 300, which ultimately provides a signal to the BMS 306. After the capacitor has charged, the current draw from the battery pack may remain very small. After the battery pack is removed, the capacitor should be discharged before the next insertion of a battery pack, otherwise the battery pack detection circuit 348 may not detect a subsequent battery pack connection. The battery pack detection circuit 348 may be configured to output a single pulse to the BMS 306 when a battery pack is inserted. The output pack detection signal at the BMS 306 may be a single-ended digital logic signal. All of this may be achieved while maintaining galvanic isolation between the BMS 306 side and the battery pack charger 308 side of the portable power supply 100. Some of the circuit designs described herein achieve galvanic isolation using an optocoupler, a transformer, and/or capacitors, as will be described in further detail below.

The first optocoupler-based circuit configuration 400 for a BMS 406 and a battery pack charger 408 acting together as a battery pack detection circuit 400 is shown in FIG. 4. Resistor R1 (“R1”) 402 is a resistor with a high impedance. Its purpose is to discharge the capacitor C1 (“C1”) 404 when the battery pack is not connected to the terminals 412. The high impedance of R1 402 limits current draw when the battery pack is connected to these terminals 412. Resistor R2 (“R2”) 414 limits the rate at which C1 404 charges after the battery pack is installed. This may both keep the current of the battery pack detection circuit 400 within current limitations and also lengthens the logic low pulse on the pack detection signal line 416 so that it can be more easily registered by the BMS 406. Diode D1 (“D1”) 418 is configured to allow capacitor 404 to discharge through resistor 414 and resistor 402 when no battery pack is installed on the terminals 412. It also prevents reverse avalanche of the LED 420 inside optocoupler 422. Optocoupler 422 is an optocoupler or optoisolator that provides galvanic isolation between the battery pack charger 408 and BMS 406 sides of the battery pack detection circuit 400. C1 404 is configured to cause significant current to flow through the LED 420 of optocoupler 422 for a limited period of time after a battery pack is installed on the terminals 412, generating a signal that can be communicated to the BMS 406 via pack detection signal line 416. It ceases drawing current from the battery pack after it is charged. Positive logic supply voltage 424 supplies logic voltage to the phototransistor 430 on the BMS 406 side of the optocoupler 422. The common signal represents the negative logic supply voltage 426 within the BMS 406. Resistor R3 (“R3”) 428 is a pullup resistor that causes a pack detection signal on the battery pack detection signal line 416 to idle at a logic high voltage level, but also permits this signal to decrease to a logic low voltage level when current flows through the phototransistor 430 of optocoupler 422.

In the embodiment shown, the battery pack detection circuit 400 has two operational modes. In a first mode, when a battery pack is connected to the terminals 412, the voltage across the battery pack appears between terminals 412. This voltage charges capacitor 404 through resistor 414 and the LED 420 of optocoupler 422. While capacitor 404 is charging, a current flows through the LED 420 and turns on both the LED and phototransistor 430 inside optocoupler 422. This draws current through resistor 428, decreasing the voltage of the pack detect signal on the battery pack detection signal line 416 to a logic low voltage level that the BMS 406 will register as a battery pack detected signal. Once capacitor 404 fully charges, no more current flows through resistor 414, the LED 420, or capacitor 404. The LED 420 and phototransistor 430 inside the optocoupler 422 turn off, the current flow through resistor 428 decreases to negligible levels, and the battery pack detect signal on battery pack detection signal line 416 returns to its idle state logic high voltage level. The only current drawn from the battery pack is the small current through R1 402.

After a battery pack is removed. The capacitor 404 discharges through D1 418, R2 414, and R1 402 until its voltage drops to a very low level or zero. At this point, the battery pack detection circuit 400 has been reset and can detect connection to another battery pack.

In a first variation of the battery pack detection circuit 400 shown in FIG. 4, R1 402 is placed between the cathode of D1 418 and the negative terminal 412 (B−). This configuration is shown in FIG. 4A. In the configuration shown in FIG. 4A, C1 404 discharges through D1 418 and R1 402 after a battery pack is removed. R2 414 is no longer in the discharge path.

FIG. 4B shows a second variation of the battery pack detection circuit 400 shown in FIG. 4. R1 402 is placed directly across C1 404 instead of across the terminals 412. In this configuration, C1 404 discharges directly through R1 402 after a battery pack is removed. R2 414 and D1 418 are no longer in the discharge path.

FIG. 4C shows a variation of the battery pack detection circuit 400 shown in FIG. 4B, with D1 418 omitted.

In any of the previous optocoupler circuit configurations (FIG. 4, 4A, 4B), diode D1 418 may be replaced with an ordinary resistor, shown as resistor R4 (“R4”) 430 in FIG. 4D. In FIG. 4D, R4 436 provides a path for C1 404 to discharge after the battery pack is removed, just like D1 418 did previously. Resistors are generally cheaper than diodes, so cost is reduced. However, R4 436 diverts more current around the LED 420 while C1 404 is charging than a diode would be expected to divert.

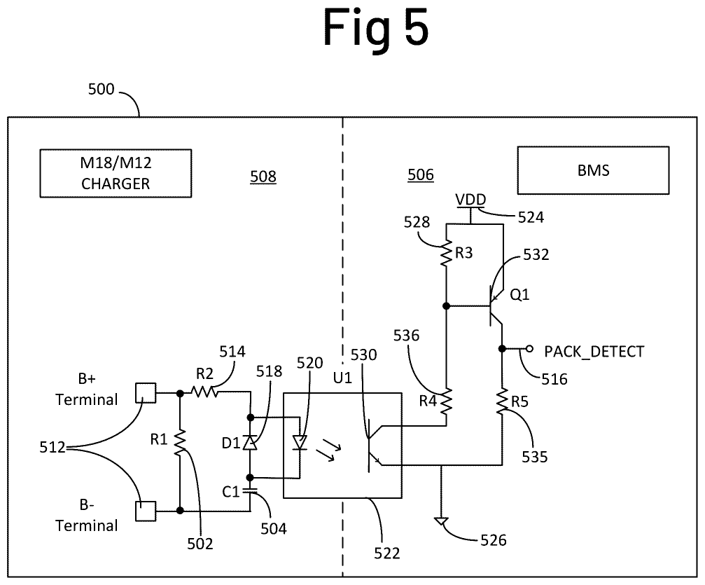

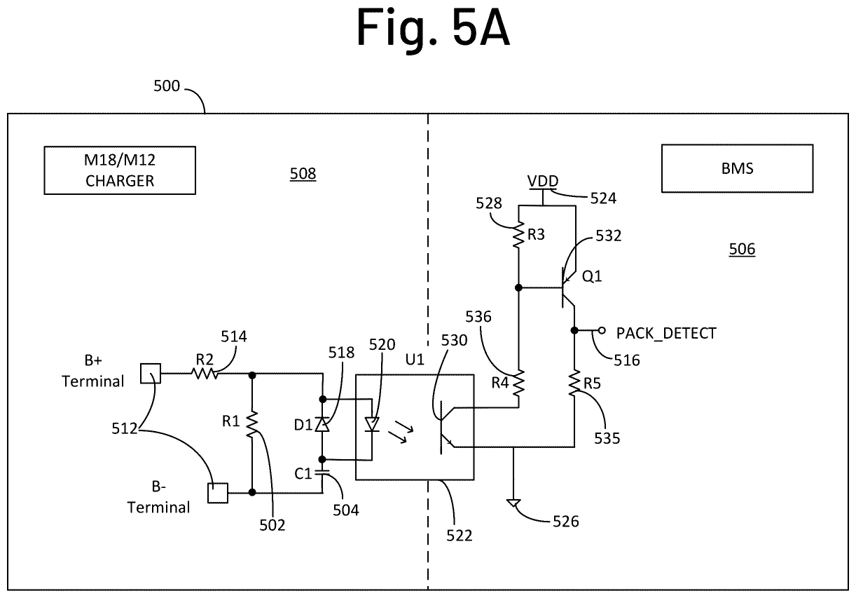

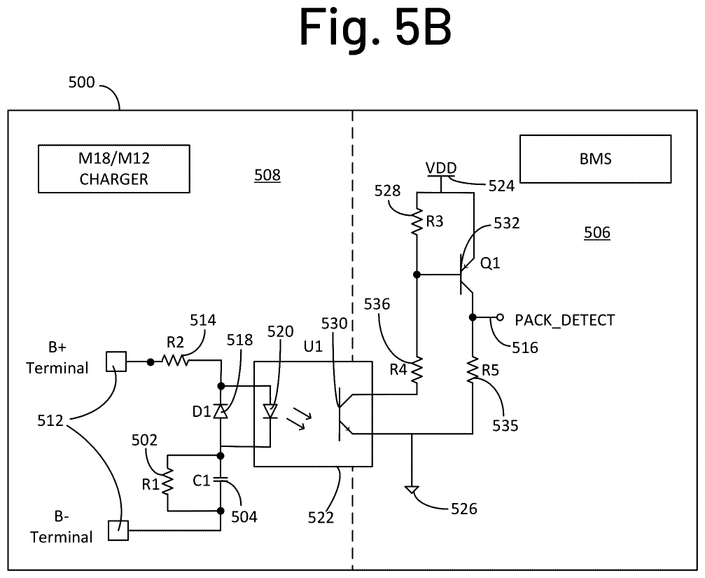

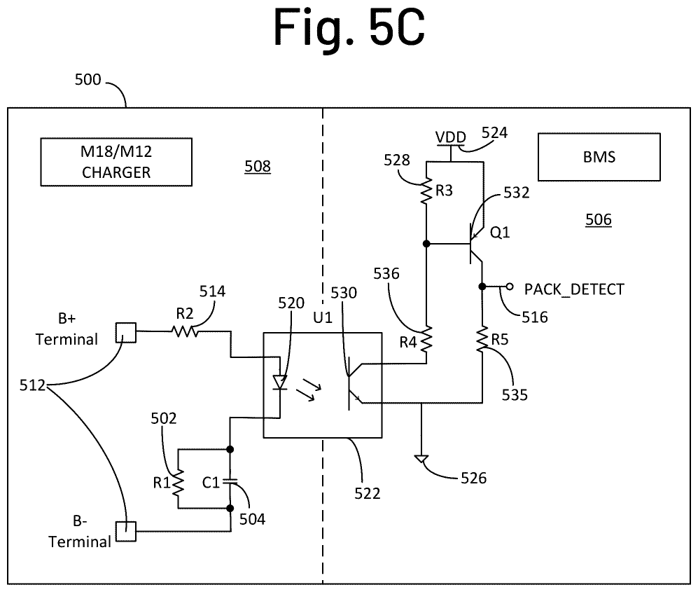

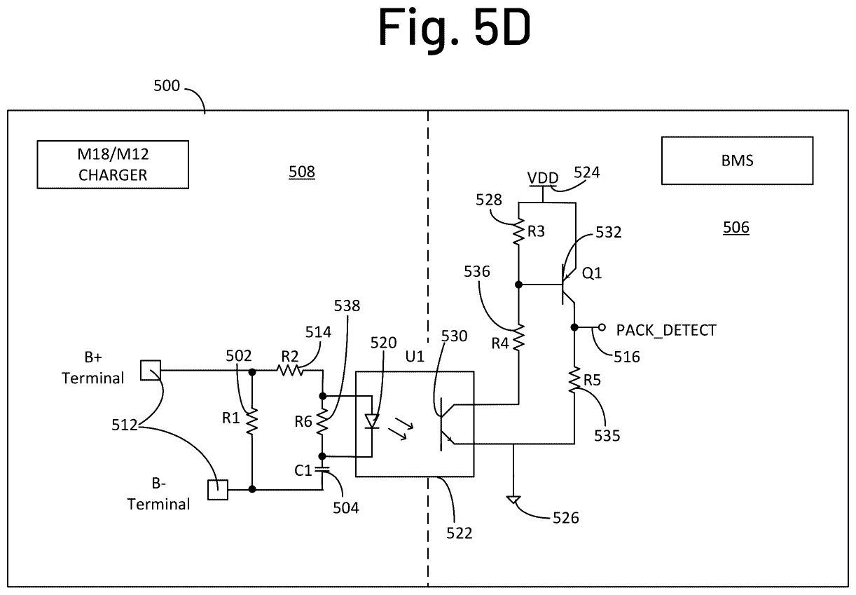

Another configuration 500 for an optocoupler-based battery detection circuit 500 is shown in FIG. 5. The battery pack charger 508 side of the circuit is identical to the optocoupler 522 configuration shown in FIG. 4. However, in FIG. 5, the BMS 506 shown in FIG. 4 been modified. Transistor Q1 (“Q1”) 532 is a PNP bipolar junction transistor. The transistor Q1 532 has lower leakage current in cutoff than the dark current of the phototransistor 530 of optocoupler 522, allowing higher values for resistor R5 (“R5”) 535 and more flexibility in the overall circuit design. The transistor Q1 532 also has improved saturation characteristics relative to phototransistor 530 of the optocoupler 522, making it easier to achieve clean logic levels on the battery pack detect signal on the battery pack detection signal line 516. Transistor Q1 532 also amplifies the output current or collector current of the optocoupler 522, allowing more flexibility in the overall circuit design of the battery detection circuit 500, and makes it possible for the phototransistor 530 of the optocoupler 522 to be operated in its active or linear region. R3 528 is a resistor that keeps Q1 532 in cutoff against the dark current of phototransistor 530. R4 536 is an optional resistor that limits the current through phototransistor 530 and the base of Q1 532 to some maximum limit, if desired. R5 535 is a pulldown resistor that causes the battery pack detect signal of the battery pack detection signal line 516 to idle at a logic low voltage level but also permits this signal to increase to a logic high voltage level when current flows through the collector of Q1 532.

The operation of optocoupler 522 shown in FIG. 5 is similar to that of the optocoupler 422 shown in FIG. 4. In the embodiment shown, when the battery pack is connected, the voltage across the battery pack appears between the terminals 512. This voltage charges C1 504 through R2 514 and the LED 520 of optocoupler 522. While C1 504 is charging, a current flows through the LED 520 of optocoupler 522 that turns on both the LED 520 and phototransistor 530 inside of optocoupler 522. This draws current through the base-emitter junction of Q1 532, causing Q1 532 to enter saturation, resulting in a low voltage drop across the collector-emitter junction of Q1 532 and a logic high voltage level on the battery pack detect signal on the battery detection signal line 516 that the BMS 506 will register as a pack detection. Once C1 504 fully charges, no more current flows through R2 514, the LED 520 of optocoupler 522, or C1 504. The LED 520 inside the optocoupler 522 turns off, the current through phototransistor 530 decreases, and the voltage across R3 528 drops low enough to turn off Q1 532. The current on the collector of Q1 532 (the current through R5 535) decreases to negligible levels, and the battery detect signal on the battery detection signal line 516 returns to its idle state logic low voltage level. The only current drawn from the battery pack is the small current through R1 502. After the battery pack is removed, the capacitor C1 504 discharges through D1 518, R2 514, and R1 502 until its voltage drops to a very low level. The battery detection circuit 500 has been reset and can detect another battery pack. To the extent that any circuit components are not explicitly described in detail with respect to these embodiments of the circuit, the same functions of those components as previously described can be attributed to such components. However, any such components have been renumbered to start with a “5”.

In another variation shown in FIG. 5A, R1 502 could be placed between the cathode of D1 518 and the B− terminal 512. In this configuration, C1 504 discharges through D1 518 and R1 502 after a battery pack is removed. R2 514 is no longer in the discharge path.

R1 502 could be placed directly across C1 504 instead of across the terminals 512. In this configuration, shown in FIG. 5B, C1 504 discharges directly through R1 502 after a battery pack is removed.

In a similar configuration, shown in FIG. 5C, the battery pack detection circuit 500 still functions with D1 518 omitted.

In any of the previous optocoupler circuit configurations (FIG. 5, 5A, or 5B), diode D1 518 could be replaced with an ordinary resistor, shown as resistor R6 (“R6”) 538 in FIG. 5D. R6 538 provides a path for C1 504 to discharge after the battery pack is removed, similar to D1 418 in FIG. 4. Generally, resistors are cheaper than diodes, reducing cost. The potential drawback is that R6 538 diverts more current around LED 520 while C1 504 is charging than a diode would be expected to divert.

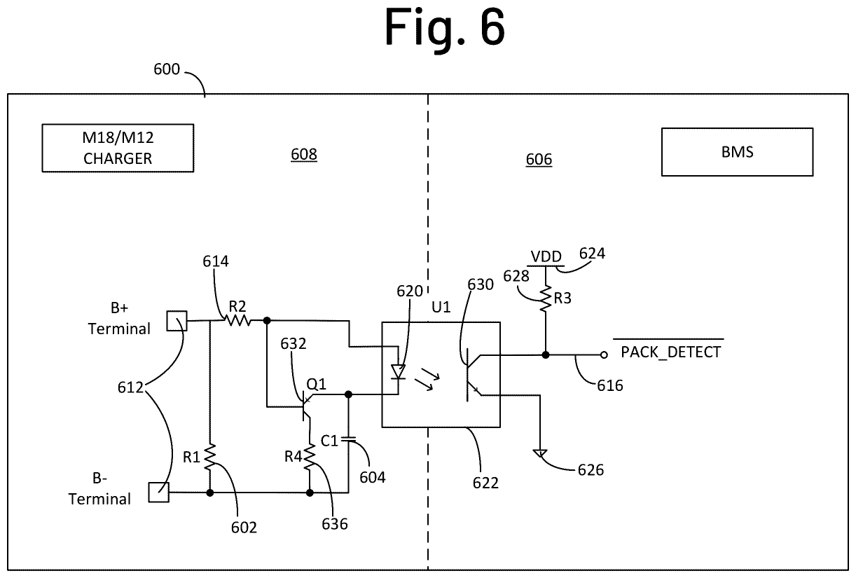

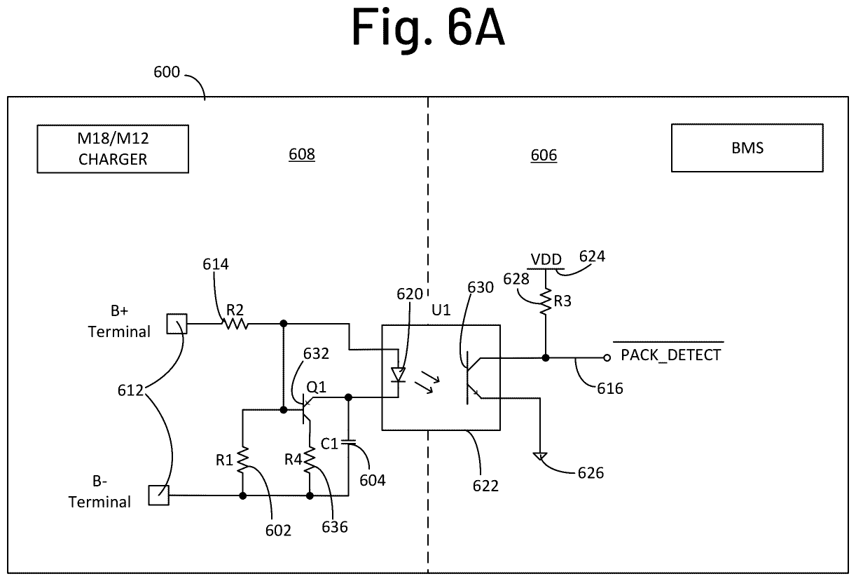

Another optocoupler-based circuit configuration 600 is shown in FIG. 6. The BMS 606 is identical to the configuration shown in FIG. 4, but the battery pack charger 608 has been modified.

Q1 632 is a PNP BJT that amplifies the current that R1 602 and R2 614 draw from C1 604 after a battery pack is removed, causing the circuit to reset more quickly than the configuration shown in FIG. 4. Q1 632 also draws almost no current when a battery pack is installed, because it is biased off, and protects LED 620 from avalanche breakdown if the voltage on C1 604 exceeds the voltage across the terminals 612. LED 620 protects the base-emitter junction of Q1 from avalanche when a pack is installed. R4 636 is an optional resistor that limits the current through the collector of Q1 632 to some maximum limit, if desired. When a battery pack is connected to the terminals 612, the voltage across the battery pack appears between the terminals 612. This voltage charges C1 604 through R2 614 and the LED 620 of the optocoupler 622. While C1 604 is charging, a current flows through the LED 620 of optocoupler 622 that turns on both the LED 620 and phototransistor 630 inside the optocoupler 622. This draws current through R3 628, decreasing the voltage of the battery pack detect signal on the battery pack detection signal line 616 to a logic low voltage level that the BMS 606 will register as a pack detected signal. Once C1 604 fully charges, no more current flows through R2 614, the LED 620 of optocoupler 622, or C1 604. The LED 620 and phototransistor 630 inside optocoupler 622 turn off, the current flow through R3 628 decreases to negligible levels, and the battery pack detect signal on the battery pack detection signal line 616 returns to its idle state logic high voltage level. The only current drawn from the battery pack is the small current through R1 602 and the collector cutoff current of Q1 632. Q1 632 is biased off while C1 604 charges.

After the battery pack is removed, the capacitor C1 604 discharges through Q1 632, R1 602, R2 614, and R4 636, until its voltage decreases to approximately the base-emitter threshold voltage of Q1 632. Base current from Q1 632 flows through R1 602 and R2 614. At this point, the pack detection circuit 600 has been reset and can detect the connection/insertion of another battery pack. Due to a gain of Q1 632, its collector current is much larger than its base current, and flows through R4 636. The C1 604 discharge current is thus much larger than the configuration shown in FIG. 4, and C1 604 discharges much more quickly. To the extent that any circuit components are not explicitly described in detail with respect to these embodiments of the circuit, the same functions of those components as previously described can be attributed to such components. However, any such components have been renumbered to start with a “6”.

R1 602 could be placed between the base of Q1 632 and the B− terminal 612 instead of across both of the terminals 612. This configuration is shown in FIG. 6A. In this configuration, R1 602 alone drives the discharge network after a pack is removed instead of the series combination of R1 602 and R2 614.

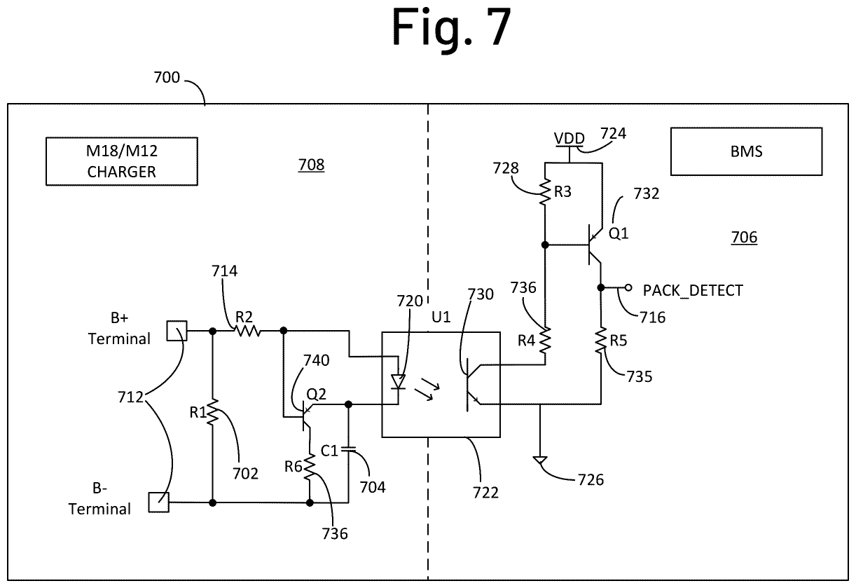

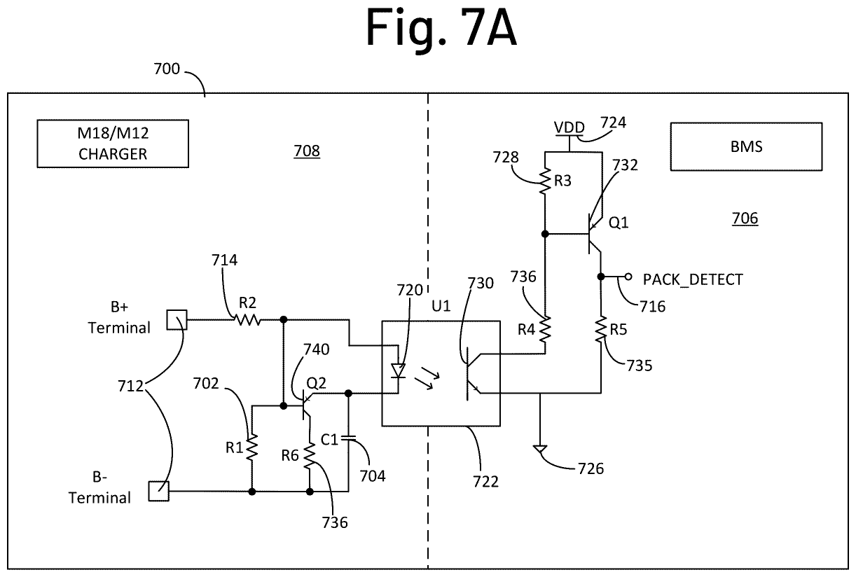

FIG. 7 shows another optocoupler circuit configuration 700. The configuration 700 combines the circuitry of the battery pack charger 608 from the configuration shown in FIG. 6 with the BMS 506 from configuration shown in FIG. 5. Corresponding common components among the embodiments are not described further, but are identified with a “7” identifier.

The optocoupler circuit configuration 700 shown in FIG. 7A combines the battery pack charger 608 from configuration shown in FIG. 6A with the BMS 506 from the configuration shown in FIG. 5. Corresponding common components among the embodiments are not described further, but are identified with a “7” identifier.

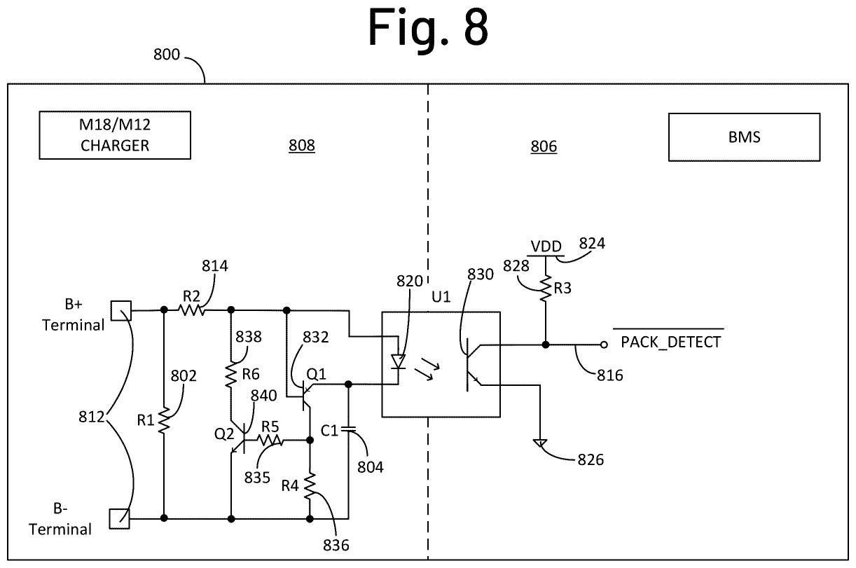

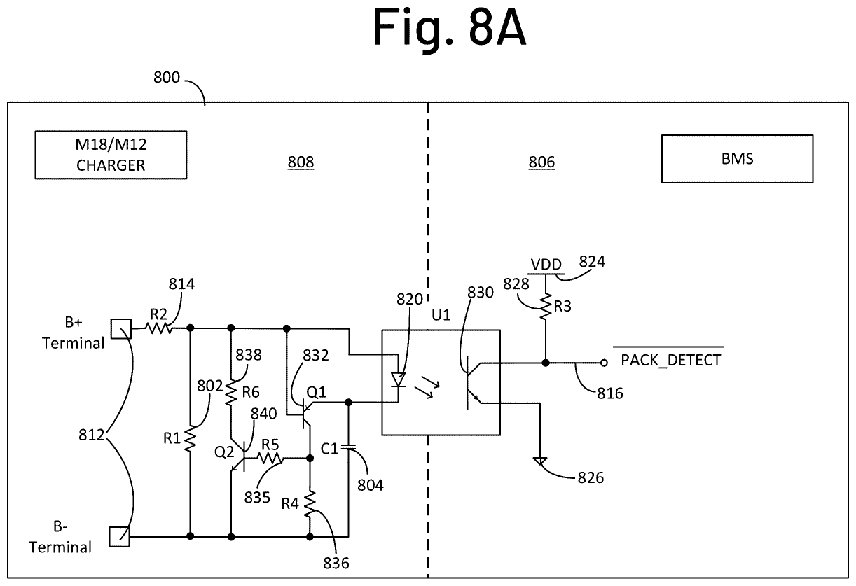

Another optocoupler circuit configuration 800 is shown in FIG. 8. The BMS 806 is identical to the configuration 400, but the battery pack charger 808 has been modified. Q1 832 is a PNP BJT that causes the battery pack detection circuit 800 to reset more quickly than configuration 400 by amplifying the current that R1 802 and R2 814 draw from C1 804 after a battery pack is removed and using this amplified current to drive the base of transistor Q2 840. Q1 draws almost no current when a battery pack is installed because it is biased off. The base-emitter junction of Q1 protects LED 820 from avalanche breakdown if the voltage on C1 804 exceeds the voltage across the terminals 812. LED 820 protects the base-emitter junction of Q1 832 from avalanche when a pack is installed. Q2 840 is an NPN BJT that is driven by Q1 832 when C1 804 starts to discharge through Q1 832, R1 802, and R2 814. Q2 840 in turn drives the base of Q1 832 and creates a positive feedback loop, together with Q1 832, that rapidly increases the current drawn from C1 804, discharging C1 804 quickly. R4 836 serves to keep Q2 840 biased off against the collector cutoff current of Q1 832 when a battery pack is installed. R5 835 is an optional resistor that limits the collector current of Q1 832 and the base current of Q2 840 while C1 804 is being discharged by these transistors, if desired. R6 838 is an optional resistor that limits the base current of Q1 832 and the collector current of Q2 840 while C1 804 is being discharged by these transistors, if desired.

When a battery pack is connected, the voltage across the battery pack appears between the terminals 812. This voltage charges C1 804 through R2 814 and the LED 820. While C1 804 is charging, a current flows through the LED 820 that turns on both the LED 820 and phototransistor 830 inside optocoupler 822. This draws current through R3 828, decreasing the voltage of the battery pack detect signal on the battery pack detection signal line 816 to a logic low voltage level that the BMS will register as a battery pack detected signal. Once C1 804 fully charges, no more current flows through R2 814, the LED 820 or C1 804. The LED 820 and phototransistor 830 inside optocoupler 822 turn off, the current flow through R3 828 decreases to negligible levels, and the battery pack detect signal on battery pack detection signal line 816 returns to its idle state logic high voltage level. The only current drawn from the battery pack is the small current through R1 802, the collector cutoff current of Q1 832, and the collector cutoff current of Q2 840. Q1 832 and Q2 840 are biased off during the charging of the capacitor C1 804. After the battery pack is removed, the capacitor C1 804 initially discharges through the base-emitter junction of Q1 832, R1 802, and R2 814. The current on the collector of Q1 832 will be much larger than its base current due to the gain of Q1 832. Once the current on the collector Q1 832 is high enough to raise the voltage across R4 836 higher than the base-emitter threshold voltage of Q2 840, Q2 840 starts to turn on. The battery detection circuit 800 is designed so that most of the current on the collector of Q1 832 flows through the base of Q2 840. The current on the collector of Q2 840 will be much larger than its base current due to the gain of Q2 840. The current on the collector of Q2 840 is sourced from the base of Q1 832. This forms a positive feedback loop that quickly increases the currents through both transistors until these currents are limited only by R5 835, R6 838, the saturation characteristics of Q1 832 and Q2 840, and by the voltage across C1 804. C1 804 quickly discharges until the voltage across it is approximately the base-emitter threshold voltage of Q1 832 or Q2 840 plus the collector-emitter saturation voltage of Q2 840 or Q1 832. At this point, the battery pack detection circuit 800 has been reset and can detect the connection/insertion of another battery pack. To the extent that any circuit components are not explicitly described in detail with respect to these embodiments of the circuit, the same functions of those components as previously described can be attributed to such components. However, any such components have been renumbered to start with a “8”.

R1 802 could be placed between the base of Q1 832 and the B− terminal 812 instead of across both terminals 812. In this configuration, shown in FIG. 8A, R1 802 drives the discharge network initially after a pack is removed instead of the series combination of R1 802 and R2 814.

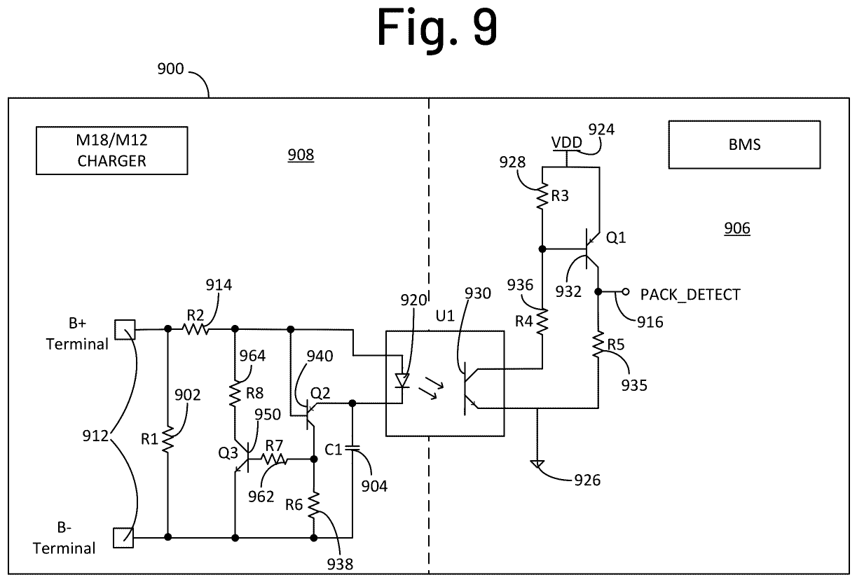

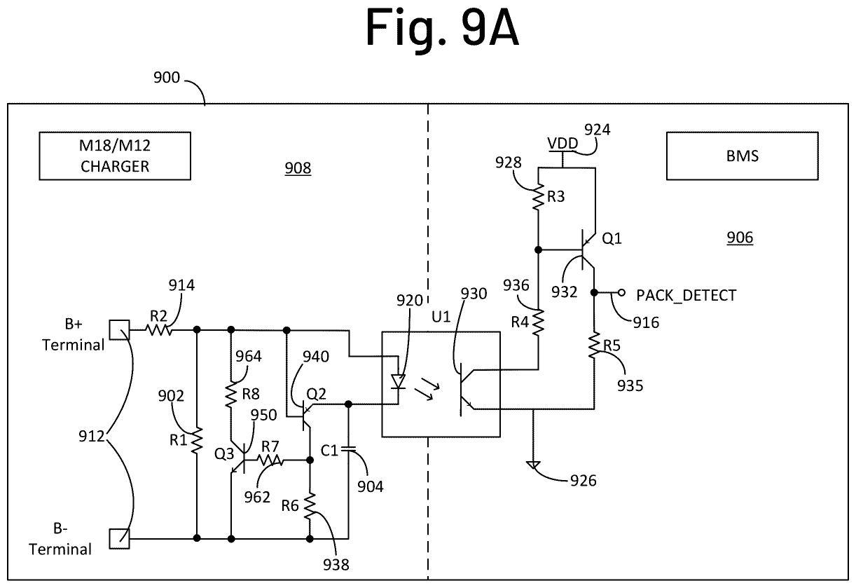

FIG. 9 shows another optocoupler circuit configuration 900. Optocoupler circuit configuration 900 combines the battery pack charger 808 from FIG. 8 with the BMS 506 from FIG. 5. Corresponding common components among the embodiments are not described further, but are identified with a “9” identifier.

Another optocoupler circuit configuration 900 is shown in FIG. 9A. It combines the battery pack charger 808 from configuration 800 (FIG. 8A) with the BMS 506 from configuration 500. Corresponding common components among the embodiments are not described further, but are identified with a “9” identifier.

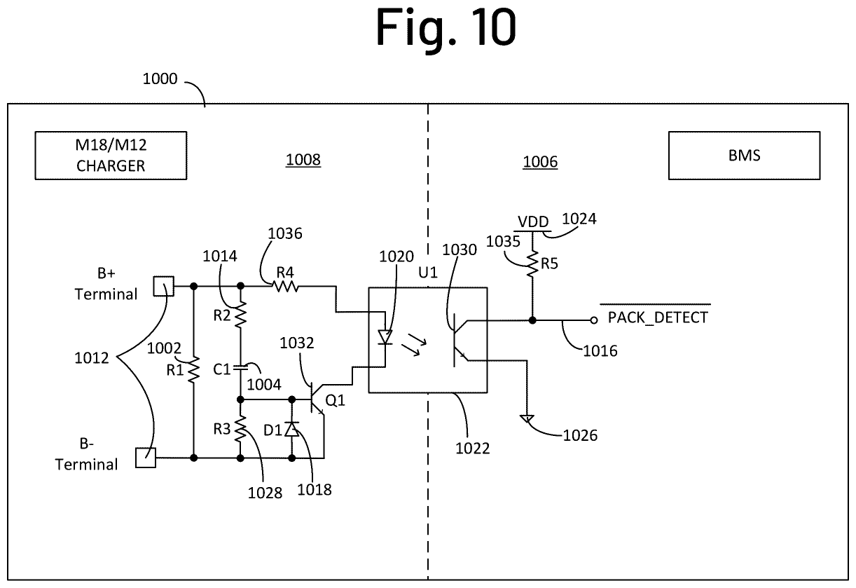

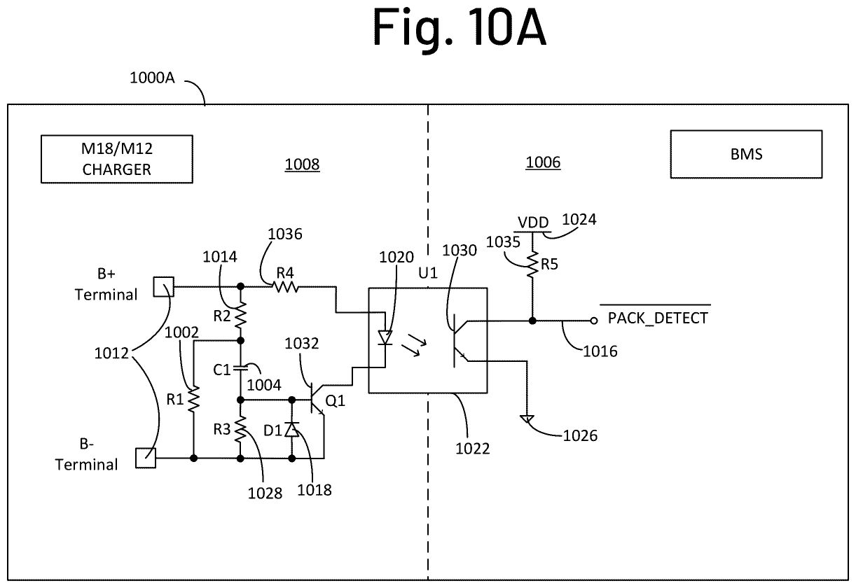

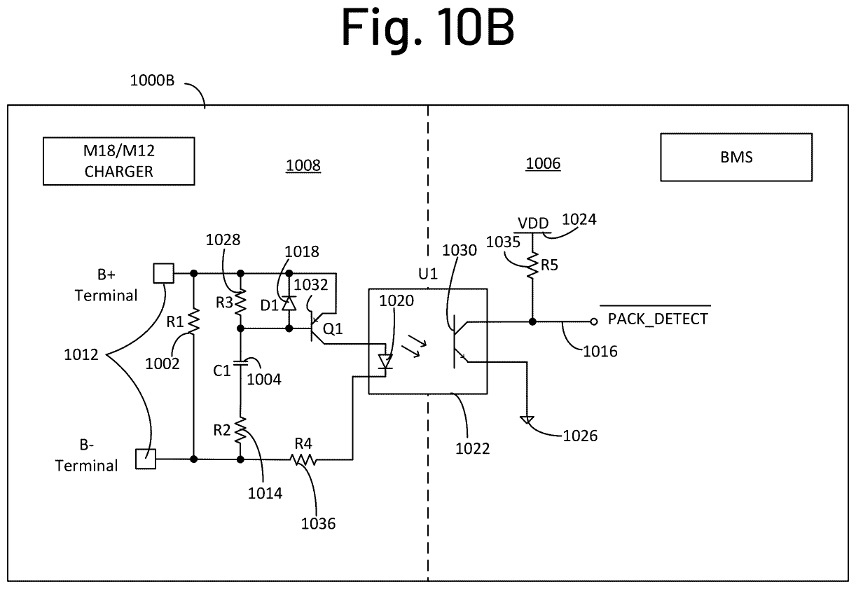

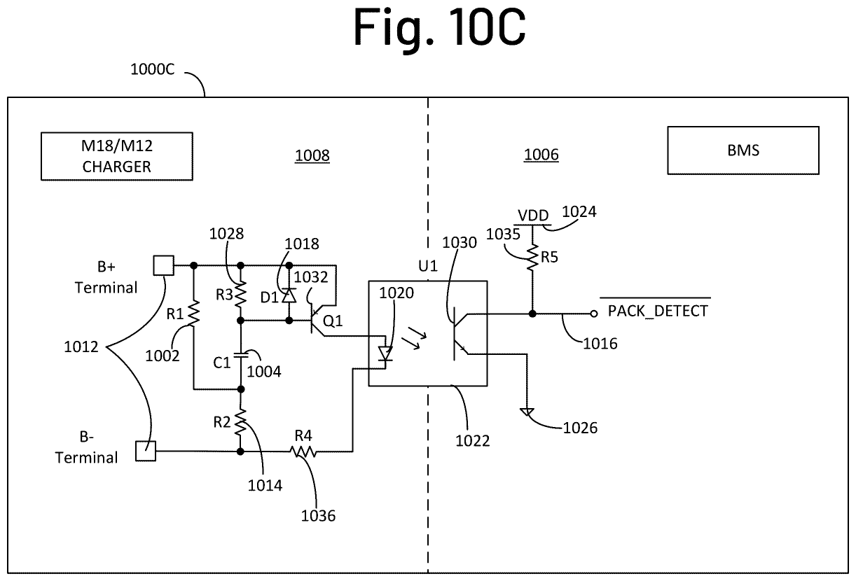

Optocoupler circuit configuration 1000 is shown in FIG. 10. R1 1002 is a resistor with a high impedance. It is configured to discharge the capacitor C1 1004 when no battery pack is connected to the terminals 1012. The high impedance limits current draw when a battery pack is connected to the terminals 1012. R2 1014 is a resistor that limits the rate at which C1 1004 charges after a battery pack is installed. This both keeps the circuit current within the current limitations of the battery detection circuit 1000 and also lengthens the logic low pulse on the battery pack detect signal on the battery pack detection signal line 1016 so that it can be more easily registered by circuitry in the BMS 1006. C1 1004 is a capacitor that causes current to flow through the base-emitter junction of Q1 1032 for a limited period of time after a battery pack is connected to both terminals 1012, generating a signal that can be communicated to the BMS 1006. It ceases drawing current from the battery pack after it is charged. D1 1018 allows C1 1004 to discharge through R2 1014 and R1 1002 when no battery pack is connected to both terminals 1012. It also prevents reverse avalanche of the base-emitter junction of Q1 1032. R3 1028 keeps Q1 1032 biased off against small voltage or current fluctuations (especially after C1 1004 has fully charged) and provides some immunity against noise. It also permits C1 1004 to discharge to a voltage lower than the forward voltage of D1 1018. Q1 1032 is an NPN BJT that amplifies the charge current of C1 1004, turning it into a much larger current that is used to drive the LED 1020. This affords much more flexibility in the overall design of the battery detection circuit 1000. R4 1036 limits the current through LED 1020 and the collector-emitter junction of Q1 1032 so that it is within the limitations of the components of the battery detection circuit 1000. Optocoupler U1 (“U1”) is an optocoupler 1022 or optoisolator that provides galvanic isolation between the battery pack charger 1008 and BMS 1006 sides of this battery pack detection circuit 1000. The positive logic supply voltage 1024 (“VDD”) is disposed in the BMS 1006. The common signal represents the negative logic supply voltage 1026 within the BMS 1006. R5 1035 is a pullup resistor that causes the battery pack detected signal on the battery pack detection signal line 1016 to idle at a logic high voltage level but also permits this signal to decrease to a logic low voltage level when current flows through the phototransistor 1030 of the optocoupler 1022.

When a battery pack is connected, the voltage across the battery pack appears between the terminals 1012 and charges C1 1004 through R2 1014 and the base-emitter junction of Q1 1032. A small current flows through R3 1028, but it has little effect on operation of the battery detection circuit 1000. While C1 1004 is charging, a current flows through the base-emitter junction of Q1 1032. The current on the collector of Q1 1032 will be much larger than its base current due to a gain of Q1 1032. The collector current of Q1 1032 drives the LED 1020 of optocoupler 1022, which turns on the phototransistor 1030 inside optocoupler 1022. This draws current through R5 1035, decreasing the voltage of the battery pack detect signal on the battery pack detection signal line 1016 to a logic low voltage level that the BMS 1006 will register as a pack detected signal. Once C1 1004 fully charges, no more current flows through R2 1014, the base-emitter junction of Q1 1032, or C1 1004. Q1 1032 turns off (this is aided by R3 1028). The LED 1020 and phototransistor 1030 turn off, the current flow through R5 1035 decreases to negligible levels, and the battery detect signal on the battery pack detection signal line 1016 returns to its idle state logic high voltage level. The only current drawn from the battery pack charger 1008 is the small current through R1 1002 and the collector cutoff current of Q1 1032. When battery pack is removed, the capacitor C1 1004 discharges through D1 1018, R3 1028, R2 1014, and R1 1002 until its voltage drops to a very low level. At this point, the battery detection circuit has been reset and can detect the connection/insertion of another battery pack. To the extent that any circuit components are not explicitly described in detail with respect to these embodiments of the circuit, the same functions of those components as previously described can be attributed to such components. However, any such components have been renumbered to start with a “10”.

R1 1002 could be placed between C1 1004 and the B− terminal 1012 instead of across both terminals 1012. This configuration 1000A is shown in FIG. 10A. In this configuration, C1 1004 discharges through D1 1018, R3 1028 and R1 1002 after a battery pack is removed. R2 1014 is no longer in the discharge path.

Q1 1032 could be a PNP BJT instead of an NPN BJT. FIG. 10B shows this modification applied to configuration 1000, resulting in configuration 1000B. FIG. 10C shows this modification applied to configuration 1000A, resulting in configuration 1000C.

It is contemplated that the charger-side fast capacitor discharge circuits of configurations 600 and 800, or suitable adaptations of thereof, could be readily applied to discharge capacitor C1 in configurations 1000, 1000A, 1000B, and 1000C.

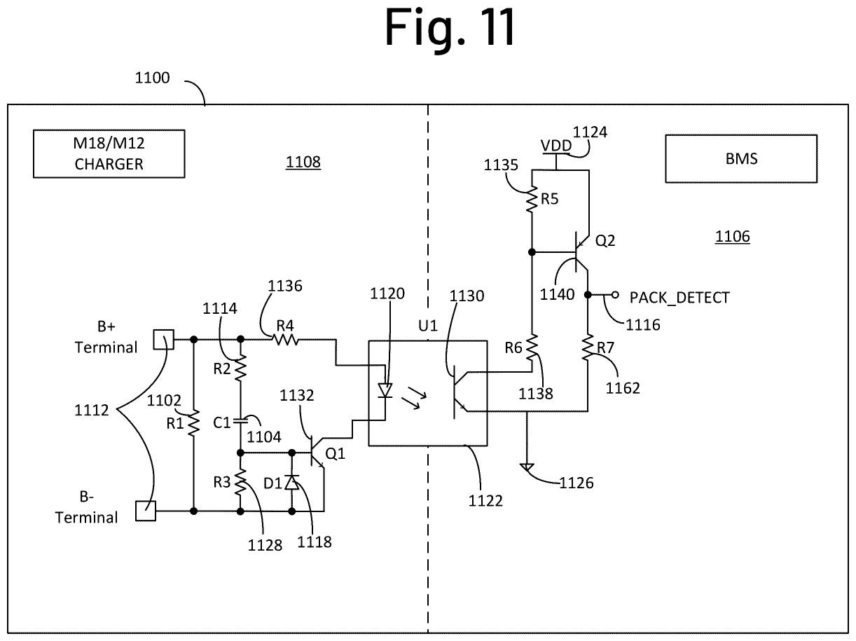

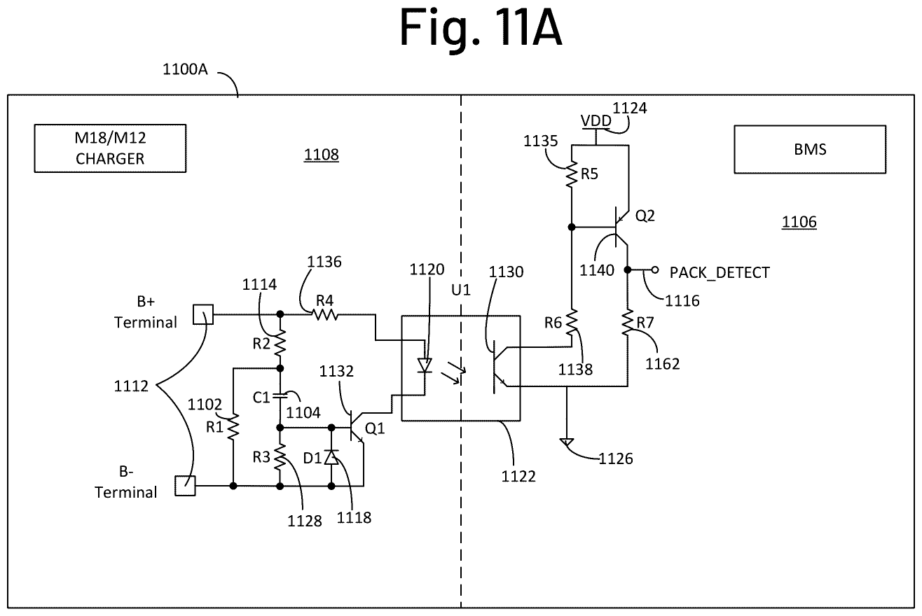

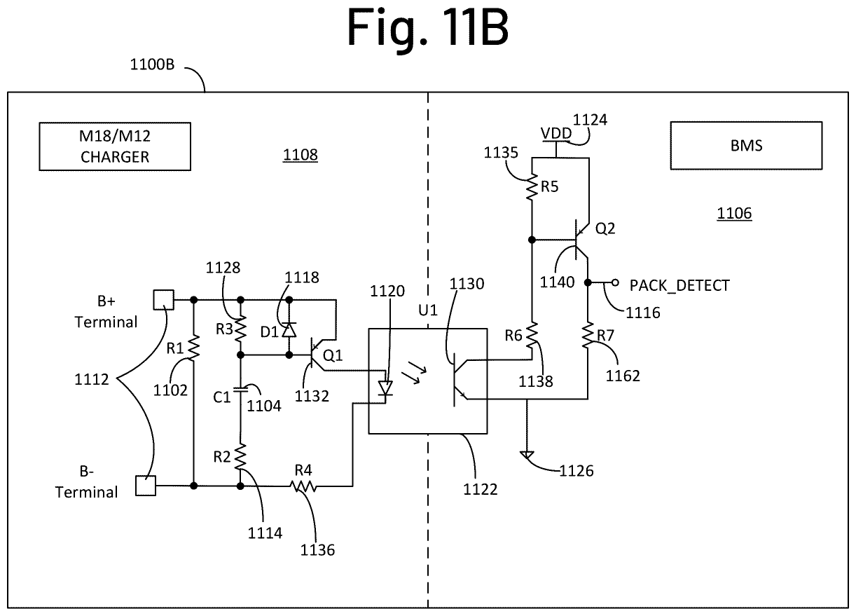

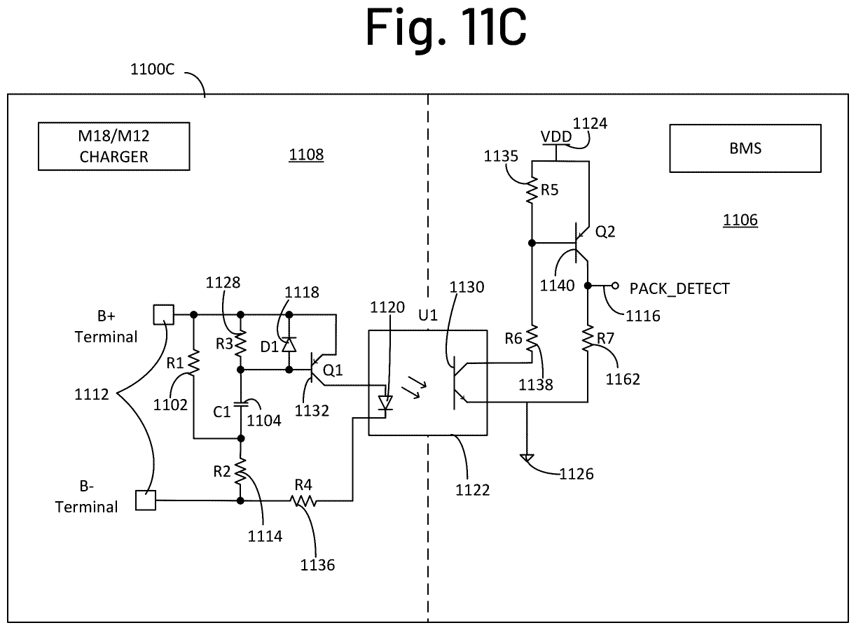

FIG. 11 shows another optocoupler circuit configuration 1100. Configuration 1100 combines the battery pack charger 1008 from configuration 1000 with the BMS 506 from configuration 500. Corresponding common components among the embodiments are not described further, but are identified with a “11” identifier.

Optocoupler circuit configuration 1100A is shown in FIG. 11A. It combines the configuration 1000A with the BMS 506 from configuration 500. Corresponding common components among the embodiments are not described further, but are identified with a “11” identifier.

Q1 1132 could be a PNP BJT instead of an NPN BJT. FIG. 11B shows this modification applied to configuration 1000, resulting in configuration 1100B. FIG. 11C shows this modification applied to configuration 1000, resulting in configuration 1100C.

It is contemplated that the charger-side fast capacitor discharge circuits of configurations 600 and 800, or suitable adaptations of thereof, could be readily applied to discharge capacitor C1 1104 in configurations 1100, 1100A, 1100B, and 1100C.

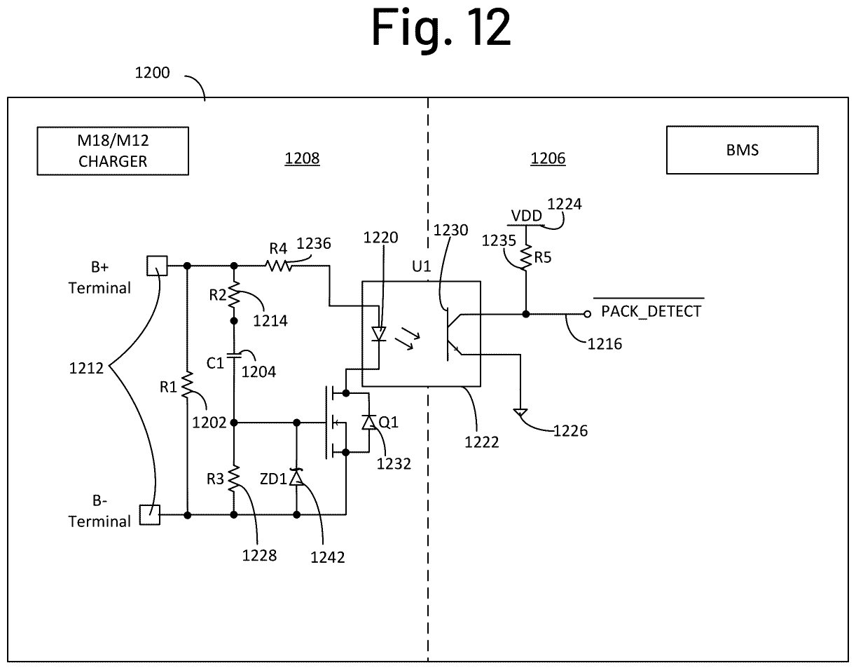

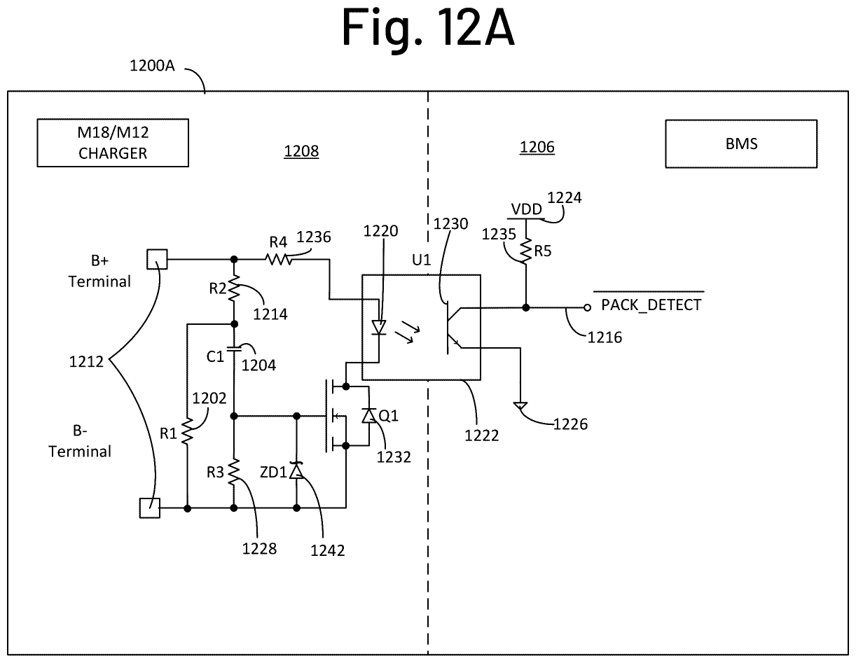

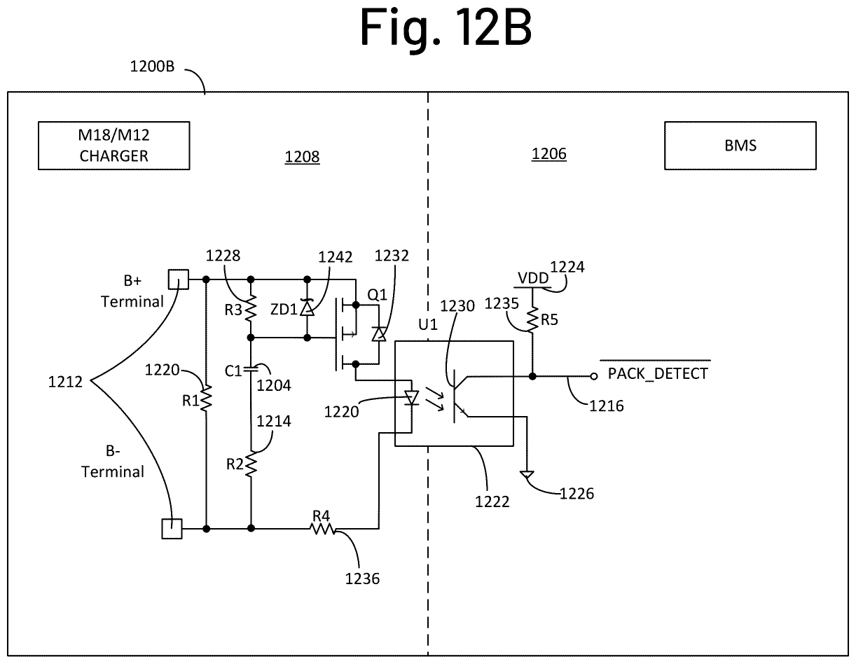

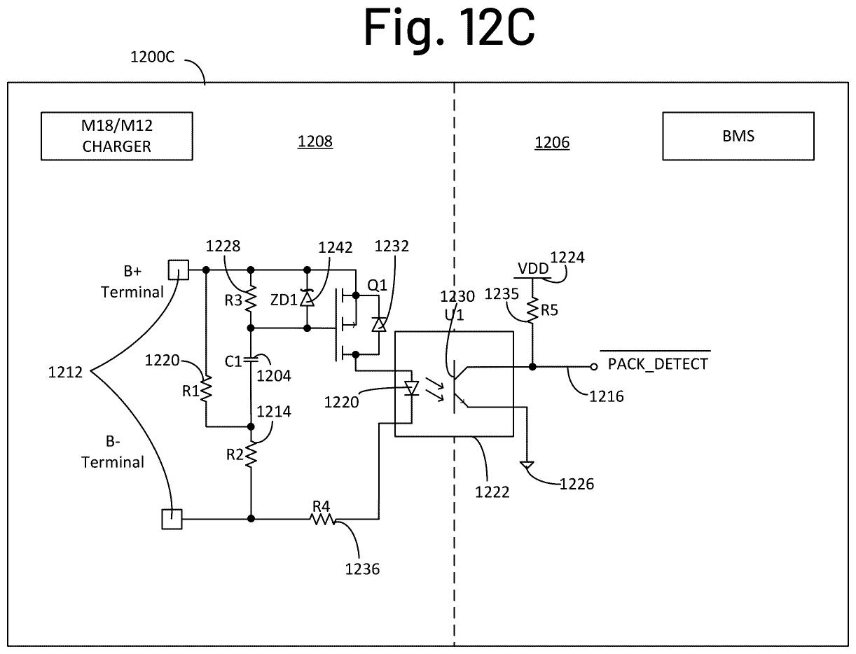

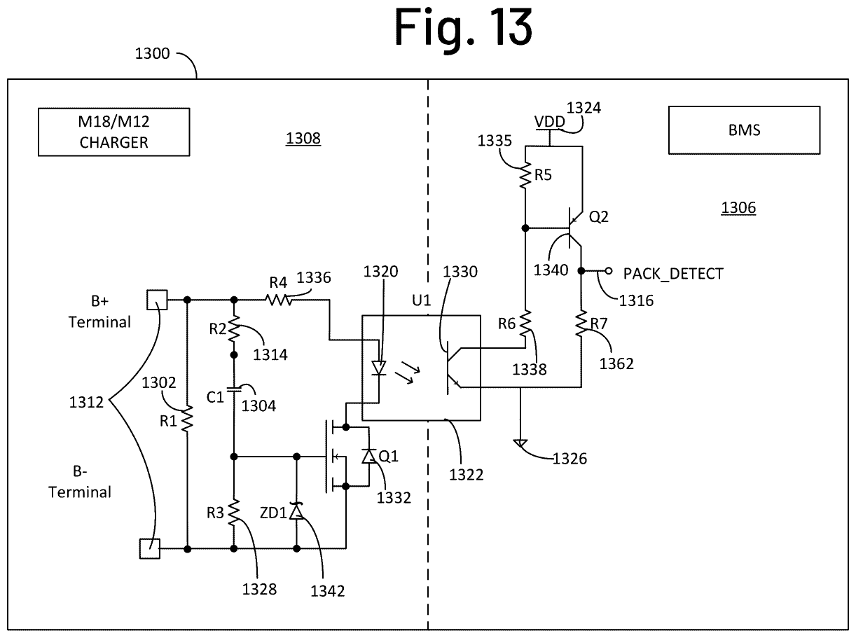

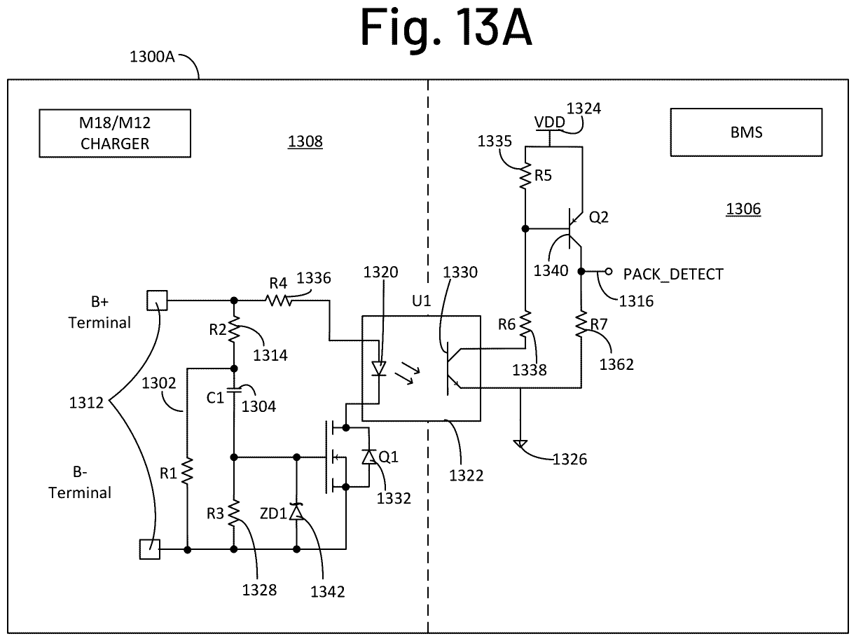

Optocoupler circuit configuration 1200 is shown in FIG. 12. Q1 1232 is an N-Channel MOSFET that closes and draws current through R4 1236 and LED 1220 when its gate-source voltage exceeds some threshold voltage. C1 1204 is charged through R2 1214 and R3 1228 to the full voltage across the terminals 1212 after the battery pack is installed. C1 1204 ensures that the voltage on the gate of Q1 1232 decreases at a designed rate after the battery pack is installed, keeping Q1 1232 on for the desired length of time. After C1 1204 fully charges, Q1 1232 remains off, and no more current flows through C1 1204, R2 1214, or R3 1228. ZD1 1242 is an optional Zener diode that limits the gate-source voltage of Q1 1232 to levels that will not cause damage to Q1 1232. R2 1214 is an optional resistor that limits the peak current through C1 1204 and ZD1 1242 after the battery pack is initially connected. R3 1228, together with the values of C1 1204 and R2 1214, sets the time constant at which C1 1204 charges after the battery pack is connected. In most configurations, R3 1228 is of a higher impedance than R2 1214.

When a battery pack is connected, the voltage across the battery pack appears between the terminals 1212. This voltage charges C1 1204 through R2 1214 and R3 1228. C1 1204 starts at a very low voltage. R2 1214 and R3 1228 are sized so that more of the battery pack voltage appears across R3 1228 (and the gate of Q1 1232) than across R2 1214. Q1 1232 turns on due to its gate-source voltage being high enough to enhance its channel. Current flows through R4 1236, the drain of Q1 1232, and the LED 1220, which turns on the phototransistor 1230 inside optocoupler 1222. This draws current through R5 1235, decreasing the voltage of the battery pack detect signal to a logic low voltage level that the BMS 1206 will register as a pack detected signal. As C1 1204 charges, an increasing amount of the pack voltage appears across C1 1204. Eventually, the voltage across gate of Q1 1232 is no longer high enough to enhance the channel of Q1 1232, and Q1 1232 turns off. The LED 1220 and phototransistor 1230 inside optocoupler 1222 turn off, the current flow through R5 1235 decreases to negligible levels, and the battery pack detect signal on battery detection signal line 1216 returns to its idle state logic high voltage level. The only current drawn from the battery pack is the small current through R1 1202 and the drain-source leakage current of Q1 1232. After a battery pack is removed, the capacitor C1 1204 discharges through ZD1 1242, R3 1228, R2 1214, and R1 1202 until its voltage drops to a very low level. At this point, the battery detection circuit has been reset and can detect the connection/insertion of another battery pack. To the extent that any circuit components are not explicitly described in detail with respect to these embodiments of the circuit, the same functions of those components as previously described can be attributed to such components. However, any such components have been renumbered to start with a “12”.

R1 1202 could be placed between C1 1204 and the B− terminal 1212 instead of across the terminals 1212, as shown in FIG. 12A. In this configuration 1200A, C1 1204 discharges through ZD1 1242, R3 1228, and R1 1202 after a battery pack is removed. R2 1214 is no longer in the discharge path.

Q1 1232 could be a P-Channel MOSFET instead of an N-Channel MOSFET. FIG. 12B shows this modification applied to configuration 1200, resulting in configuration 1200B. FIG. 12C shows this modification applied to configuration 1200A, resulting in configuration 1200C.

It is contemplated that the charger-side fast capacitor discharge circuits of configurations 600 and 800, or suitable adaptations of thereof, could be readily applied to discharge capacitor C1 1204 in configurations 1200, 1200A, 1200B, and 1200C.

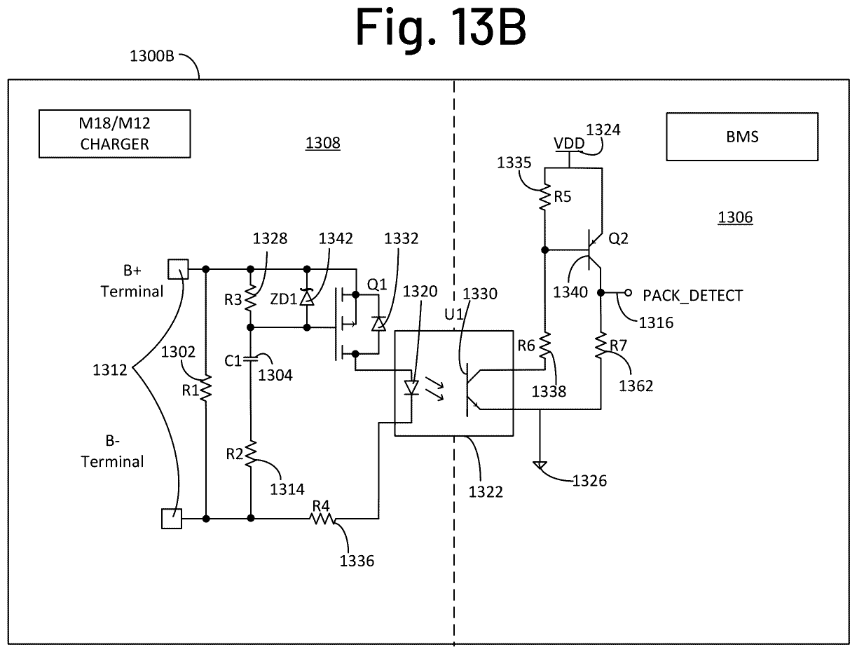

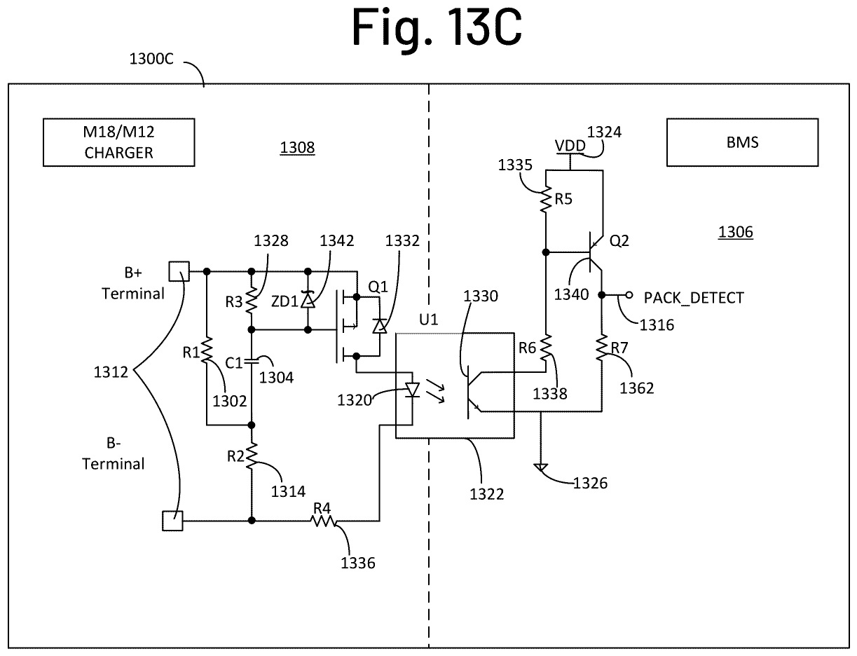

FIG. 13 shows another optocoupler circuit configuration 1300. The configuration combines the battery pack charger 1208 from configuration 1200 with the BMS 706 from configuration 700. Corresponding common components among the embodiments are not described further, but are identified with a “13” identifier.

Optocoupler circuit configuration 1300A is shown in FIG. 13A. It combines the battery pack charger 1208 from configuration 1200A with the BMS 706 from configuration 700. Corresponding common components among the embodiments are not described further, but are identified with a “13” identifier.

Q1 1332 could be a P-Channel MOSFET instead of an N-Channel MOSFET. FIG. 13B shows this modification applied to configuration 1300, resulting in configuration 1300B. FIG. 13C shows this modification applied to configuration 1300A, resulting in configuration 1300C.

It is contemplated that the charger-side fast capacitor discharge circuits of configurations 600 and 800, or suitable adaptations of thereof, could be readily applied to discharge capacitor C1 1304 in configurations 1300, 1300A, 1300B, and 1300C.

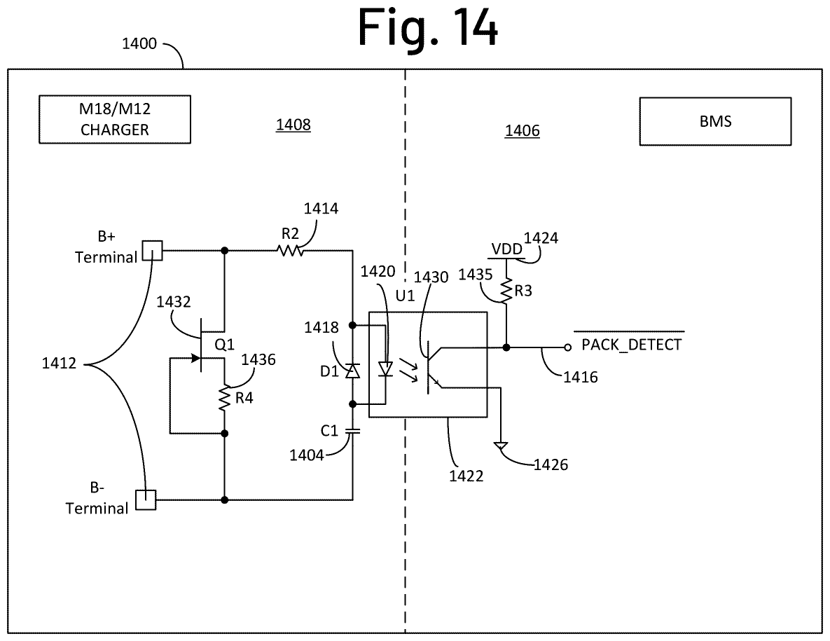

In any of the optocoupler circuit configurations 400-1300, or related configurations, the resistor R1 may be replaced with a current sink circuit formed from an N-Channel JFET (Junction Field Effect Transistor) and an optional resistor. FIG. 14 shows optocoupler circuit configuration 1400 modified in this fashion. Q1 1432 and R4 1436 are the aforementioned JFET and resistor. Corresponding common components among the embodiments are not described further, but are identified with a “14” identifier.

The current sink formed from the JFET may provide a better tradeoff between C1 1404 discharge time and battery pack quiescent current draw than the resistor R1 did. This circuit causes a relatively constant current to flow through the drain terminal of the JFET even when the voltage across its drain and gate terminals of the JFET vary over a fairly wide range.

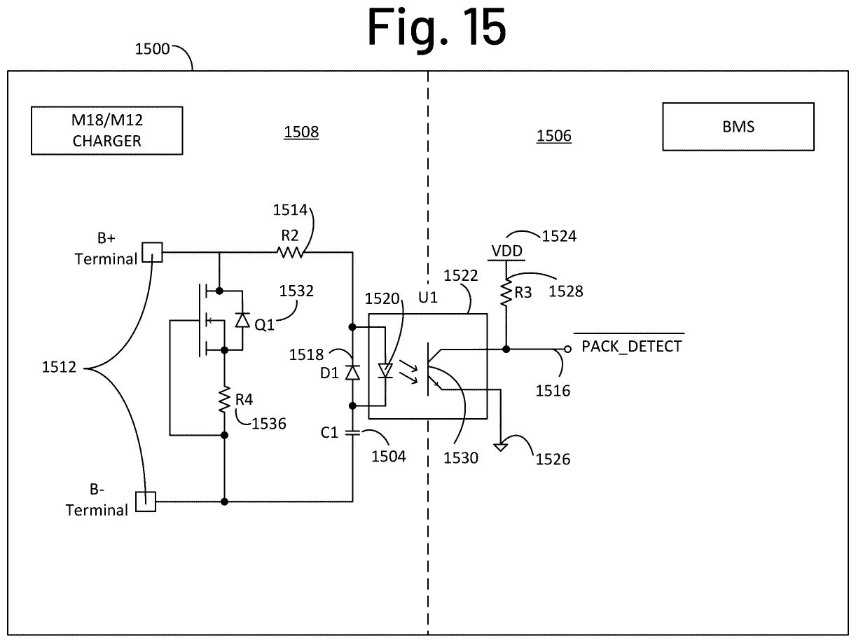

In any of the optocoupler circuit configurations 400-1300, or related configurations, the resistor R1 may be replaced with a current sink circuit formed from a depletion mode N-Channel MOSFET and a resistor. FIG. 15 shows optocoupler circuit configuration 400 modified in this fashion as configuration 1500. Q1 1532 and R4 1536 are the aforementioned MOSFET and resistor. Corresponding common components among the embodiments are not described further, but are identified with a “15” identifier.

The depletion mode N-Channel MOSFET current sink circuit may provide a better tradeoff between C1 1504 discharge time and battery pack quiescent current draw than the resistor R1. This configuration 1500 causes a relatively constant current to flow through its drain terminal even when the voltage across the drain and gate terminals of the N-Channel MOSFET varies over a fairly wide range.

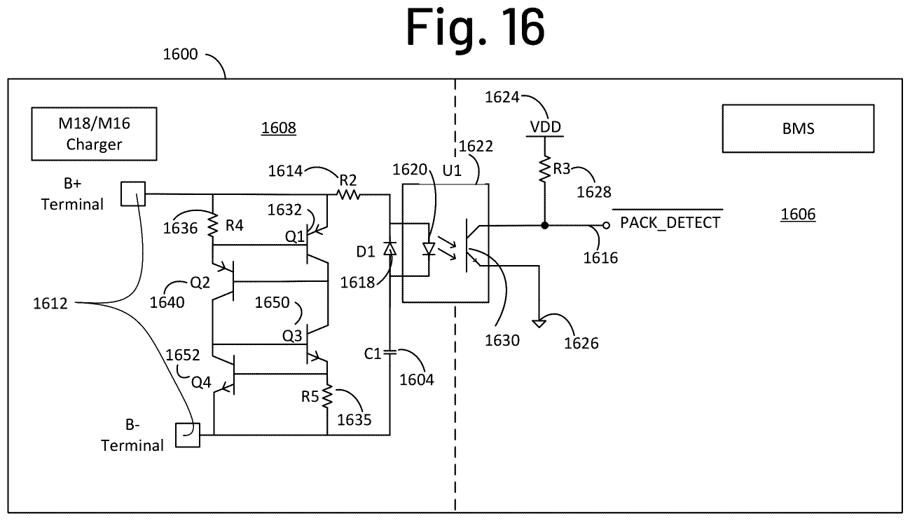

In any of the optocoupler circuit configurations 400-1300, or related configurations, the resistor R1 may be replaced with a current sink circuit formed from two PNP BJTs, two NPN BJTs, and two resistors. FIG. 16 shows optocoupler circuit configuration 400 modified in this fashion. Q1 1632, Q2 1640, transistor Q3 (“Q3”) 1650, transistor Q4 (“Q4”) 1652, R4 1636, and R5 1635 are the aforementioned BJTs and resistors. Corresponding common components among the embodiments are not described further, but are identified with a “16” identifier.

The bipolar current sink circuit 1600 may provide a better tradeoff between C1 discharge time and battery pack quiescent current draw than the resistor R1. This configuration 1600 causes a relatively constant current to flow even when the voltage across it varies over a fairly wide range.

Configurations 1400, 1500, and 1600 employ constant current circuits constructed from discrete components (JFET, depletion mode N-Channel MOSFET, NPN & PNP BJTs, resistors). There are also components available commercially that perform this function. Some are called current regulating diodes, others are simply called current sources or current sinks. Some of these are integrated circuits. Some may require an external component such as a resistor, while others may not. Any such component could take the place of the constant current circuitry in configurations 1400, 1500, or 1600.

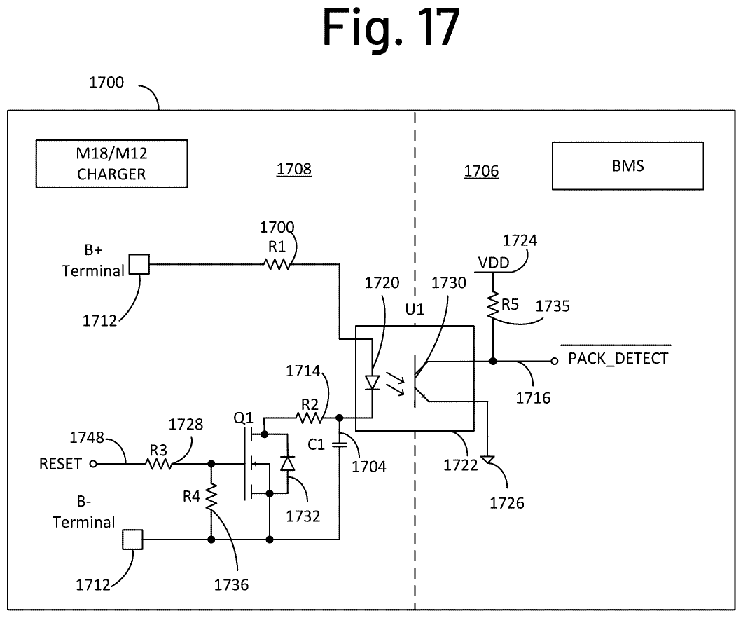

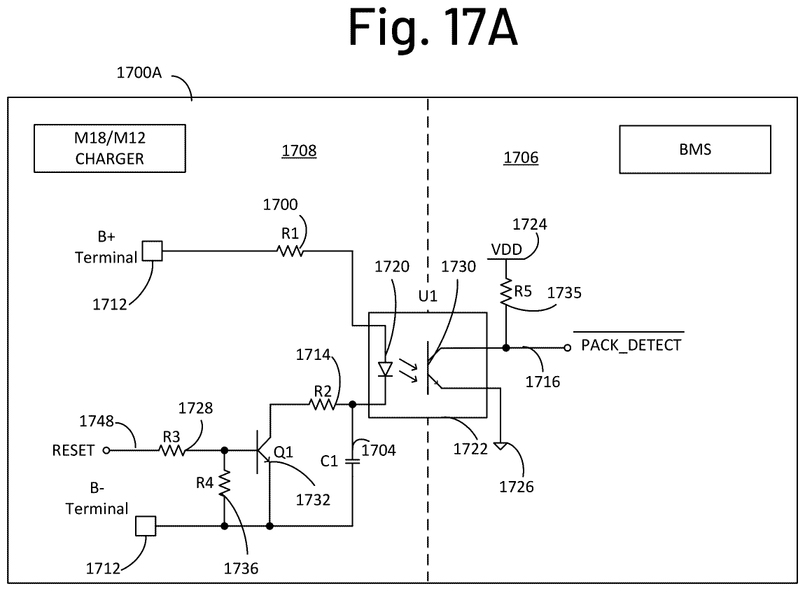

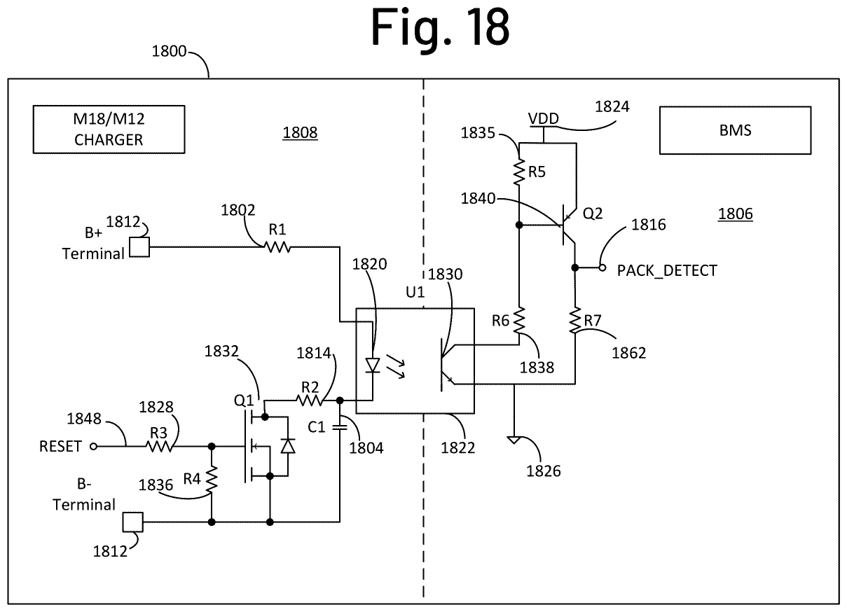

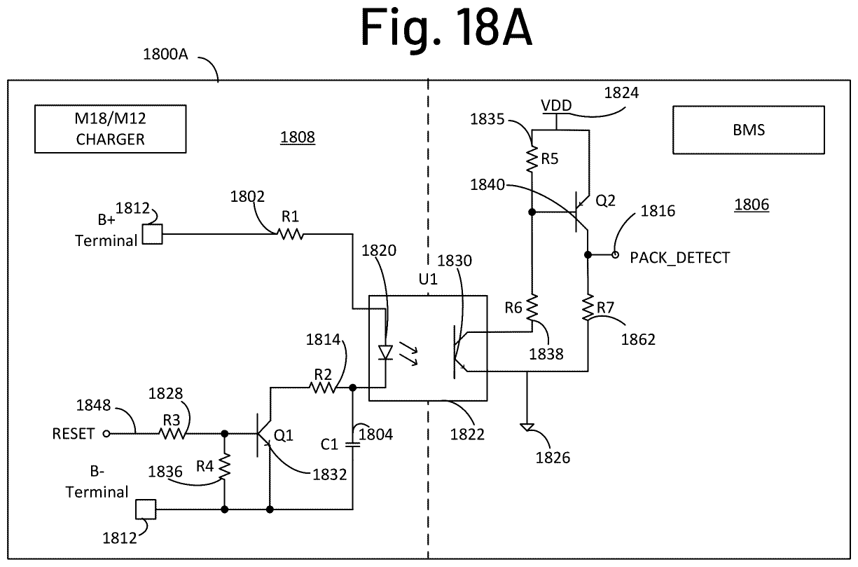

FIG. 17 shows configuration 1700, which is a new class of optocoupler-based circuit. All previous optocoupler circuit configurations employed components that would automatically discharge C1 1704 and reset the battery detection circuit 1738 after the battery pack is removed. Configuration 1700 differs from this scheme by requiring a RESET signal generated by a microcontroller 236 or other circuit within the battery pack charger 1708 to activate the circuitry that resets the battery pack detection circuit 1700 (here, Q1 1732 and R2 1714).

A benefit of configuration 1700 is lower long-term current draw from the battery pack when it is installed (there is no resistor between the B+ and B− terminals 1712).

R1 1702 is a resistor that limits the rate at which C1 1704 charges after a battery pack is connected to the terminals 1712. This both keeps the circuit current within device limitations and also lengthens the logic low pulse on the battery pack detect signal on the battery pack detection signal line 1716 so that it can be more easily registered by circuitry in the BMS 1706. C1 1704 causes significant current to flow through LED 1720 for a limited period of time after a battery pack is installed on the B+ and B− terminals 1712, generating a signal that can be communicated to the BMS 1706. It ceases drawing current from the battery pack after it is charged. Q1 1732 is an N-Channel MOSFET that discharges C1 1704 through R2 1714 when the voltage of the RESET signal on the reset signal line 1748 is high enough to enhance its channel. R3 1728 limits the peak current into the gate of Q1 1732 in the case where the RESET signal has the property of transitioning very quickly from a near-zero voltage to a voltage high enough to enhance the channel of Q1 1732. R4 1736 is an optional resistor that keeps Q1 1732 biased in an off state against leakage current from the circuit that generates the RESET signal on the reset signal line 1748. R4 1736 may also prevent Q1 1732 turn on against Miller charge injected into the gate of Q1 1632 through parasitic capacitances when there is a rising voltage on the drain terminal of Q1 1732. R2 1714 limits the current flowing into the drain terminal of Q1 1732 when Q1 1732 is turned on. This may only occur when C1 1704 is charged and no battery is installed/connected, but R2 1714 also helps limit current if Q1 is turned on while a battery pack is installed/connected. Optocoupler 1722 is an optocoupler or optoisolator that provides galvanic isolation between the battery pack charger 1708 side and BMS 1706. VDD is the positive logic supply voltage 1724 within the BMS 1706. The common signal represents the negative logic supply voltage 1726 within the BMS 1706. R5 1735 is a pullup resistor that causes the battery pack detection signal line 1716 to idle at a logic high voltage level but also permits this signal to decrease to a logic low voltage level when current flows through the phototransistor 1730 of optocoupler 1722.

When the battery pack is inserted, the voltage across the battery pack appears between the terminals 1712. This voltage charges C1 1704 through R1 1702 and the LED 1720 of optocoupler 1722. While C1 1704 is charging, a current flows through the LED 1720 of optocoupler 1722 that turns on both the LED 1720 and phototransistor 1730. This draws current through R5 1735, decreasing the voltage of the battery detect pack signal on the battery pack detection signal line 1716 to a logic low voltage level that the BMS 1706 will register as a battery pack detected signal. Once C1 1704 fully charges, no more current flows through R1 1602, the LED 1720 of optocoupler 1722, or C1 1704. The LED 1720 and phototransistor 1730 inside optocoupler 1722 turn off, the current flow through R5 1735 decreases to negligible levels, and the battery pack detect signal on the battery pack detection signal line 1716 returns to its idle state logic high voltage level. The only current drawn from the battery pack is the leakage current through the drain of Q1 1732 and R2 1714.

Once the insertion of the battery pack is detected, the BMS 1706 will power on the battery pack charger 1708 if permitted by the system logic. After the battery pack charger 1708 turns on and detects that the battery pack has been removed, a microcontroller 236 or other circuitry within the battery pack charger 1708 increases the voltage on the RESET signal high enough to enhance the channel of Q1 1732. Q1 1732 turns on and discharges C1 1704 through R2 1714. The voltage on C1 1704 decreases to a very low level. The microcontroller 236 or other circuit sets the voltage of the RESET signal back to a near-zero level. At this point, the battery pack detection circuit 1700 has been reset and can detect the connection of another battery pack. To the extent that any circuit components are not explicitly described in detail with respect to these embodiments of the circuit, the same functions of those components as previously described can be attributed to such components. However, any such components have been renumbered to start with a “17”.

In one configuration 1700A, shown in FIG. 17A, an NPN BJT could be used in place of an N-Channel MOSFET to reset the circuit under control of an MCU 236 on the charger side of the isolation barrier.

FIG. 18 shows another optocoupler circuit configuration 1800. This one combines the battery pack charger from configuration 1700 with the BMS 706 from configuration 700. Corresponding common components among the embodiments are not described further, but are identified with a “18” identifier.

An NPN BJT could be used in place of an N-Channel MOSFET to reset the battery pack detection circuit 1800 under control of an MCU 236 on the charger side of the isolation barrier, as shown in FIG. 18A and configuration 1800A.

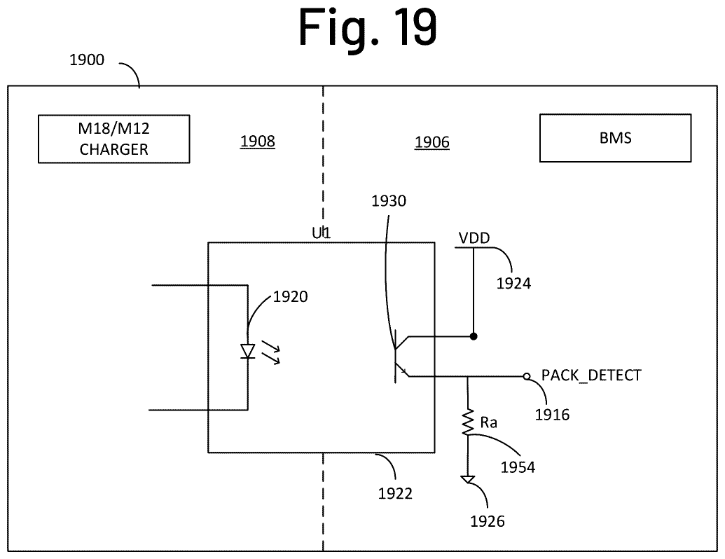

For optocoupler circuit configurations 400-1800, and variations of those configurations, the output circuit on the BMS could be reconfigured as configuration 1900 in FIG. 19. The resistor R a 1952 serves to keep the battery pack detect signal on the battery detect signal line 1916 in logic low state by default, and the phototransistor 1930 increases the voltage on that signal to a logic high level voltage when it emits an output pulse after a battery pack is connected. Corresponding common components among the embodiments are not described further, but are identified with a “19” identifier.

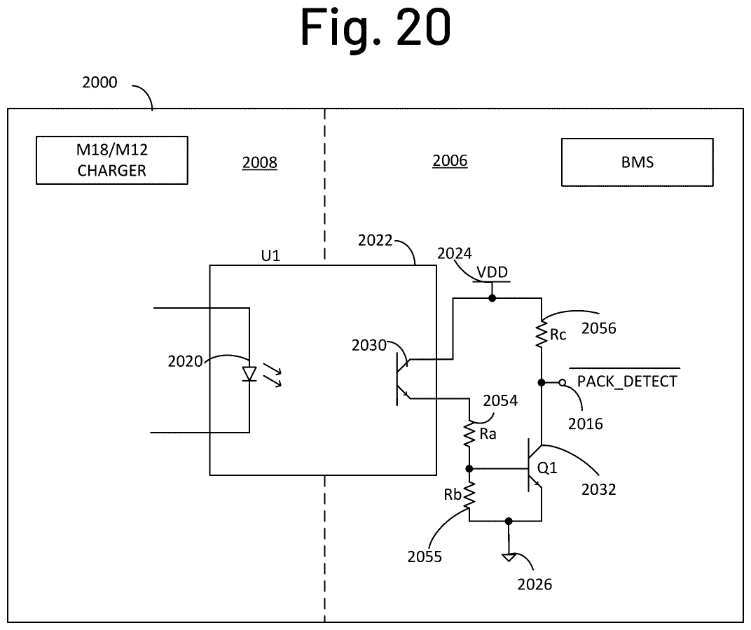

For optocoupler circuit configurations 500, 500A-D, 700, 700A, 900, 900A, 1100, 1100A-C, 1300, 1300A-C, the 1400, 1500, and 1600 variations of those configurations, and optocoupler circuit configurations 1800 and 1800A, the output circuit on the BMS side could be reconfigured as shown in FIG. 20 as configuration 2000.

The resistor R_{c} 2056 serves to keep the battery pack detect signal on the battery pack detection signal line 2016 in logic high state by default. When phototransistor 2030 turns on in response to a battery pack being connected, it turns on transistor Q1 2032, which draws current through resistor R_{c} 2056 and brings the battery pack detect signal battery pack detection signal line 2016 to a logic low voltage for a brief period of time, indicating the detection of an insertion/connection of a battery pack to the terminals (not shown).

R a 2054 is an optional resistor that limits the emitter current of optocoupler 2022 and the base current of Q1 2032. Resistor Rb 2055 keeps Q1 2032 off against the dark current of phototransistor 2030.

In many of these optocoupler circuit configurations, resistors limit the charge current of capacitor C1. In some variants, there is a separate resistor that limits the current through LED 2020. These resistors could be replaced by constant current circuits to good effect. Such circuits may provide some or all of the following benefits: capacitor C1 charges linearly instead of exponentially, allowing a better tradeoff between C1 value and C1 charge time and/or more flexibility in design of the output circuitry, including the optocoupler 2022. The battery pack voltage range over which the battery pack detection circuit 2000 operates could possibly be increased, depending on the construction of the constant current circuit. To the extent that any circuit components are not explicitly described in detail with respect to this embodiments of the circuit, the same functions of those components as previously described can be attributed to such components. However, any such components have been renumbered to start with a “20”.

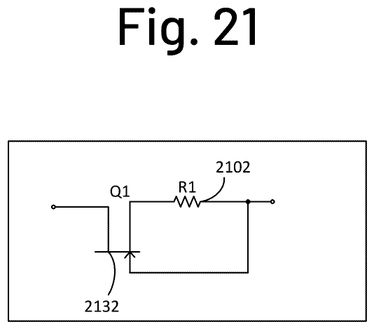

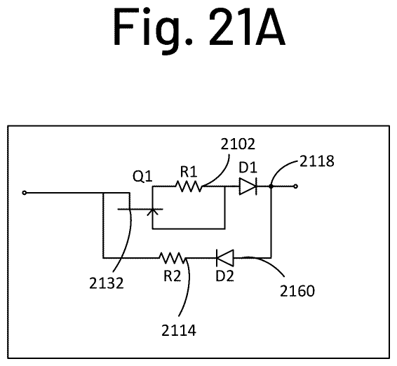

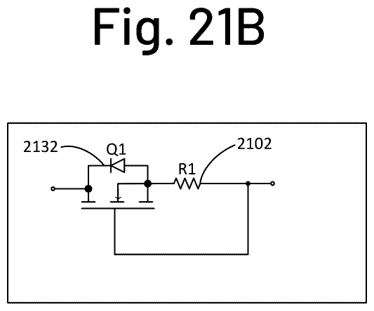

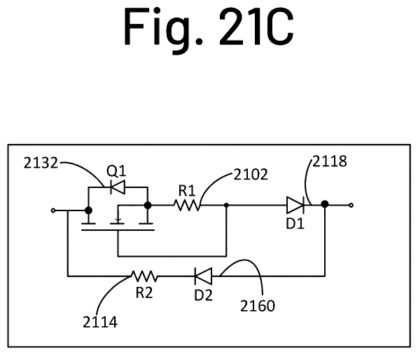

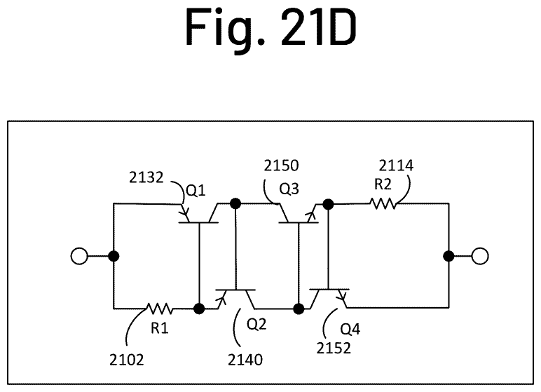

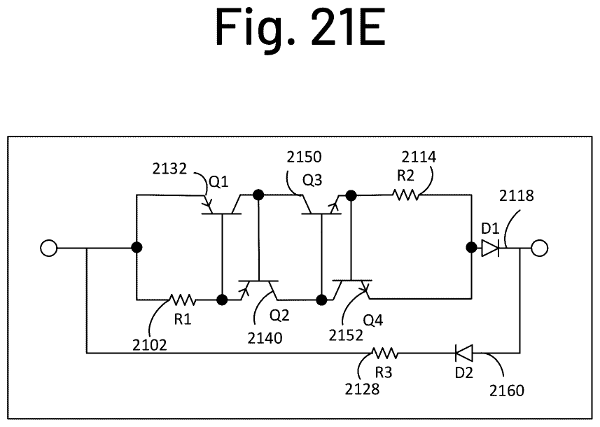

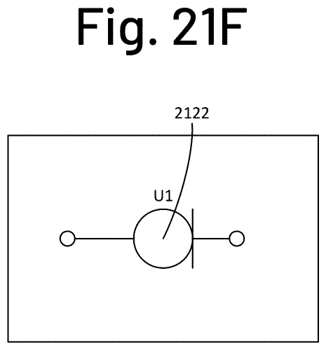

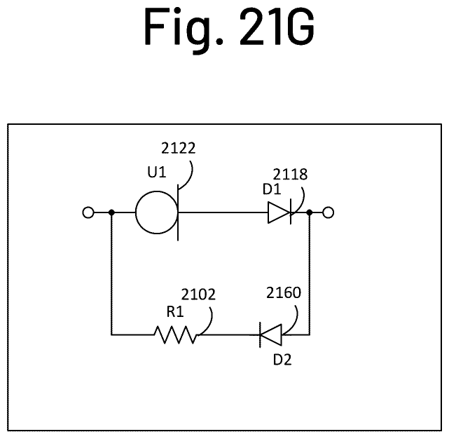

Four basic constant current circuit configurations are shown in FIG. 21 and FIG. 21A-G. The circuits are configured so that the left side of the circuit is at a more positive voltage than the right side when current is being regulated by the circuit.

Depending on how the constant current circuit is used within the overall battery pack detection circuit 2100 it may need to be protected against reverse voltage. Constant current circuit configurations FIG. 21A, FIG. 21C, FIG. 21E, and FIG. 21G. The decision of whether to use such a protected constant current circuit configuration should not be decided at this high level because it depends on the likelihood of the constant current circuit experiencing reverse voltage, the magnitude of that reverse voltage, and the properties of the components that make up the constant current circuit.

The configurations shown in FIG. 21 and FIG. 21A are made with an N-Channel JFET 2132 and an optional resistor 2102. Corresponding common components among the embodiments are not described further, but are identified with a “21” identifier.

The configurations shown in FIG. 21B and FIG. 21C are made with a depletion mode N-Channel MOSFET 2132 and a resistor 2102. Corresponding common components among the embodiments are not described further, but are identified with a “21” identifier.

The configurations shown FIG. 21D and FIG. 21E are made with two PNP BJTs (Q1 2132 & Q2 2140), two NPN BJTs (Q3 2150 & Q4 2152), and two resistors (R1 2102 & R2 2114). Corresponding common components among the embodiments are not described further, but are identified with a “21” identifier.

The configurations FIG. 21F and FIG. 21G are made with a current limiting device that could be a current limiting diode, a current source or current sink integrated circuit, whether such a device requires additional external components or not. This device is designated 2122 in both configurations. Corresponding common components among the embodiments are not described further, but are identified with a “21” identifier.

Table 1 provides a list showing which optocoupler circuit configurations could replace which of their components with any of the constant current circuit configurations listed above.

TABLE 1
APPLICABILITY OF CONSTANT CURRENT
CIRCUITS TO OPTOCOUPLER CIRCUITS

| Optocoupler Circuit | Component(s) Possibly Replaced |
|---|---|
| Configuration(s) | with a Constant Current Circuit |
| 400-900, 400A-900A, 400B, | R2 |
| 500B, 400C, 500C, 400D, 500D | |
| 1000-1300, 1000A-1300A, | R2, R4 |
| 1000B-1300B, 1000C-1300C | |
| 1700, 1800, 1700A, 1800A | R1 |

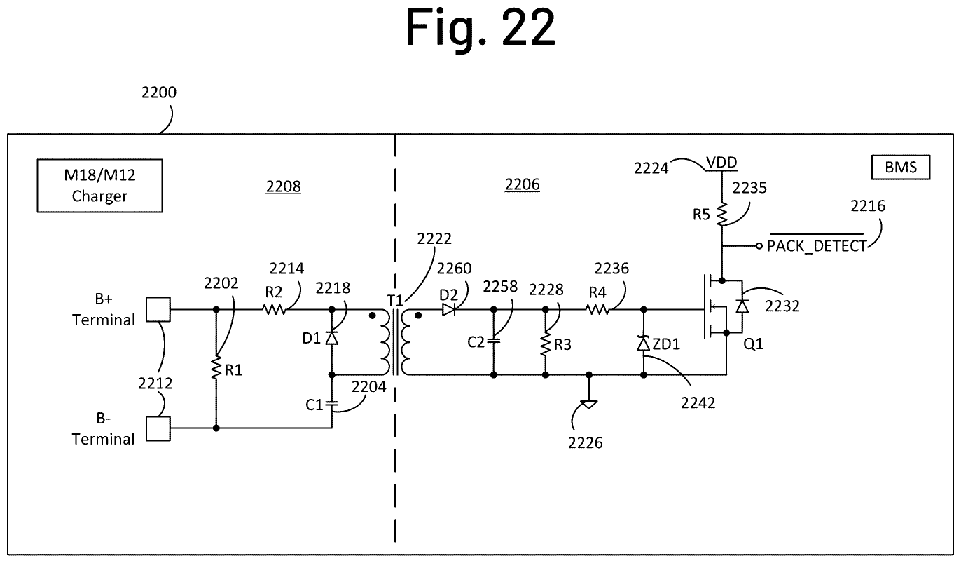

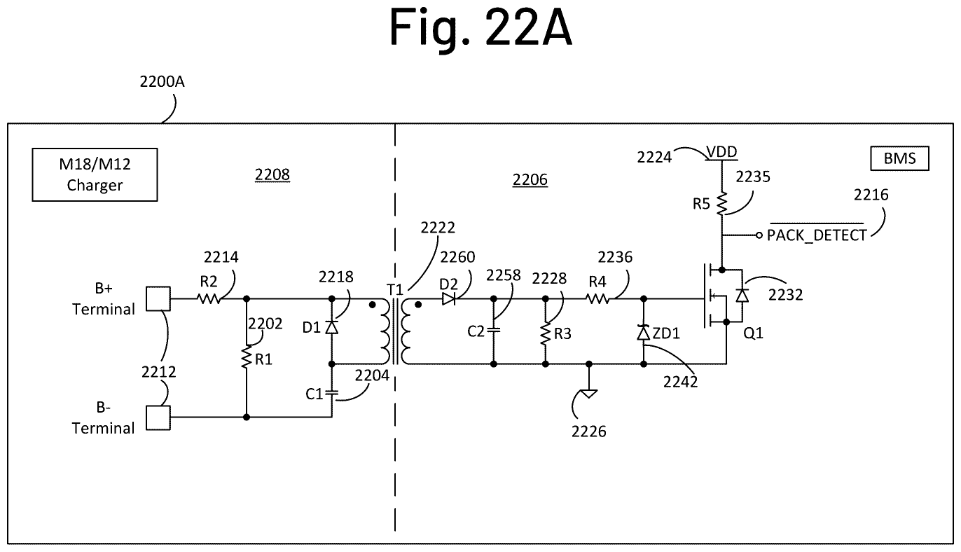

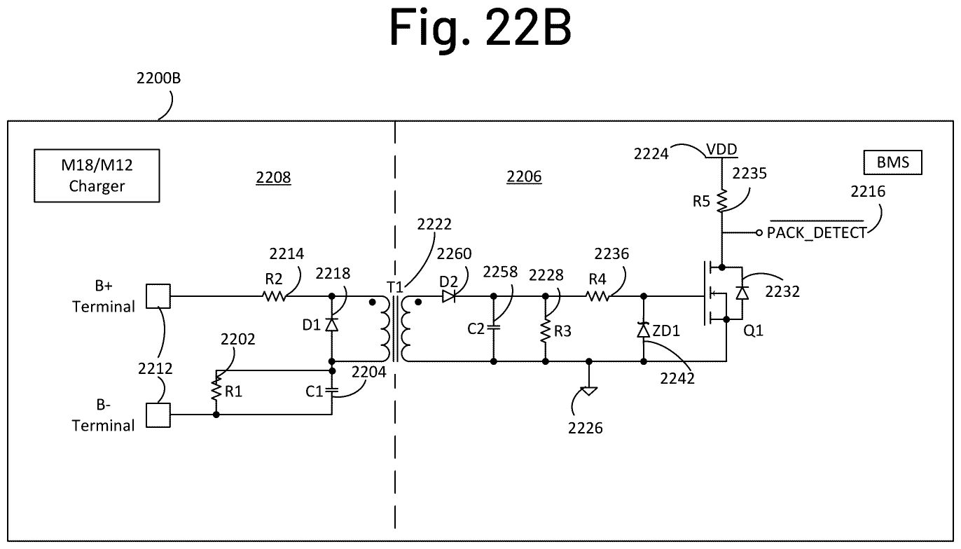

A first transformer-based pack detection circuit configuration 2200 is shown in FIG. 22. R1 2202 is a resistor with a high impedance. Its purpose is to discharge the capacitor C1 2204 when no battery pack is connected to the B+ and B− terminals 2212. The high impedance limits current draw when a battery pack is connected to these terminals 2212. R2 2214 limits the peak current drawn from the battery pack when it is initially installed/connected. D1 2218 provides a path for the reset current of a transformer 2222. C1 2204 allows a non-negligible amount of current to flow through transformer T1 (“T1”) 2222 for a limited period of time immediately after a battery pack is installed. This current drives the circuitry that communicates a battery pack detection signal via battery pack detection signal line 2216 to the BMS 2206. After C1 2204 charges, current ceases to be drawn from the battery pack, which is the desired long-term outcome. T1 2222 is a transformer that provides galvanic isolation between the battery pack charger 2208 and the BMS 2206 yet still allows an electrical signal to be transmitted from the battery pack charger 2208 to the BMS 2206 after a pack is installed. Capacitor C2 (“C2”) 2258 is a capacitor that is charged by T1 2222 through diode D2 (“D2”) 2260 after a pack is installed. It keeps Q1 2232 turned on for longer than the time required to charge C1 2204, prolonging the logic low level on the battery pack detect signal on the battery pack detection signal line 2216, making this signal easier to receive. D2 2260 is a diode that prevents premature discharge of C2 2258 after C1 2204 has charged past the point where the transformer secondary winding voltage is less than the voltage across C2 2258. R3 2228 is a resistor of relatively high impedance that discharges C2 2258 in a defined period of time, automatically resetting the secondary side of the battery pack detection circuit 2200. ZD1 2242 and R4 2236 are optional components that prevent excessive voltage on the secondary winding of T1 2222 from punching through the gate oxide of Q1 2232 and destroying Q1 2232. ZD1 2242 limits the gate-source voltage of Q1 2232 to acceptable levels, and R4 2236 limits the current through ZD1 2242 to acceptable levels. R5 2235 is a pullup resistor that causes the voltage of the battery pack detect signal on the battery pack detection signal line 2216 to idle at a logic high level (near VDD). R5 2235 also allows the voltage of the battery pack detect signal to be pulled to a logic low level by Q1 2232 for a brief period of time after a battery pack has been inserted/connected. Q1 2232 is an N-Channel MOSFET that closes after a battery pack is inserted and C2 2258 is charged above its gate-source threshold voltage. In this state, Q1 2232 brings the voltage on the battery pack detect signal on the battery pack detection signal line 2216 to a logic low level indicating a detected pack insertion to the BMS 2206. VDD is the positive logic supply voltage 2224 within the BMS 2206. The common signal represents the negative logic supply voltage 2226 within the BMS 2206.

When a battery pack is inserted, the voltage across the battery pack appears between the terminals 2212. This voltage appears across R2 2214, the primary winding of T1 2222, and C1 2204, although C1 2204 is initially at a very low or zero voltage. Whatever voltage appears across the primary winding T1 2222 is transferred according to the turns ratio of T1 2222 to its secondary winding, and C2 2204 is charged through D2 2260 to nearly the voltage of the primary winding of T1 2222. R2 2214 limits the peak current. Shortly after the voltage on C2 2258 exceeds the gate-source threshold voltage of Q1 2232, Q1 2232 closes and draws enough current through R5 2235 to bring the battery pack detect signal on the battery pack detection signal line 2216 to logic low level. The BMS 2206 will register this as a detection of a battery pack being connected to terminals 2212. C1 2204 charges through R2 2214 and the primary winding of T1 2222. As C1 2204 charges, the voltage across the primary winding of T1 2222 decreases, and so does the voltage across the secondary winding of T1 2222. Once the voltage across the secondary winding of T1 2222 is lower than the voltage across C2 2258, D2 2260 reverse biases, removing any load from the secondary winding of T1 2222. At some point, T1 2222 resets, and its reset current flows through D1 2218. At some point, C1 2204 fully charges. Afterwards, current no longer flows through R2 2214 or the primary winding of T1 2222, and the only remaining current draw from the battery pack is through the relatively high impedance of R1 2202. At some point, R3 2228 discharges C2 2258 below the gate-source threshold voltage of Q1 2232, and Q1 2232 opens. Current flow through R5 2235 decreases to a negligible level, and the battery pack detect signal on the battery pack detection signal line 2216 returns to its idle logic high state.

After a battery pack is removed, the capacitor C1 2204 discharges through the primary winding of T1 2222, R2 2214, and R1 2202 until its voltage drops to a very low level. At this point, the battery detection circuit has been reset and can detect the connection of another battery pack. To the extent that any circuit components are not explicitly described in detail with respect to these embodiments of the circuit, the same functions of those components as previously described can be attributed to such components. However, any such components have been renumbered to start with a “22”.

Resistor R1 2202 could be placed between the cathode of D1 2218 and the B-terminal 2212. In the configuration 2200A shown in FIG. 22A, R2 2214 is no longer in the discharge path for C1 2204, although it should make little difference to circuit operation.

R1 2202 could also be placed directly across C1 2204 itself, as shown in configuration 2200B of FIG. 22B. Neither R2 2214 nor the primary winding of T1 2222 is in the discharge path in this case.

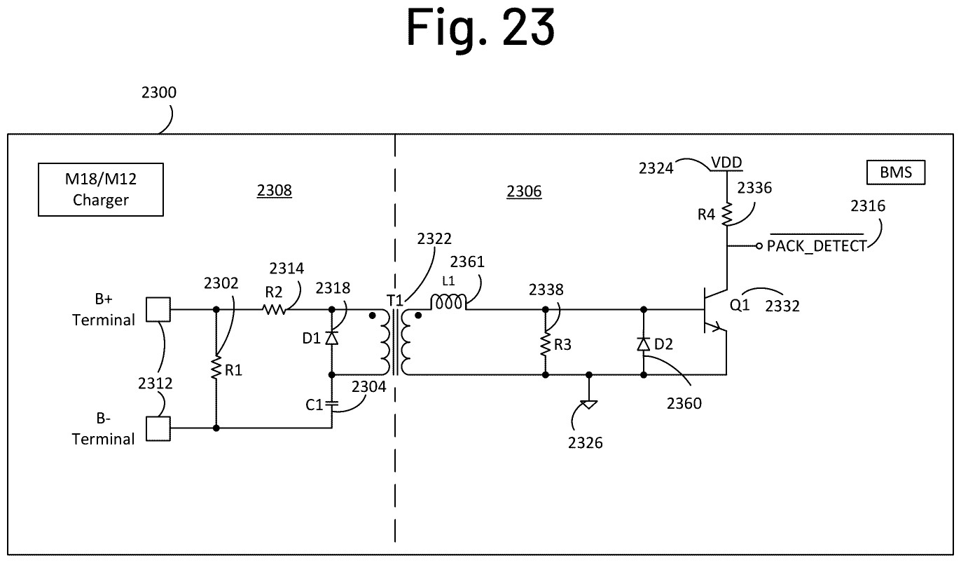

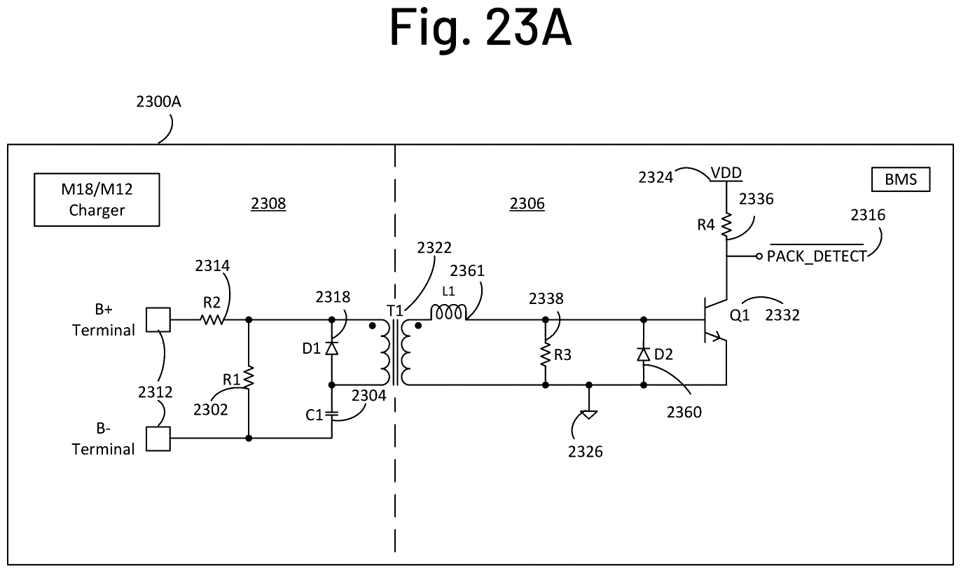

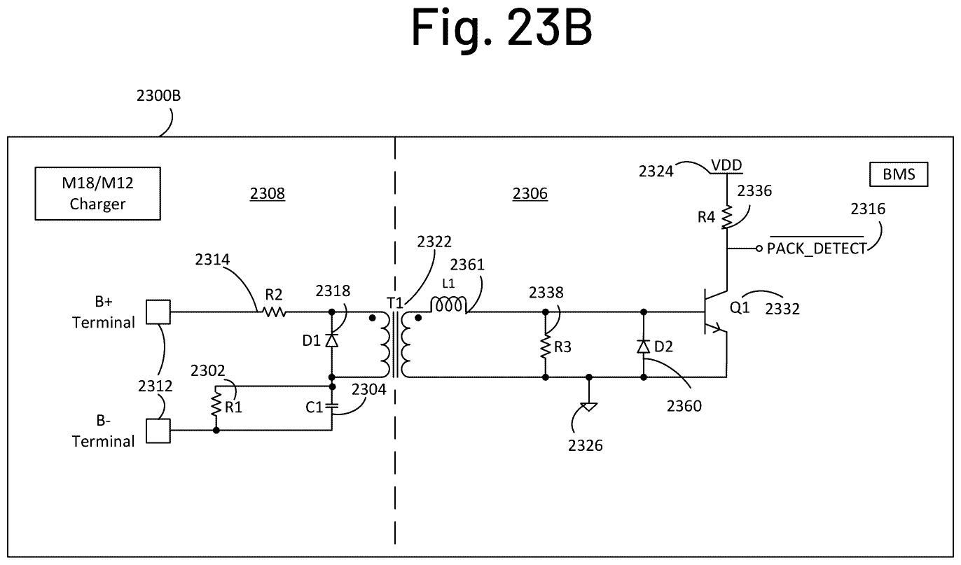

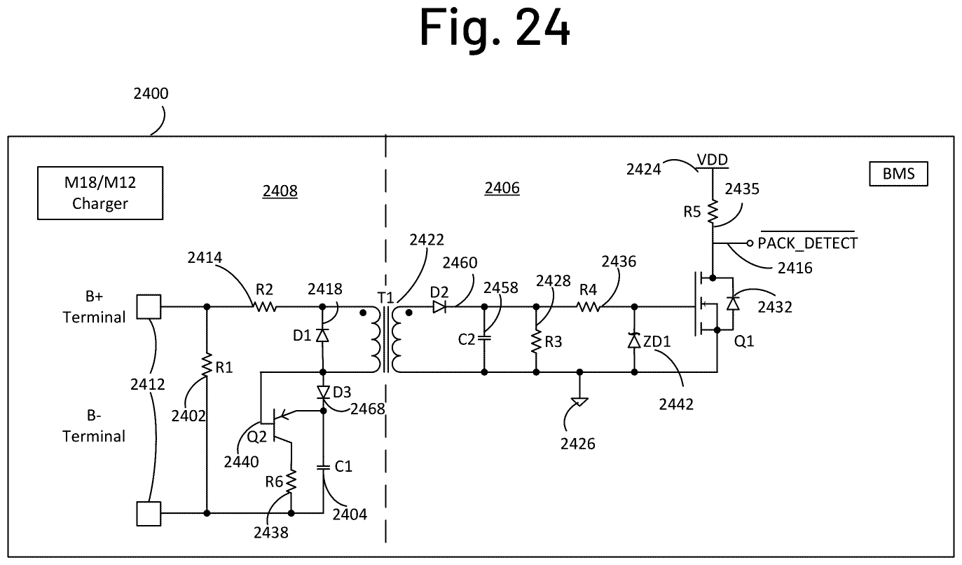

A second transformer-based battery pack detection circuit 2300 configuration 2300 is shown in FIG. 23. Inductor L1 (“L1”) 2361 is an inductor that is charged by the voltage pulse appearing on the secondary of T1 2322 following the insertion of a battery pack. L1 2361 stores current that is used to drive the base of Q1 2332 for a longer period of time than the initial pulse from the secondary of T1 2322. This makes the logic low level or active battery pack detect signal on the battery pack detection signal line 2316 easier to receive. R3 2328 is an optional resistor that helps to keep Q1 2332 in cutoff against minor voltage or current fluctuations and that may help to damp the BMS 2306 side circuit. D2 prevents avalanche of the base-emitter junction of Q1 2332 when the voltage across this junction goes negative as L1 2361 discharges. Q1 2332 is an NPN BJT that amplifies the base current sourced from T1 2322 and L1 2361 into a larger collector current that flows through R4 2336 and decreases the voltage of the battery pack detect signal to a logic low level for a brief period of time after a battery pack has been inserted. R4 2336 is a pullup resistor that causes the voltage of the battery pack detect to idle at a logic high level (near VDD). R4 2336 also allows the voltage of the battery pack detect signal to be pulled to a logic low level by Q1 2332.

When a battery pack is inserted/connected to the terminals 2312, the voltage across the battery pack appears between the terminals 2312. This voltage appears across R2 2314, the primary winding of T1 2322, and C1 2304, although C1 2304 is initially at a very low or zero voltage. Whatever voltage appears across the primary winding of T1 2322 is transferred according to the turns ratio of T1 2322 to its secondary winding, driving voltage across L1 2361 and increasing the current through L1 2361. R2 2314 limits the peak current. Most of the current through L1 2361 flows through the base of Q1 2332. A much larger current flows through the collector of Q1 2332 and R4 2336 (larger because of the gain of Q1 2332), bringing the battery pack detect signal to logic low level. The BMS 2306 will register this as a detection of a battery pack. C1 2304 charges through R2 2314 and the primary winding of T1 2322. As C1 2304 charges, the voltage across the primary winding of T1 2322 decreases, and so does the voltage across the secondary winding of T1 2322. After the voltage across the secondary winding of T1 2322 decreases below the base-emitter voltage of Q1 2332, L1 2361 begins to discharge. The current from L1 2361 continues to flow through the secondary winding of T1 2322 and the base-emitter junction of Q1 2332, but the voltage of L1 2361 has inverted, and L1 2361 is now driving current through the primary winding of T1 2322 that also flows through D1 2318. The current through L1 2361 eventually drops to zero, Q1 2332 turns off, and the voltage of the battery pack detect signal returns to its idle state logic high level. By this point, C1 2304 has fully charged. Current no longer flows through R2 2314 or the primary winding of T1 2322, and the only remaining current draw from the battery pack is through the relatively high impedance of R1 2302.

After a battery pack is disconnected/removed, the capacitor C1 2304 discharges through the primary winding T1 2322, R2 2314, and R1 2302 until its voltage drops to a very low level. At this point, the battery pack detection circuit 2300 has been reset and can detect connection to another battery pack. To the extent that any circuit components are not explicitly described in detail with respect to these embodiments of the circuit, the same functions of those components as previously described can be attributed to such components. However, any such components have been renumbered to start with a “23”.

Resistor R1 2302 could be placed between the cathode of D1 2318 and the B-terminal 2322. In this configuration, R2 2314 is no longer in the discharge path for C1 2304, although it should make little difference to circuit operation. This configuration 2300A is shown in FIG. 23A.

R1 2302 could also be placed directly across C1 2304 itself. Neither R2 2314 nor the primary winding of T1 2322 is in the discharge path in this case, but again, the difference to circuit operation is minimal. This configuration 2300B is shown in FIG. 23B.

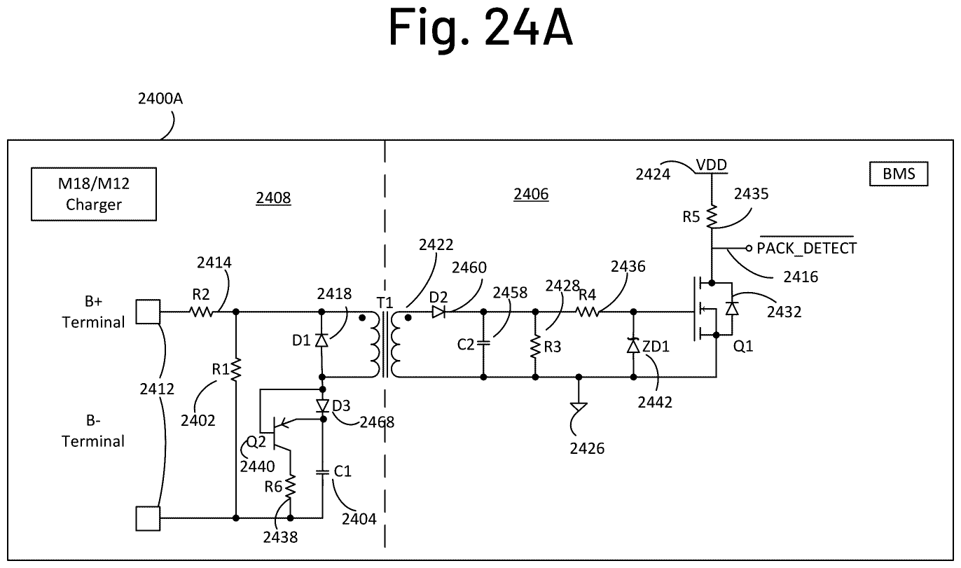

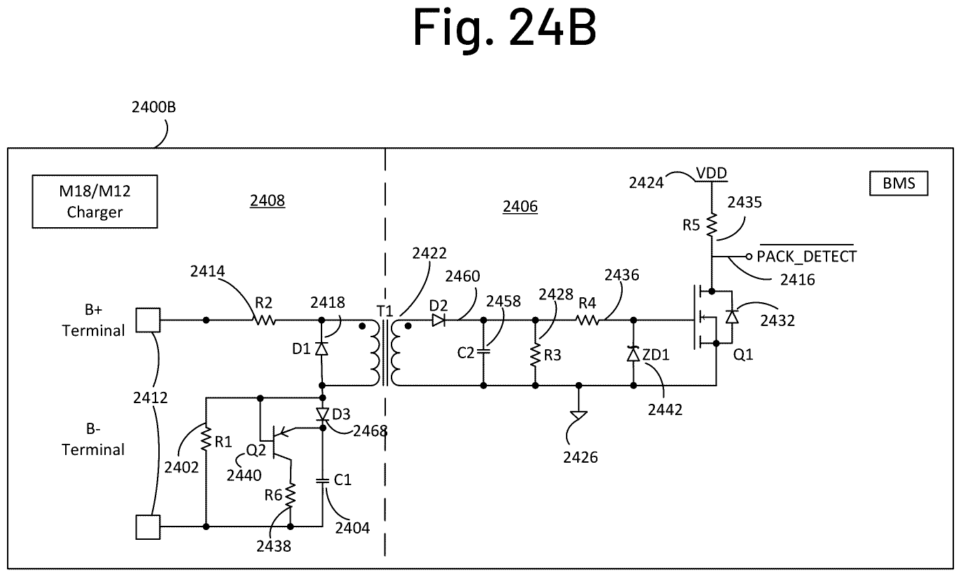

FIG. 24 shows configuration 2400 as a variation of configuration 2200 that differs only in the addition of a fast discharge circuit for C1 2404 (Q2 2440, diode D3 (“D3”) 2468, and R6 2438). Q2 2440 is a PNP BJT that amplifies the current drawn from C1 2404 when C1 2404 is being discharged. Part of the discharge current flow from C1 2404 through the base-emitter junction of Q2 2440, the primary winding of T1 2422, R2 2414, and R1 2402. A much larger current flows through the collector-emitter junction of Q2 2440 and R6 2438. This current is larger due to the gain of Q2 2440. D3 2468 provides a path for the current that charges C1 2404 to flow and protects the base-emitter junction of Q2 2440 from avalanche breakdown when that junction is reverse biased. R6 2438 is an optional resistor that limits the collector current of Q2 2440, if desired.

When the battery pack is inserted, the battery pack voltage initially appears across R2 2414, the primary winding of T1 2422, C1 2404, and D3 2468. The current that charges C1 2404 flows through D3 2468. Q2 2440 remains in cutoff throughout the process of charging C1 2404 and after C1 2404 is charged. The collector cutoff current of Q2 2440 adds to the current drawn from the battery pack after C1 2404 is fully charged. This current is very small.

After the battery pack is removed, a relatively small current flows from C1 2404 through the base emitter junction of Q2 2440, the primary winding of T1 2422, R2 2414, and R1 2402. A current many times larger than the current mentioned above flows from C1 2404 through the collector-emitter junction of Q2 2440 and through R6 2438. This current is much larger due to the gain of Q2 2440. C1 2404 discharges much more quickly than configuration 2200 until its voltage is approximately the base-emitter threshold voltage of Q2 2440. At this point, the battery pack detection circuit 2400 has been reset and can detect connection to another battery pack. To the extent that any circuit components are not explicitly described in detail with respect to these embodiments of the circuit, the same functions of those components as previously described can be attributed to such components. However, any such components have been renumbered to start with a “24”.

Resistor R1 2402 could be placed between the cathode of D1 2418 and the B-terminal 2412. In this configuration, R2 2414 is no longer in the discharge path for C1 2404, although it should make little difference for circuit operation. This configuration 2400A is shown in FIG. 24A.

R1 2402 could also be placed between the base of the Q2 2440 and the B− terminal 2412. Neither R2 2414 nor the primary winding of T1 2422 is in the discharge path in this case, but again, the difference to circuit operation is minimal. This configuration 2400B is shown in FIG. 24B.

It is contemplated that a complement of the fast turnoff configuration could also be used, where Q2 2440 is an NPN transistor with emitter connected to the other side of C1 2404, base connected to B− terminal 2412, R6 2438 from collector to the anode of D1 2418, and D3 2468 antiparallel to the base-emitter junction of Q2 2440. R1 2402 would be from B− to the anode of D1 2418.

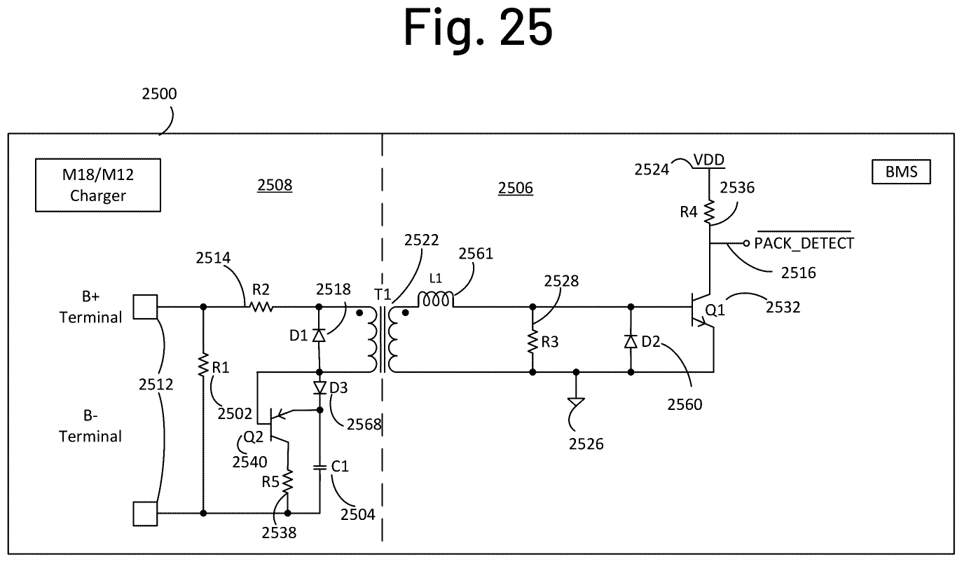

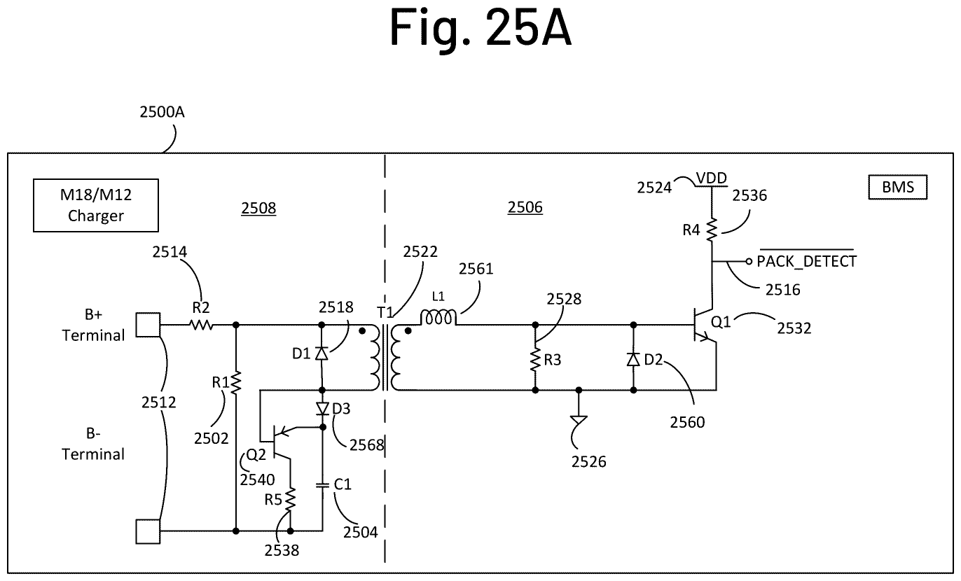

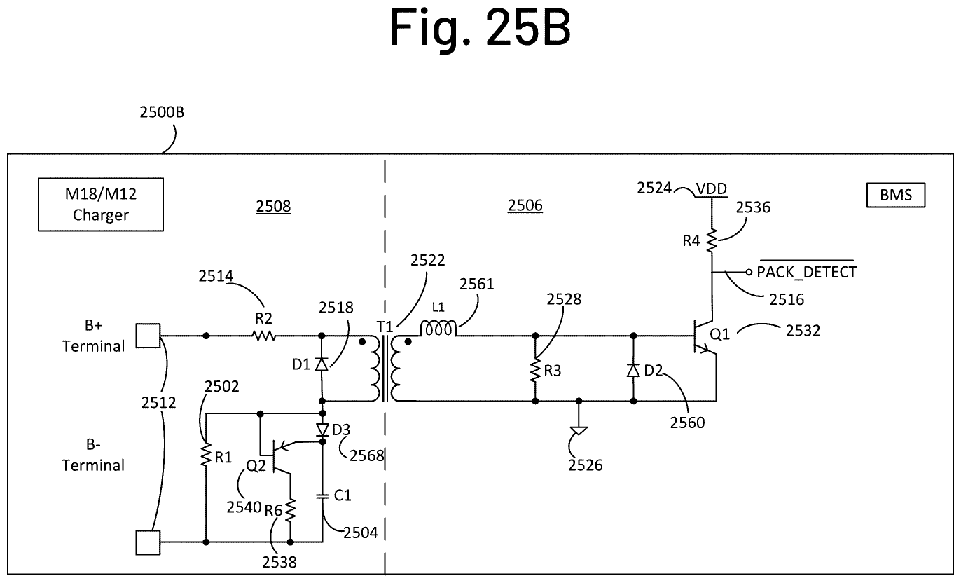

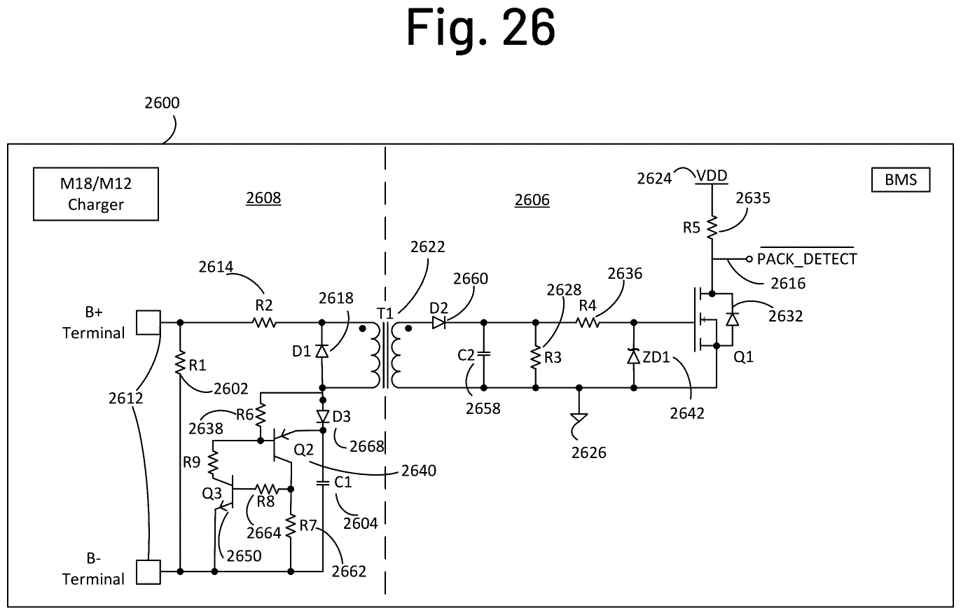

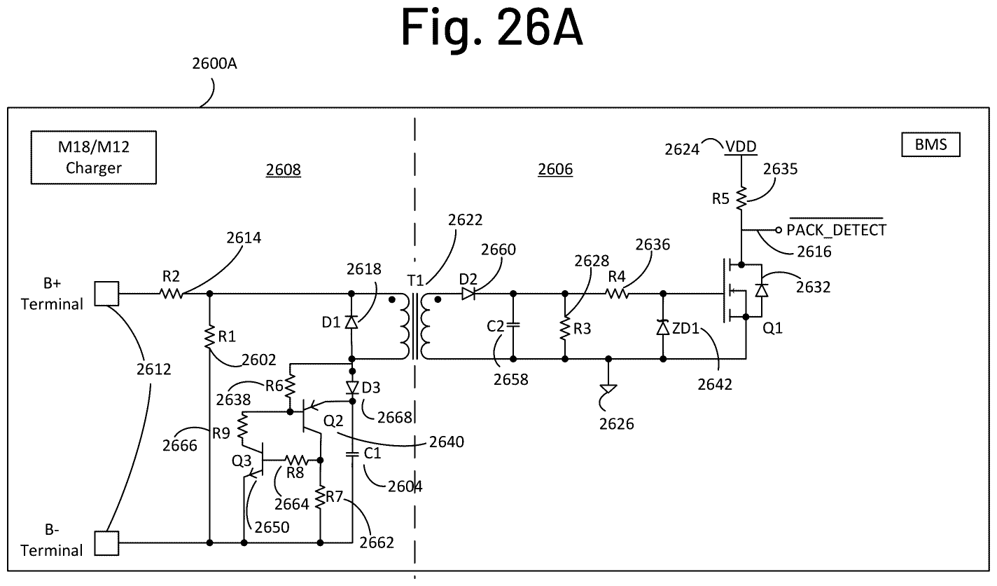

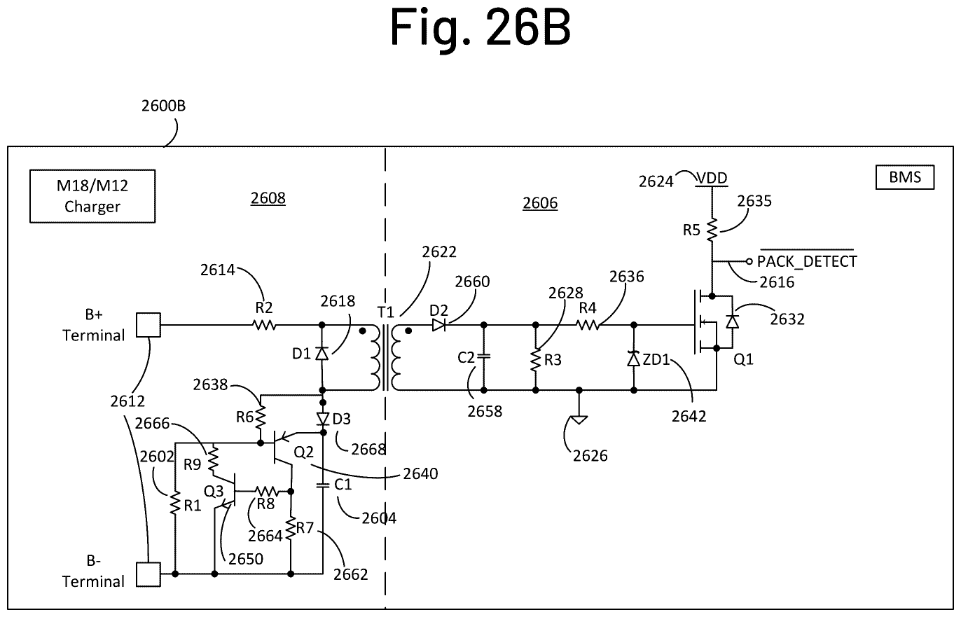

Configuration 2500 is shown in FIG. 25. This combines the BMS from configuration 2300 with the fast C1 2504 discharge circuit from configuration 2400. The resistor in the fast discharge circuit is labelled R5 2538 in configuration 2500, whereas it is labelled R6 2438 in configuration 2400. Corresponding common components among the embodiments are not described further, but are identified with a “25” identifier.

Resistor R1 2502 could be placed between D1's 2518 cathode and the B− terminal. In this configuration, R2 2514 is no longer in the discharge path for C1 2504, although it should make little difference to circuit operation. This configuration 2500A is shown FIG. 25A. Corresponding common components among the embodiments are not described further, but are identified with a “25” identifier.

R1 2502 could also be placed between Q2's 2540 base and the B− terminal. Neither R2 2514 nor T1's 2522 primary winding is in the discharge path in this case, but again, the difference to circuit operation is minimal. This configuration 2500B is shown in FIG. 25B. Corresponding common components among the embodiments are not described further, but are identified with a “25” identifier.

It is contemplated the complement of the fast turnoff network could also be used, where Q2 2540 is an NPN transistor with emitter connected to the other side of C1 2504, base connected to B− Terminal, R5 2538 from collector to D1's 2518 anode, and D3 2568 antiparallel to Q2's 2540 base-emitter junction. R1 2502 would be from B− to D1's 2518 anode.

FIG. 26 shows configuration 2600 as a variation of configuration 2200 that differs only in the addition of a very fast discharge circuit for C1 2604 (Q2 2640, Q3 2650, D3 2668, R6 2638, resistor R7 (“R7”) 2662, resistor R8 (“R8”) 2664, and resistor R9 (“R9”) 2666). Q2 2640 is a PNP BJT that amplifies the current drawn from C1 2604 when it discharges. Part of C1's 2604 discharge current flows through Q2's 2640 base-emitter junction, T1's 2622 primary winding, R2 2614, and R1 2602. A much larger current flows through Q2's 2640 collector-emitter junction, R8 2664, and the base-emitter junction of Q3 2650; this current is larger due to the gain of Q2 2640. R6 2638 is an optional resistor that limits the base current of Q2 2640 in the event that a pack with lower voltage than C1 2604 is installed while C1 2604 is still charged. D3 2668 provides a path for the current that charges C1 2604 to flow and protects Q2's 2640 base-emitter junction from avalanche breakdown when that junction is reverse biased. R7 2662 is a resistor that keeps Q3 2650 biased in cutoff while a battery pack is installed. R8 2664 is a resistor that limits the base current of Q3 2650 while C1 2604 is being discharged. Q3 2650 is an NPN BJT whose base current is driven by Q2 2640. A larger current (magnified by the gain of Q3 2650) flows through Q3's 2650 collector, R9 2666, and the base of Q2 2640. This creates a positive feedback loop that rapidly increases the currents through Q2 2640 and Q3 2650 until they are limited by R8 2664, R9 2666, the saturation characteristics of Q2 2640 and Q3 2650, as well as the voltage remaining across C1 2604. Consequently, C1 2604 is discharged very rapidly. R9 2666 is a resistor that limits the current drawn by Q3 2650 from the base of Q2 2640.

When the battery pack is inserted, the battery pack voltage initially appears across R2 2614, T1's 2622 primary winding, C1 2604, and D3 2668. The current that charges C1 2604 flows through D3 2668. Q2 2640 and Q3 2650 remain in cutoff throughout the process of charging C1 2604 and after C1 2604 is charged. The collector cutoff currents of Q2 2640 and Q3 2650 add to the current drawn from the battery pack after C1 2604 is fully charged. The additional current is very small.

After the battery pack is removed, a relatively small current flows from C1 2604 through Q2's 2640 base emitter junction, T1's 2622 primary winding, R2 2614, and R1 2602. A current many times larger than the current mentioned above flows from C1 2604 through Q2's 2640 collector-emitter junction, R8 2664, and the base-emitter junction of Q3 2650. This current is much larger due to the gain of Q2 2640. Q3 2650, in turn, sinks a much larger current than that flowing through its base from Q2's 2640 base through R9 2666 and Q3's 2650 collector. This creates a positive feedback loop between Q2 2640 and Q3 2650. The two transistors rapidly increase the currents flowing through each other until these currents are primarily limited by R8 2664, R9 2666, the saturation characteristics of Q2 2640 and Q3 2650, and the voltage remaining across C1 2604. C1 2604 is rapidly discharged as a result. C1 2604 discharges much more quickly than configuration 2200 until its voltage is approximately the base-emitter threshold voltage of Q2 2640/Q3 2650 plus the collector-emitter saturation voltage of Q3 2650/Q2 2640. At this point, the battery pack detection circuit 2600 has been reset and can detect connection to another battery pack. To the extent that any circuit components are not explicitly described in detail with respect to these embodiments of the circuit, the same functions of those components as previously described can be attributed to such components. However, any such components have been renumbered to start with a “26”.

Resistor R1 2602 could be placed between D1's 2618 cathode and the B− terminal. In this configuration, R2 2614 is no longer in the discharge path for C1 2604, although it should make little difference for circuit operation. This configuration 2600A is shown in FIG. 26A. R1 2602 could also be placed between Q2's 2640 base and the B− terminal 2712. Neither R2 2614 nor T1's 2622 primary winding is in the discharge path in this case, but again, the difference to circuit operation is minimal. This configuration 2600B is shown in FIG. 26B.

It is contemplated that the complement of the very fast turnoff network could also be used, where Q2 2640 is an NPN transistor with emitter connected to the other side of C1 2604, base connected to one side of R6 2638, and the other side of R6 2638 connected to the B-terminal 2612. D3 2668 would have its anode at the emitter of Q2 2640 and its cathode at the B-terminal 2612. R7 2662 would connect from Q2's 2640 collector to D1's 2618 anode. R1 2602 would be from the B− terminal 2612 to D1's 2618 anode. Q3 2650 would be a PNP transistor with emitter at D1's 2618 anode, R8 2664 from base to Q2's 2640 collector, and R9 2666 from Q3's 2650 collector to Q2's 2640 base.

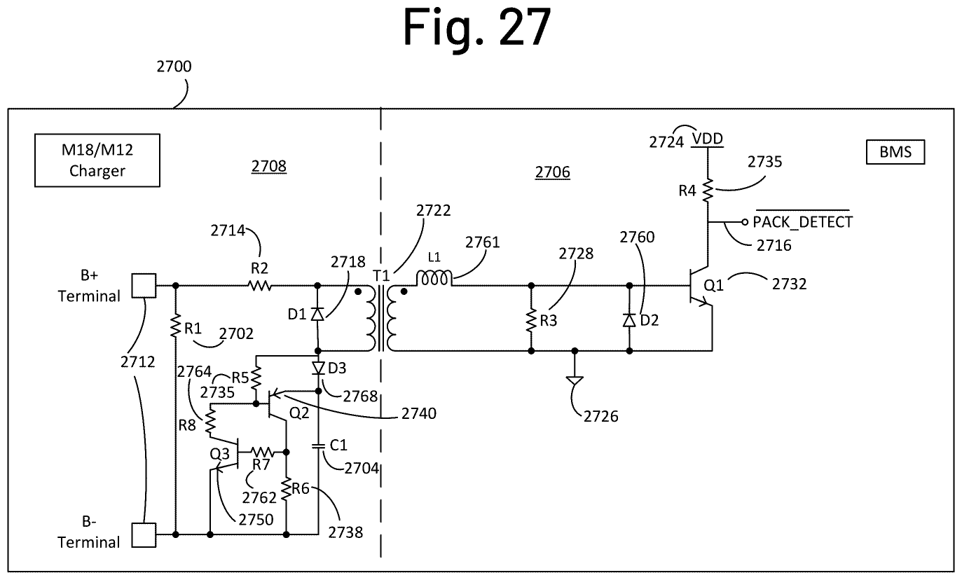

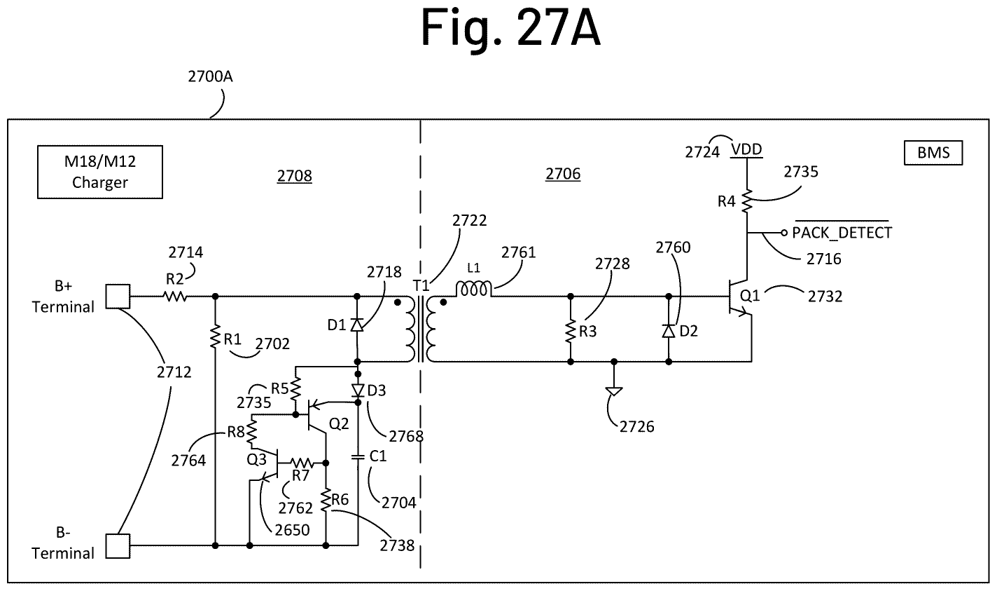

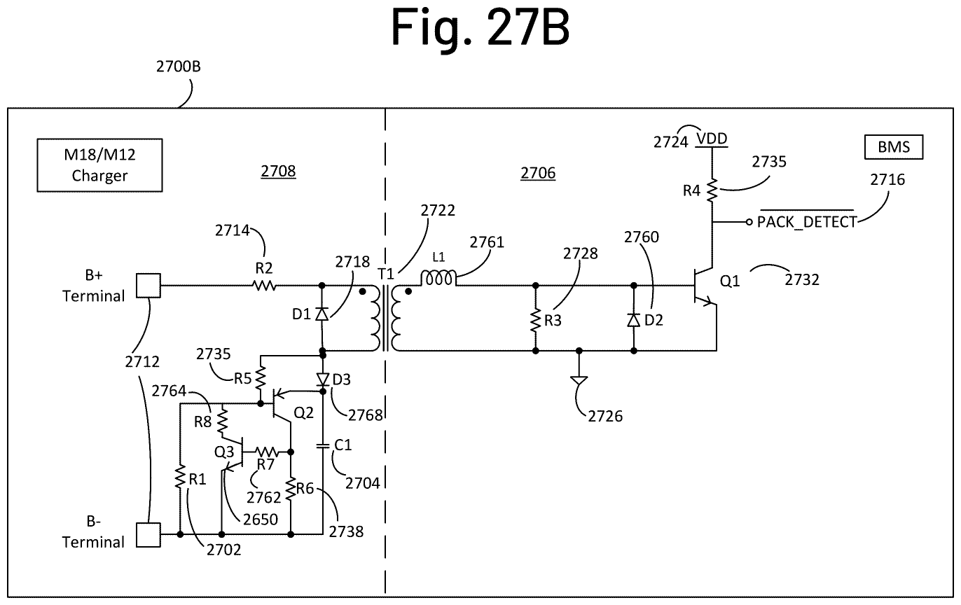

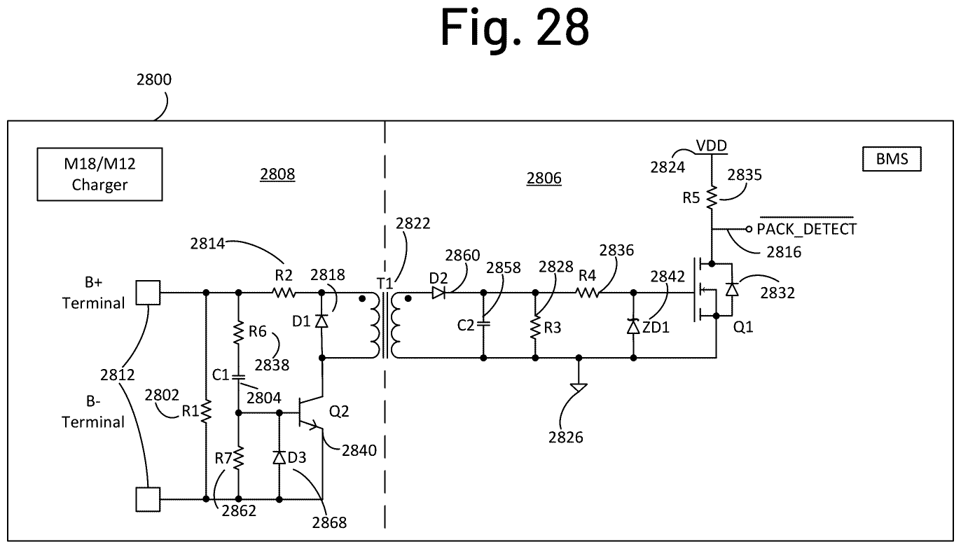

Configuration 2700 is shown in FIG. 27. This combines the BMS from configuration 2300 with the very fast C1 discharge circuit from configuration 2600. It is contemplated that the resistor designator numbers in the very fast discharge circuit (R5 2735, R6 2738, R7 2762, and R8 2764) are one lower than those of configuration 2600. Corresponding common components among the embodiments are not described further, but are identified with a “27” identifier.

Resistor R1 2702 could be placed between D1's 2718 cathode and the B− terminal 2712. In this configuration, R2 2714 is no longer in the discharge path for C1 2704, although it should make little difference to circuit operation. This configuration 2700A is shown in FIG. 27A. Corresponding common components among the embodiments are not described further, but are identified with a “27” identifier.

R1 2702 could also be placed between Q2's 2740 base and the B− terminal. Neither R2 2714 nor T1's 2722 primary winding is in the discharge path in this case, but again, the difference to circuit operation is minimal. This configuration 2700B is shown in FIG. 27B. Corresponding common components among the embodiments are not described further, but are identified with a “27” identifier.

It is contemplated that the complement of the very fast turnoff network could also be used, where Q2 2740 is an NPN transistor with emitter connected to the other side of C1 2704, base connected to one side of R6 2738, and the other side of R6 2738 connected to the B-terminal 2712. D3 2768 would have its anode at the emitter of Q2 2740 and its cathode at the B-terminal 2712. R7 2762 would connect from Q2's 2740 collector to D1's 2718 anode. R1 2702 would be from the B− terminal 2712 to D1's 2718 anode. Q3 2750 would be a PNP transistor with emitter at D1's 2718 anode, R8 2764 from base to Q2's 2740 collector, and R9 2766 from Q3's 2750 collector to Q2's 2740 base.

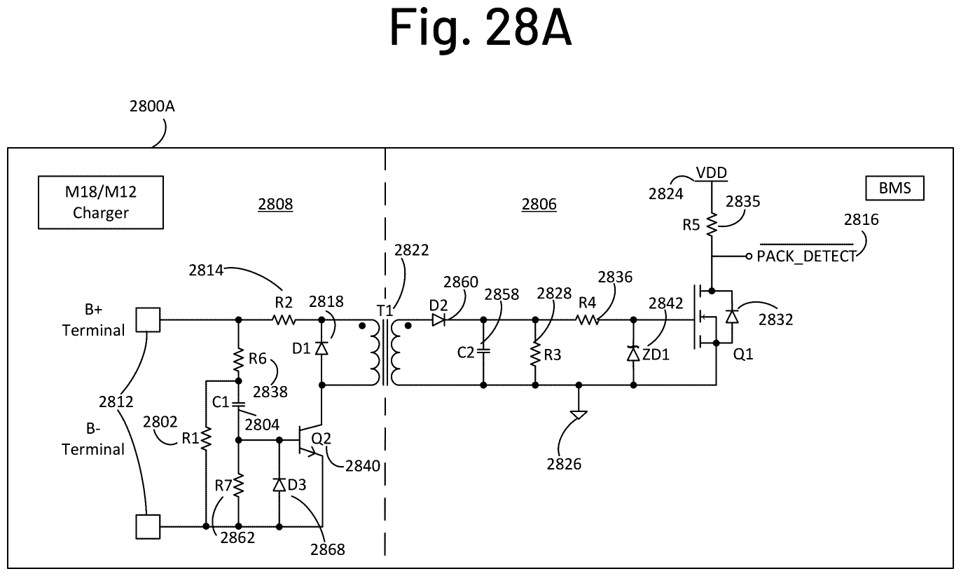

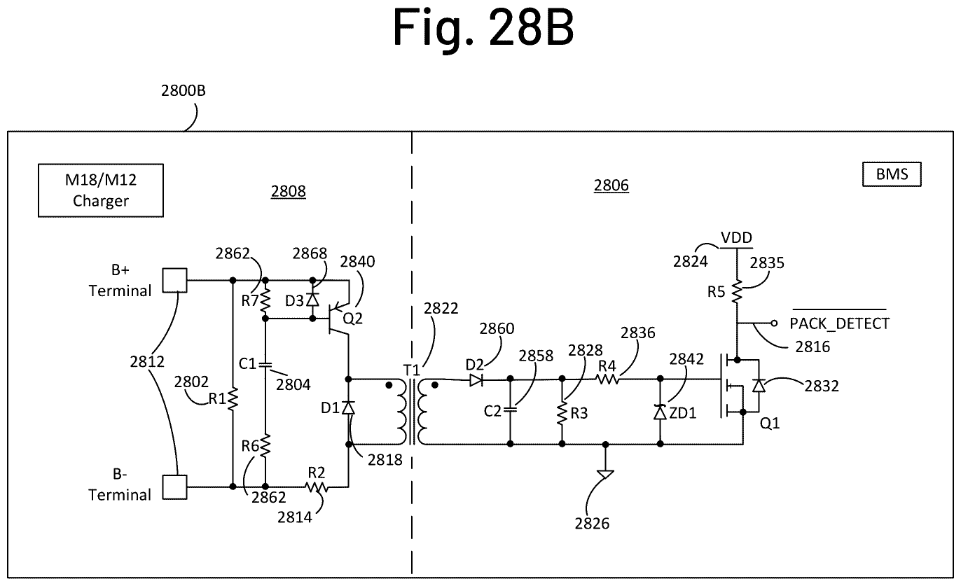

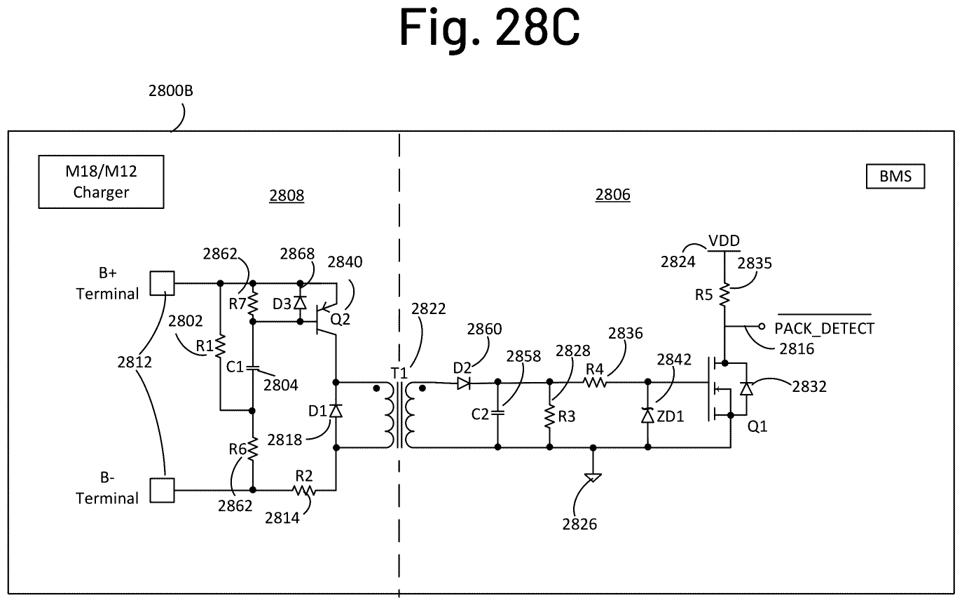

FIG. 28 shows configuration 2800 as a variation of configuration 2700 that differs in the placement of C1 2804 and in the manner in which the primary winding of the transformer 2822 is driven. C1 2804 is no longer in the path of the primary winding of T1 2822. Rather, the current that charges C1 2804 also flows through the base of Q2 2840. R6 2838 is a resistor that serves to limit the peak charge current of C1 2804 and the peak current through the base of Q2 2840. The values of R6 2838 and C1 2804 in combination tune the charging time constant. R7 2862 is an optional resistor that keeps Q2 2840 biased in cutoff against minor fluctuations in voltage or current, providing some immunity against noise. It also permits C1 2804 to discharge to a lower voltage than the forward voltage of D3 2868. D3 2868 is a diode that provides a path for the current that discharges C1 2804. It also protects the base of Q2 2840 and the base-emitter junction of Q2 2840 from avalanche when this junction is reverse biased.

When the battery pack is inserted, the battery pack voltage initially appears across two independent and critical circuit paths: (1) R6 2838, C1 2804, and the base-emitter junction of Q2 2840; and (2) R2 2814, the primary winding of T1 2822, and Q2's 2840 collector-emitter junction. R2 2814, the primary winding of T1 2822, and Q2's 2840 collector emitter junction. Q2 2840 is initially biased off. C1 2804 begins to charge, and the current that charges C1 2804 flows through the base of Q2 2840, turning on Q2 2840. After Q2 2840 turns on, a voltage is applied across the primary winding of T1 2822 and transferred by the turns ratio of T1 to the secondary winding of t1 2822. This drives the BMS 2806 side of the battery pack detection circuit 2800. As in configuration 2200, R2 2814 limits the peak current through the primary winding of T1 2822. Once C1 2804 fully charges, current ceases to flow through the base of Q2 2840, and Q2 2840 turns off. Current ceases to flow in a positive direction through the primary winding of T1 2822, and T1 will reset through D1 2818. The collector cutoff current of Q2 2840 adds to the current drawn from the battery pack after C1 2804 is fully charged. The additional current is very small.

After the battery pack is removed, C1 2804 discharges to a very low voltage through D3 2868, R7 2862, R6 2838, and R1 2802. The circuit has been reset and can detect the connection/insertion of another battery pack. To the extent that any circuit components are not explicitly described in detail with respect to these embodiments of the circuit, the same functions of those components as previously described can be attributed to such components. However, any such components have been renumbered to start with a “28”.

Resistor R1 2802 could be placed between C1 2804 and the B− terminal. In this configuration, R6 2838 is no longer in the discharge path for C1 2804, although it should make little difference to circuit operation. This configuration 2800A is shown in FIG. 28A.

Q2 2840 could be changed from an NPN BJT to a PNP BJT, with related other changes to the circuit. This is shown in FIG. 28B as configuration 2800B. Operation is essentially identical except for changes to the polarity of some voltages and the direction of some currents.

Configuration 2800C combines the changes of 2800A and 2800B together, as shown in FIG. 28C.

It is contemplated that the charger-side fast capacitor discharge circuits of configurations 2400 and 2600, or suitable adaptations of thereof, could be readily applied to discharge capacitor C1 2804 in configurations 2800, 2800A, 2800B, and 2800C.

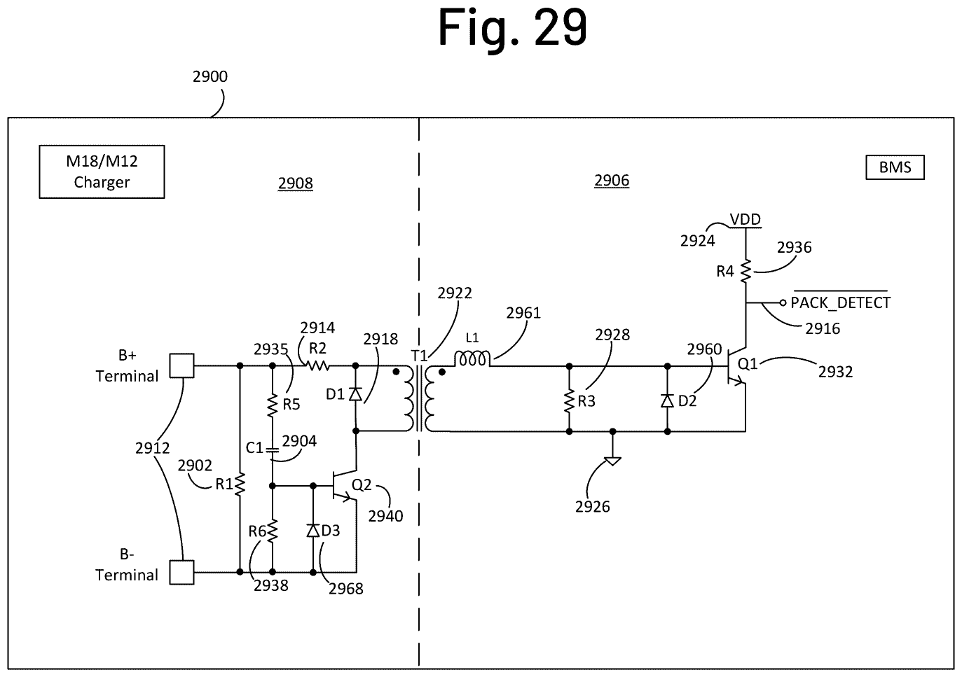

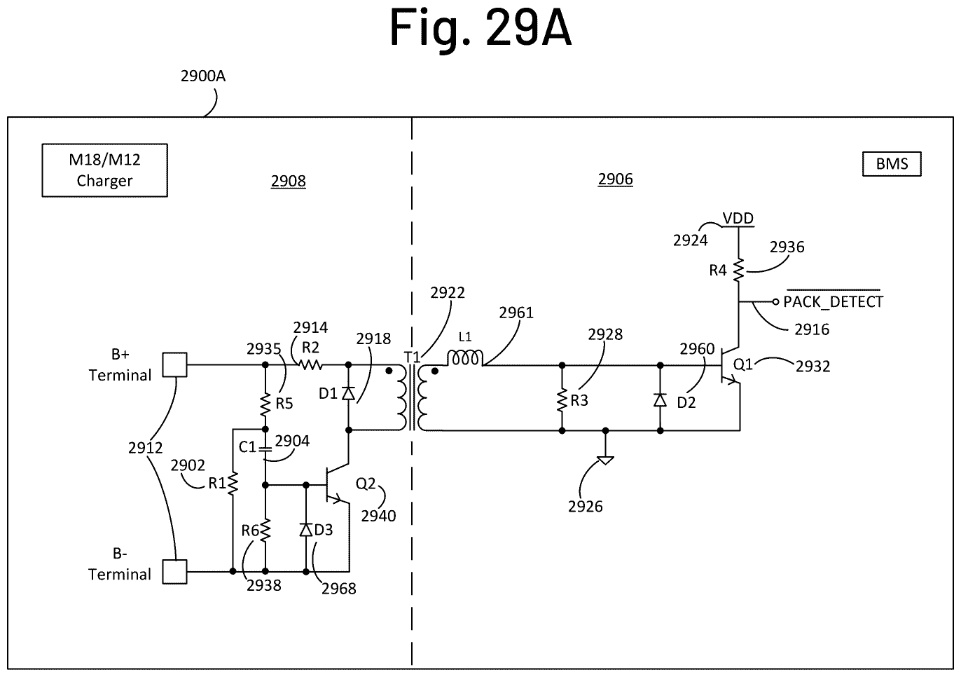

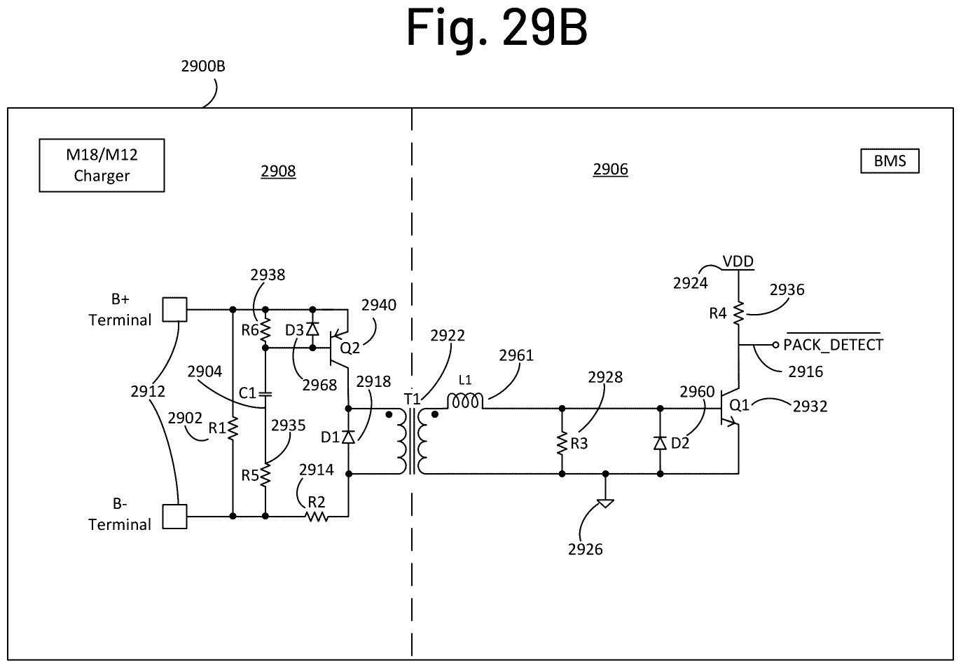

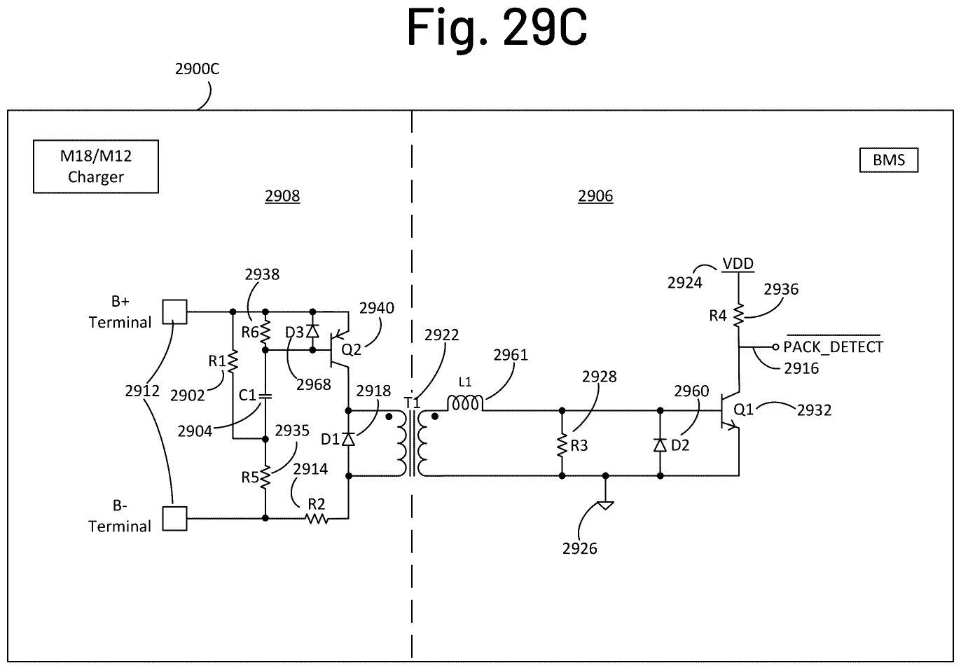

Configuration 2900 is shown in FIG. 29. This combines the BMS from configuration 2300 with the battery pack charger side circuitry from configuration 2800. Refer to those sections for explanations of components and function. R5 2935 and R6 2938 in configuration 2900 correspond to R6 2838 and R7 2862 in configuration 2800, respectively. Corresponding common components among the embodiments are not described further, but are identified with a “29” identifier. Resistor R1 2902 could be placed between C1 2904 and the B− terminal. In this configuration, R5 2935 is no longer in the discharge path for C1 2904, although it should make little difference to circuit operation. This configuration 2900A is shown in FIG. 29A.

Q2 2940 could be changed from an NPN BJT to a PNP BJT, with related other changes to the circuit. This is shown in FIG. 29B as configuration 2900B. Operation is essentially identical except for changes to the polarity of some voltages and the direction of some currents. Configuration 2900C combines the changes of 2900A and 2900B together, as shown in FIG. 29C.

The charger-side fast capacitor discharge circuits of configurations 2400 and 2600, or suitable adaptations of thereof, could be readily applied to discharge capacitor C1 2904 in configurations 2900, 2900A, 2900B, and 2900C.

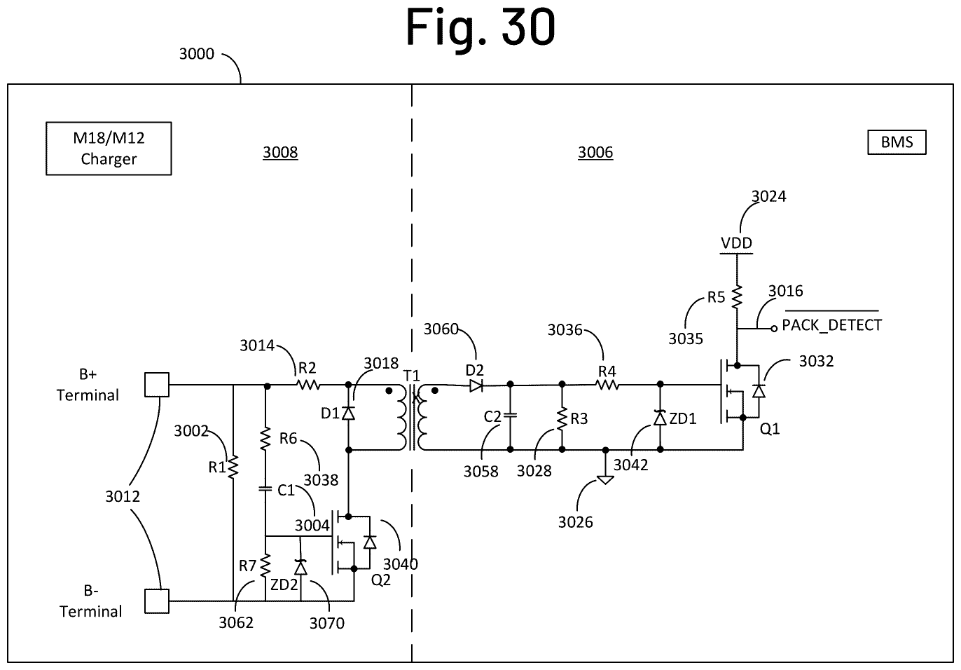

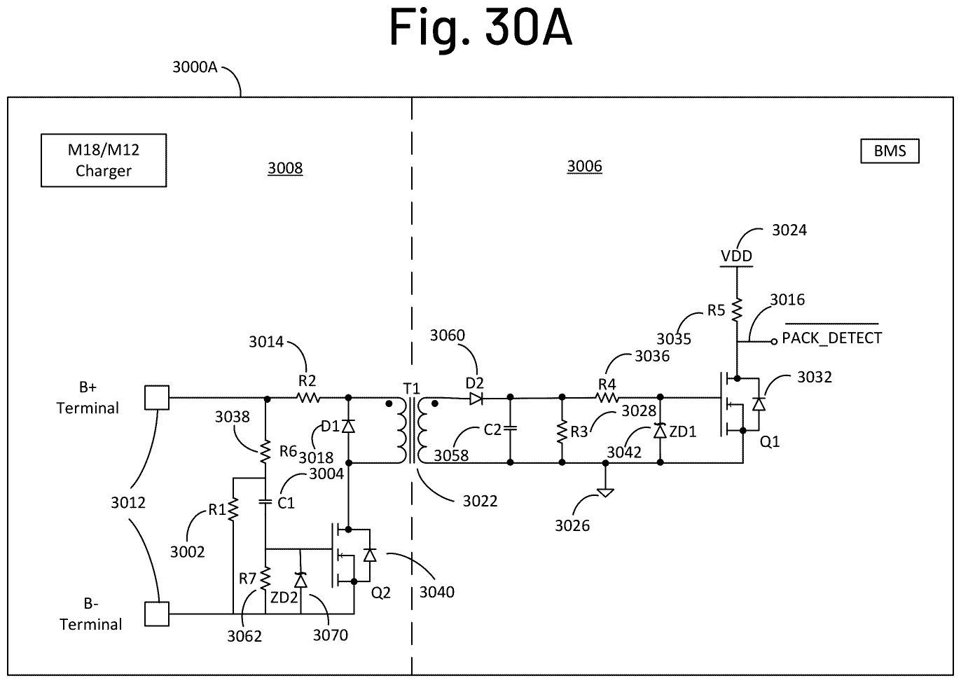

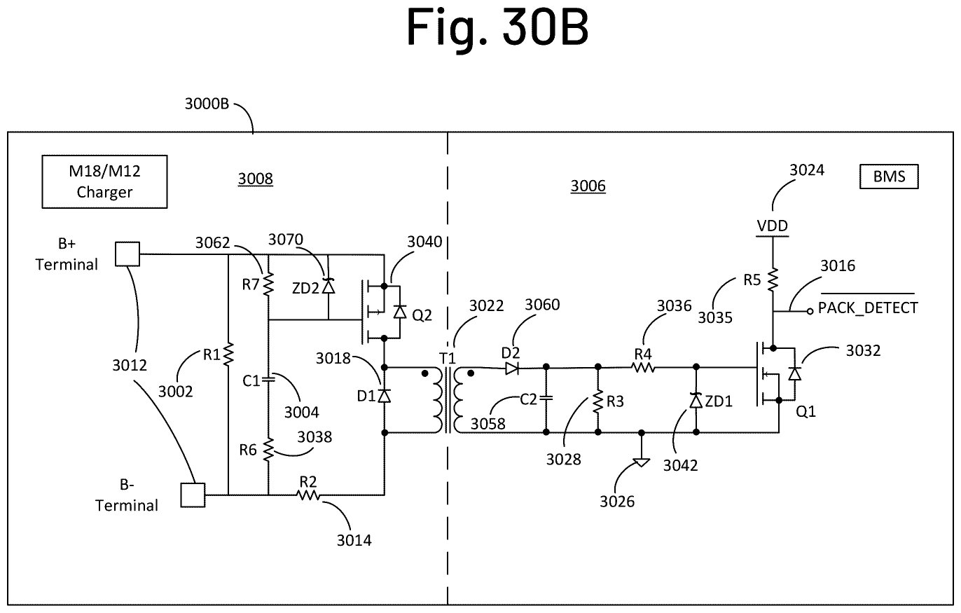

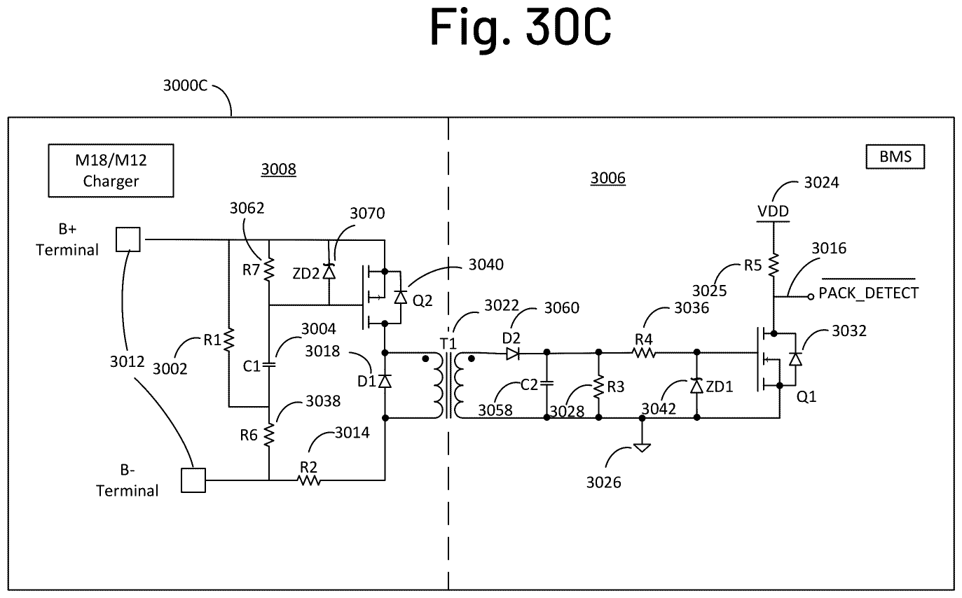

FIG. 30 shows configuration 3000 as a variation of configuration 2200 that differs in the placement of C1 3004 and in the manner in which the primary winding of the transformer 3022 is driven. Q2 3040 is an N-Channel MOSFET that closes and causes the battery pack voltage to be applied across R2 3014 and the primary winding of T1 3022 when the gate-source voltage of Q2 3040 exceeds some threshold voltage. C1 3004 is no longer in the path of the primary winding of T1 3022. Instead, C1 3004 is charged through R6 3038 and R7 3062 to the full voltage across the B+ and B− terminals after the battery pack is installed. C1 3004 ensures that the voltage on the gate of Q2 3040 decreases at a designed rate after the battery pack is installed, keeping Q2 3040 on for the desired length of time. After C1 3004 fully charges, Q2 3040 remains off, and no more current flows through C1 3004, R6 3038, or R7 3062. ZD2 3070 is an optional Zener diode that limits the gate-source voltage of Q2 3040 to levels that will not cause damage to Q2 3040. R6 3038 is an optional resistor that limits the peak current through C1 3004 and ZD2 3070 after the battery pack is initially installed. R7 3062, together with the values of C1 3004 and R6 3038, sets the time constant at which C1 3004 charges after the battery pack is installed. In most configurations, R7 3062 is likely to be much higher impedance than R6 3038.

When the battery pack is inserted, the voltage across the battery pack appears between the B+ terminal and the B− terminal. This voltage charges C1 3004 through R6 3038 and R7 3062. C1 3004 starts at a very low voltage. R6 3038 and R7 3062 are sized so that more of the battery pack voltage appears across R7 3062 (and the gate of Q2 3040) than across R6 3038. Q2 3040 turns on due to its gate-source voltage being high enough to enhance its channel. After Q2 3040 turns on, a voltage is applied across the primary winding of T1 3022 and transferred by the turns ratio of T1 3022 to the secondary winding of T1 3022. This drives the BMS 3006 side of the battery pack detection circuit 3000. As in configuration 2200, R2 3014 limits the peak current through the primary winding of T1 3022. As C1 3004 charges, an increasing amount of the pack voltage appears across C1 3004. Eventually, the voltage on the gate of Q2 3040 is no longer high enough to enhance the channel of Q2 3040, and Q2 3040 turns off. Current ceases to flow in a positive direction through T1's 3022 primary, and T1 3022 will reset through D1 3018. The drain-source leakage current of Q2 3040 adds to the current drawn from the battery pack after C1 3004 is fully charged. The additional current is very small.

After the battery pack is removed, C1 3004 discharges to a very low voltage through ZD2 3070, R7 3062, R6 3038, and R1 3002. The circuit has been reset and can detect the connection/insertion of another battery pack. To the extent that any circuit components are not explicitly described in detail with respect to these embodiments of the circuit, the same functions of those components as previously described can be attributed to such components. However, any such components have been renumbered to start with a “30”.

Resistor R1 3002 could be placed between C1 3004 and the B− terminal. In this configuration, R6 3038 is no longer in the discharge path for C1 3004, although it should make little difference to circuit operation. This configuration 3000A is shown in FIG. 30A. Q2 3040 could be changed from an N-Channel MOSFET to a P-Channel MOSFET, with related other changes to the circuit. This is shown in FIG. 30B as configuration 3000B. Operation is essentially identical except for changes to the polarity of some voltages and the direction of some currents. Configuration 3000C combines the changes of 3000A and 3000B together, as shown in FIG. 30C.

It is contemplated that the charger-side fast capacitor discharge circuits of configurations 2400 and 2600, or suitable adaptations of thereof, could be readily applied to discharge capacitor C1 3004 in configurations 3000, 3000A, 3000B, and 3000C.

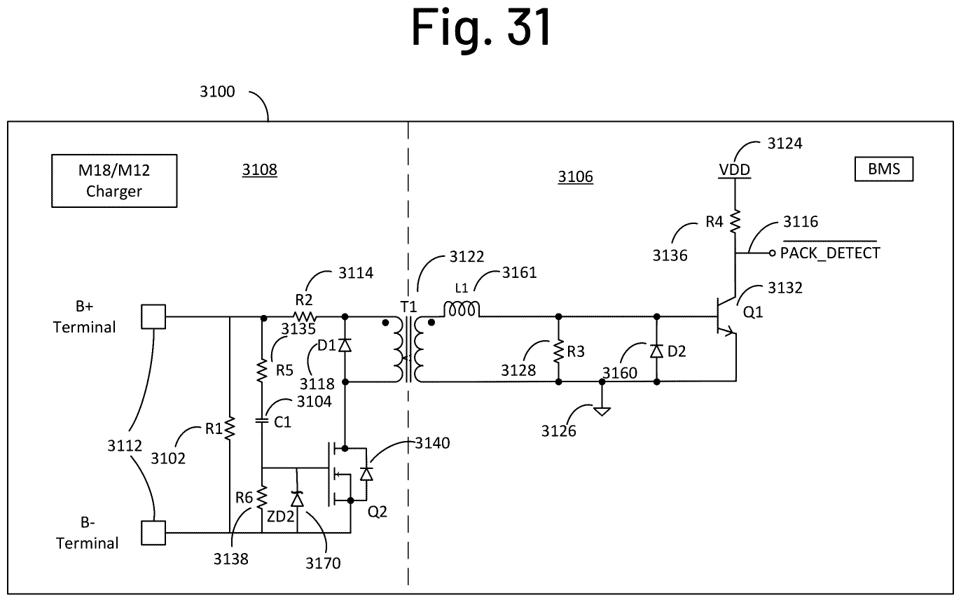

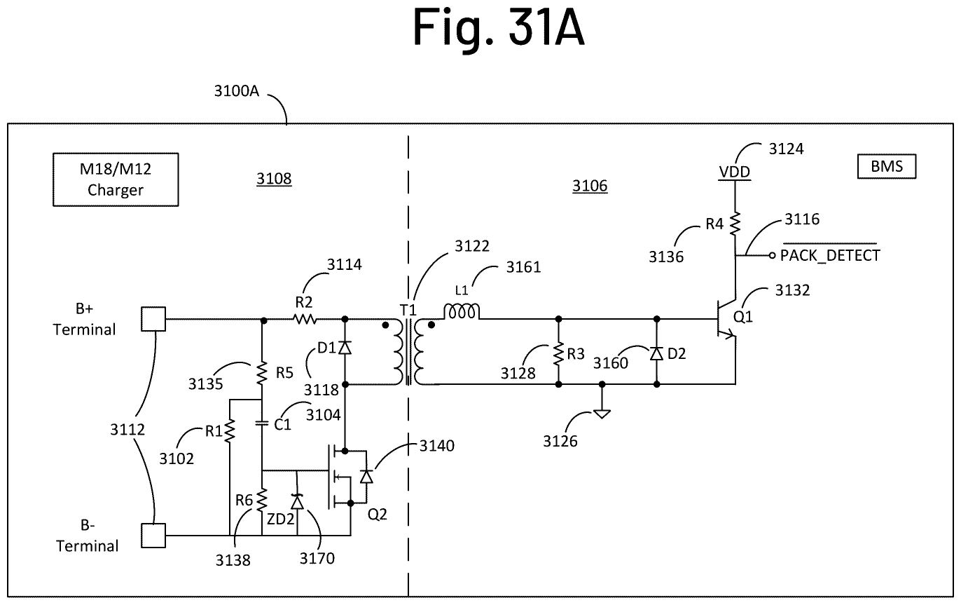

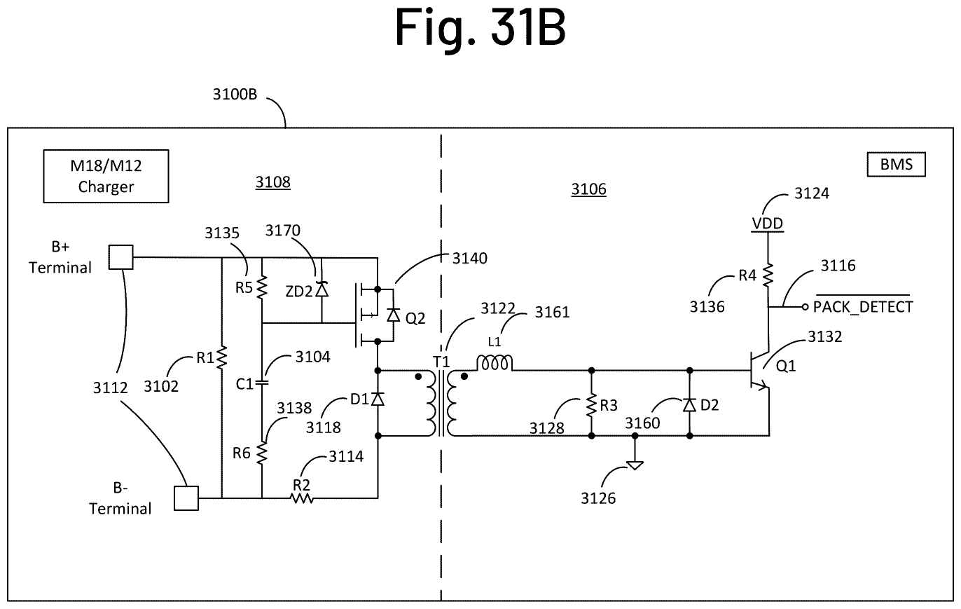

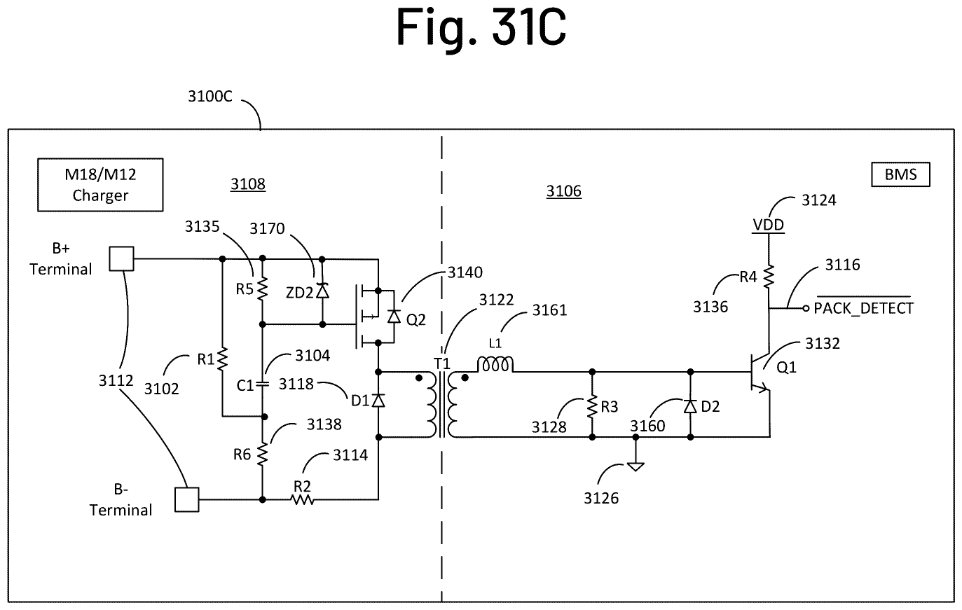

FIG. 31 shows configuration 3100. This combines the BMS 3106 from configuration 2300 with the battery pack charger 3108 side circuitry from configuration 3000. R5 3135 and R6 3138 in configuration 3100 correspond to R6 3038 and R7 3062 in configuration 3000, respectively. Corresponding common components among the embodiments are not described further, but are identified with a “31” identifier. Resistor R1 3102 could be placed between C1 3104 and the B− terminal 3112. In this configuration, R5 3135 is no longer in the discharge path for C1 3104, although it should make little difference to circuit operation. This configuration 3100A is shown in FIG. 31A.

Q2 3140 could be changed from an N-Channel MOSFET to a P-Channel MOSFET, with related other changes to the circuit. This is shown in FIG. 31B as configuration 3100B. Operation is essentially identical except for changes to the polarity of some voltages and the direction of some currents. Configuration 3100C combines the changes of 3100A and 3100B together; it is shown in FIG. 31C. It is contemplated that the charger-side fast capacitor discharge circuits of configurations 2400 and 2600, or suitable adaptations of thereof, could be readily applied to discharge capacitor C1 3104 in configurations 3100, 3100A, 3100B, and 3100C.

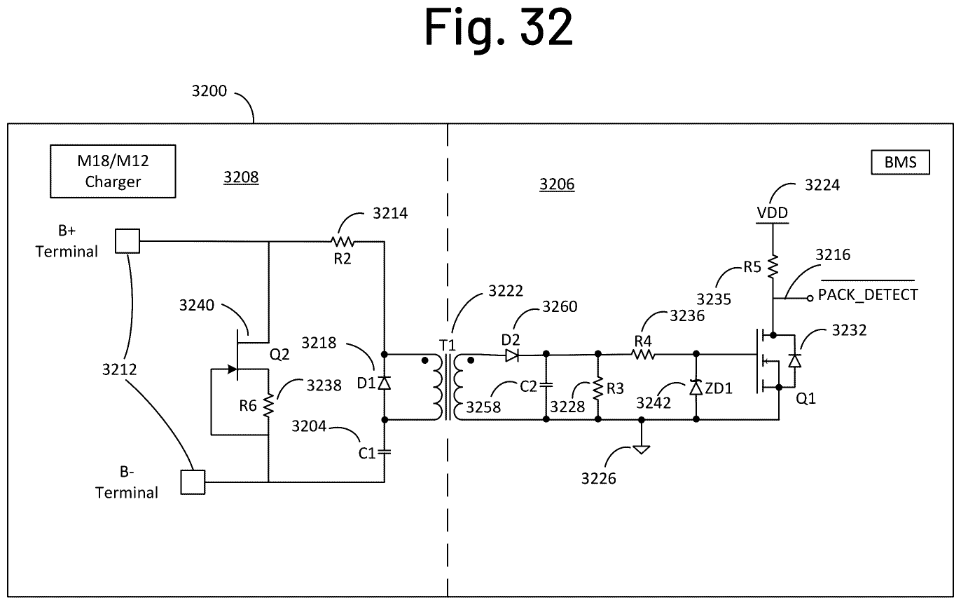

In any of the transformer 3222 circuit configurations 2200-3100, 2200A-3100A, 2200B-3100B, or 2800C-3100C, the resistor R1 may be replaced with a current sink circuit formed from an N-Channel JFET (Junction Field Effect Transistor) and an optional resistor. FIG. 32 shows transformer 3222 circuit configuration 2200 modified in this fashion. Q2 3240 and R6 3238 are the aforementioned JFET and resistor. The JFET current sink circuit may provide a better tradeoff between C1 3204 discharge time and battery pack quiescent current draw than the resistor R1 3202 did. This circuit causes a relatively constant current to flow through its drain terminal even when the voltage across its drain and gate terminals varies over a fairly wide range. Corresponding common components among the embodiments are not described further, but are identified with a “32” identifier.

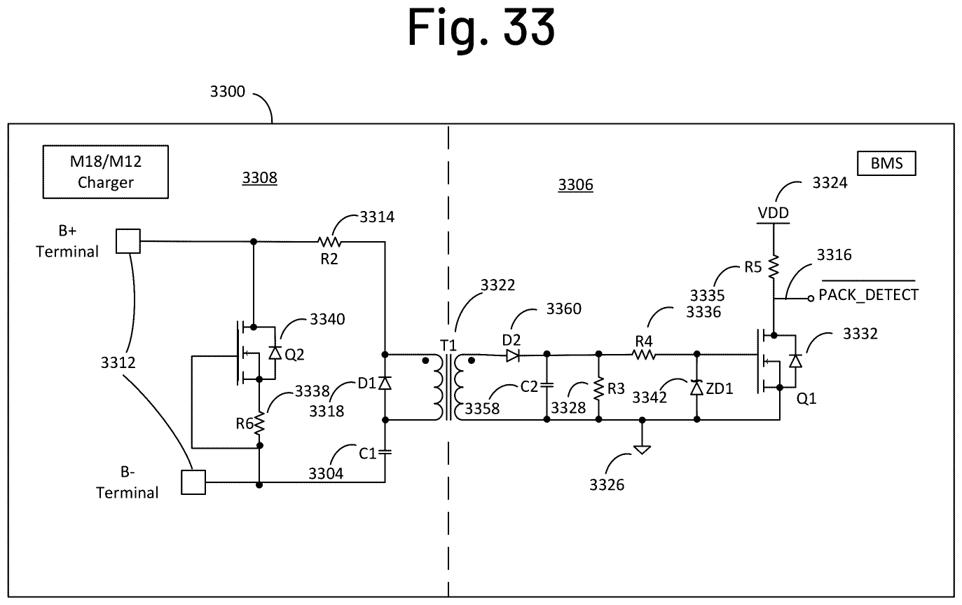

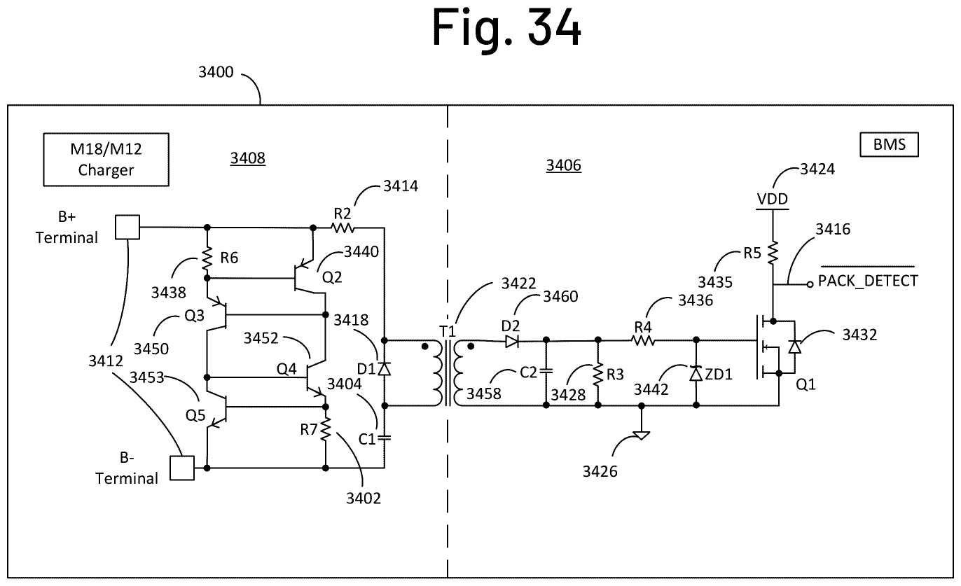

In any of the transformer 3322 circuit configurations 2200-3100, 2200A-3100A, 2200B-3100B, or 2800C-3100C, the resistor R1 3302 may be replaced with a current sink circuit formed from a depletion mode N-Channel MOSFET and a resistor. FIG. 33 shows transformer 3322 circuit configuration 2200 modified in this fashion. Q2 3340 and R6 3338 are the aforementioned MOSFET and resistor. Corresponding common components among the embodiments are not described further, but are identified with a “33” identifier.

The depletion mode N-Channel MOSFET current sink circuit may provide a better tradeoff between C1 3304 discharge time and battery pack quiescent current draw than the resistor R1 3302 did. This circuit causes a relatively constant current to flow through its drain terminal even when the voltage across its drain and gate terminals varies over a fairly wide range.

In any of the transformer 3422 circuit configurations 2200-3100, 2200A-3100A, 2200B-3100B, or 2800C-3100C, the resistor R1 3402 may be replaced with a current sink circuit formed from two PNP BJTs, two NPN BJTs, and two resistors. FIG. 34 shows transformer 3422 circuit configuration 2200 modified in this fashion as configuration 3400. Q2 3440, Q3 3450, Q4 3452, transistor Q5 (“Q5”) 3453, R6 3438, and R7 3462 are the aforementioned BJTs and resistors. Corresponding common components among the embodiments are not described further, but are identified with a “34” identifier.

The bipolar current sink circuit may provide a better tradeoff between C1 3404 discharge time and battery pack quiescent current draw than the resistor R1 3402 did. This circuit causes a relatively constant current to flow even when the voltage across it varies over a fairly wide range.

Configurations 3200, 3300, and 3400 employ constant current circuits constructed from discrete components (N-Channel JFET, depletion mode N-Channel MOSFET, NPN & PNP BJTs, resistors). There are also components available commercially that perform this function. Some are called current regulating diodes, others are called current sources or current sinks. Some of these are integrated circuits. Some may require an external component such as a resistor, while others may not. These kinds of components could take the place of the constant current circuitry in configurations 3200, 3300, or 3400.

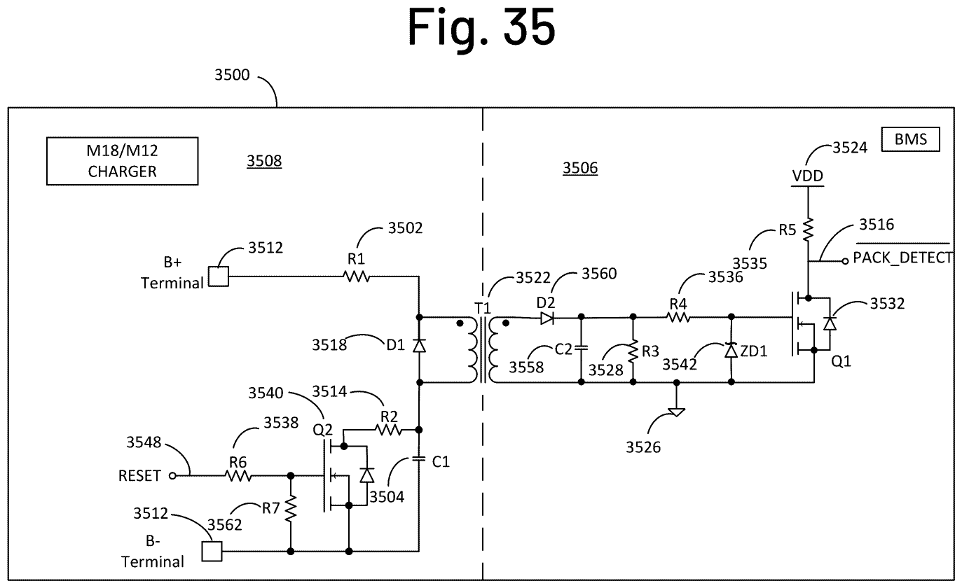

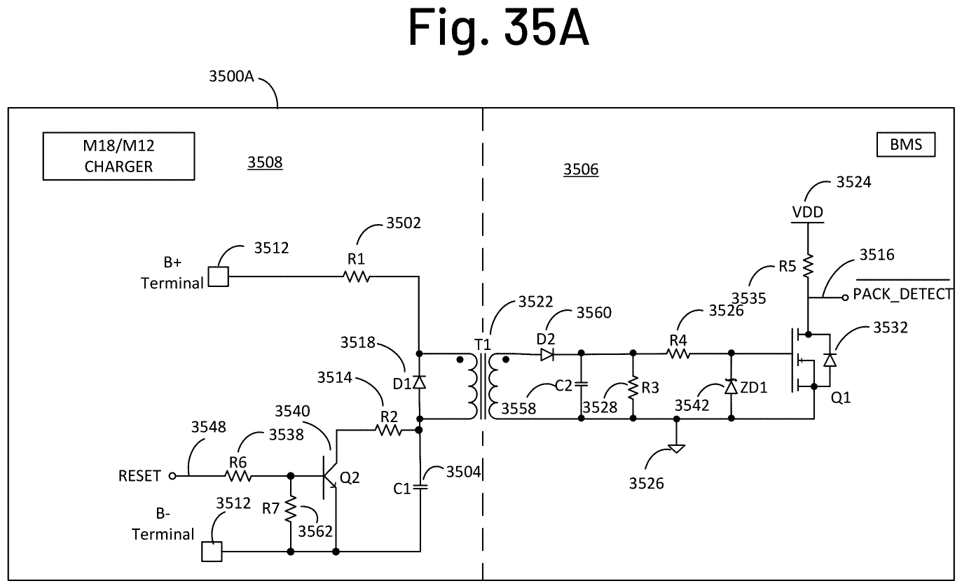

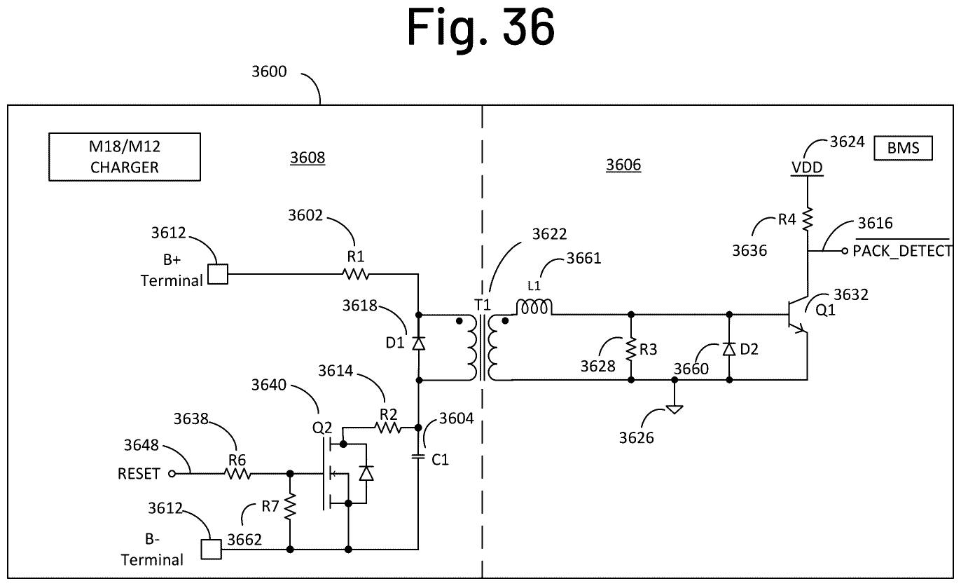

FIG. 35 shows configuration 3500, which is a new class of transformer 3522-based circuit. All previous transformer 3522 circuit configurations employed components that would automatically discharge C1 and reset the circuit after the battery pack is removed. Configuration 3500 differs from this scheme by requiring a RESET signal generated by a microcontroller 236 or other circuit within the battery pack charger 3508 to activate the circuitry that resets the battery pack detection circuit 3500 (here, Q2 3540 and R2 3514). The benefit of this scheme is lower long-term current draw from the battery pack when it is installed (there is no resistor between the B+ and B− terminals 3512). The battery pack charger 3508 may need to be powered on in order to generate the reset signal. R2 3514 limits the current into the drain of Q2 3540 when Q2 3540 is turned on by an active RESET signal. This may only occur when C1 3504 is charged and no battery is installed, but R2 3514 also helps limit current if Q2 3540 is turned on while a battery pack is installed. Q2 3540 is an N-Channel MOSFET that discharges C1 3504 once the voltage of the RESET signal is driven high enough to enhance Q2's 3540 channel. R6 3538 limits the peak current into Q2's 3540 gate in case the RESET signal is driven very quickly from a low voltage to a voltage sufficiently high to enhance Q2's 3540 channel. R7 3562 keeps Q2 3540 biased off against any leakage current from the circuit that generates the RESET signal. R7 3562 may also help keep Q2 3540 biased off against Miller charge injected into its gate through parasitic capacitances in the event that Q2's 3540 drain voltage rises quickly. Only the differences in circuit operation for configuration 3500 relative to configuration 2200 are listed.

When the battery pack is inserted, the voltage on the RESET signal may be low enough to keep Q2 3540 in an off state. The only current drawn from the battery pack after C1 3504 fully charges is the drain-source leakage current of Q2 3540. This is anticipated to be lower than the current drawn from the battery pack by R1 3502 in configuration 2200. Once the insertion of the battery pack is detected, the BMS 3506 will power on the battery pack charger 3508 if permitted by the system logic.

After the battery pack charger 3508 turns on and detects that the battery pack has been removed, a microcontroller 236 or other circuitry within the battery pack charger 3508 increases the voltage on the RESET signal high enough to enhance Q2's 3540 channel. Q2 3540 turns on and discharges C1 3504 through R2 3514. The voltage on C1 3504 decreases to a very low level. The microcontroller 236 or other circuit sets the voltage of the RESET signal back to a near-zero level. At this point, the battery detection circuit has been reset and can detect the connection/insertion of another battery pack. Q2 3540 could be an NPN BJT instead of an N-Channel MOSFET. This configuration 3500A is shown in FIG. 35A. To the extent that any circuit components are not explicitly described in detail with respect to these embodiments of the circuit, the same functions of those components as previously described can be attributed to such components. However, any such components have been renumbered to start with a “35”.

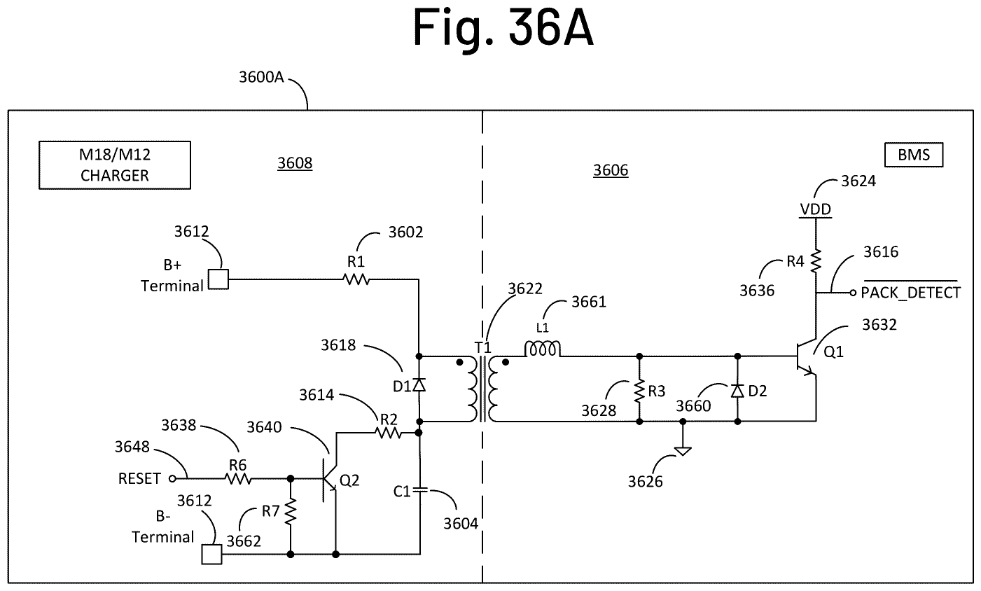

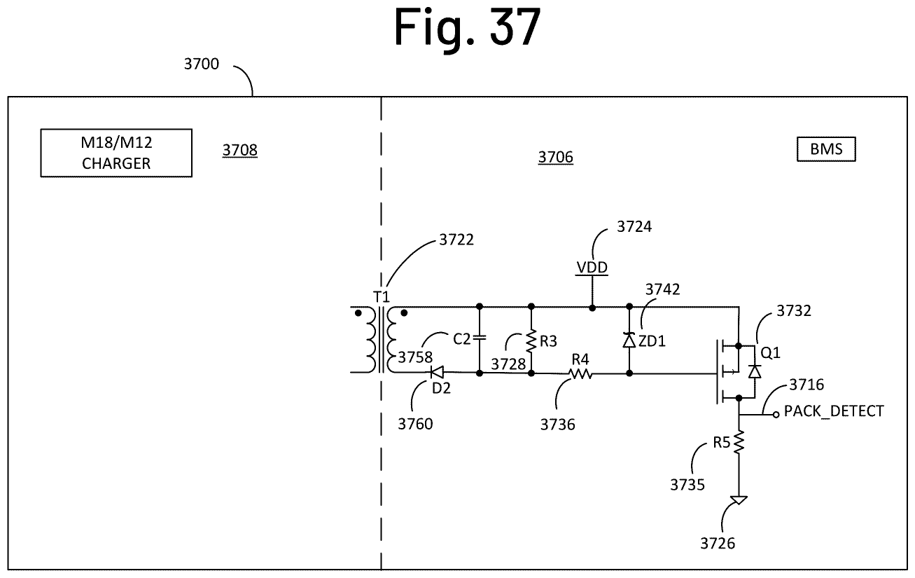

Configuration 3600 is shown in FIG. 36. This combines the BMS side circuitry from configuration 2300 with the battery pack charger side circuitry from configuration 3500. Q2 3640 could be an NPN BJT instead of an N-Channel MOSFET as shown in configuration 3600A in FIG. 36A. Corresponding common components among the embodiments are not described further, but are identified with a “36” identifier.

For any of configurations 2200, 2200A, 2200B, 2400, 2400A, 2400B, 2600, 2600A, 2600B, 2800, 2800A, 2800B, 2800C, 3000, 3000A, 3000B, 3000C, the variations of these by configurations 3200, 3300, and 3400, as well as configurations 3500 and 3500A, the BMS side circuitry could be replaced by that shown in FIG. 37, and the circuits would function equivalently.

The only differences are in the polarities of some voltages and the directions of some currents. For example, the battery pack detect signal on the battery pack detection signal line 3716 would idle at a logic low level and exhibit a brief logic high level pulse upon battery pack insertion. Corresponding common components among the embodiments are not described further, but are identified with a “37” identifier.

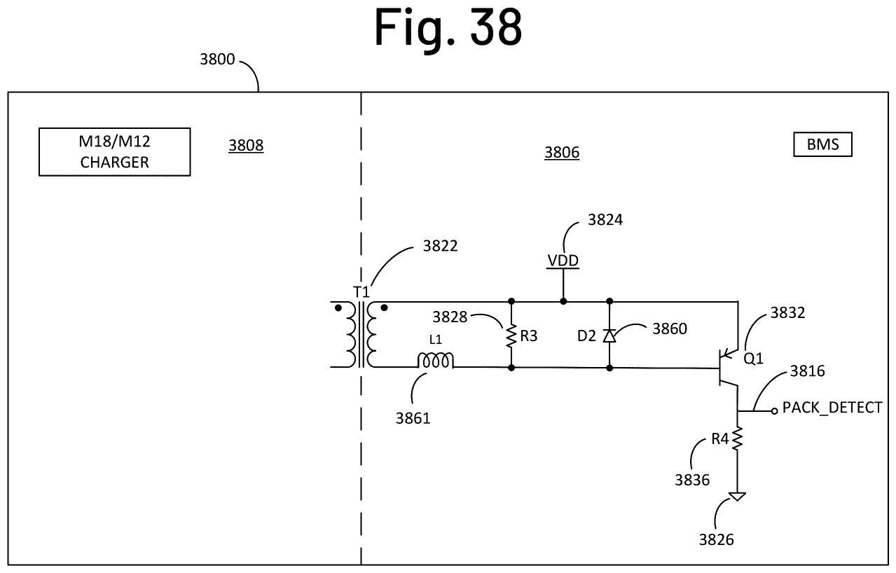

For any of configurations 2300, 2300A, 2300B, 2500, 2500A, 2500B, 2700, 2700A, 2700B, 2900, 2900A, 2900B, 2900C, 3100, 3100A, 3100B, 3100C, the variations of these by configurations 3200, 3300, and 3400, as well as configurations 3600 and 3600A, the BMS side circuitry could be replaced by that shown in the configuration 3800 of FIG. 38, and the circuits would function equivalently.

The only differences are in the polarities of some voltages and the directions of some currents. For example, the battery pack detect signal on the battery pack detection signal line 3816 would idle at a logic low level and exhibit a brief logic high level pulse upon battery pack insertion. Corresponding common components among the embodiments are not described further, but are identified with a “38” identifier.

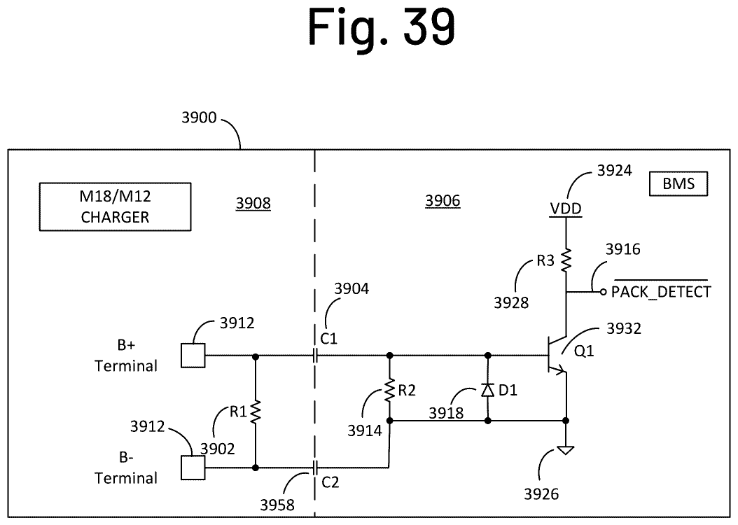

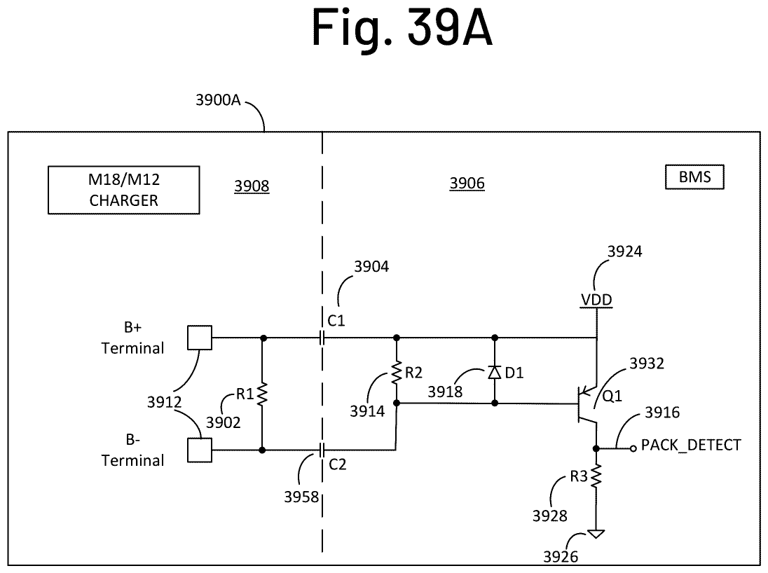

The first capacitor-based circuit configuration 3900 is shown in FIG. 39. R1 3902 is a resistor with a high impedance. Its purpose is to discharge the capacitors C1 3904 and C2 3958 when no battery pack is connected to the B+ and B− terminals. The high impedance limits current draw when a battery pack is connected to these terminals. C1 3904 and C2 3958 are capacitors that provide galvanic isolation between the battery pack charger 3908 side of the battery pack detection circuit 3900 and the BMS 3906 side of the battery pack detection circuit 3900. The insertion of a battery pack results in a rapid increase in the voltage across C1 3904 and C2 3958, causing a current to flow through C1 3904, Q1's 3932 base-emitter junction, and C2 3958. It is this current pulse that is communicated across the isolation barrier and turned into the battery pack detect signal by Q1 3932. R2 3914 helps to keep Q1 3932 in cutoff against minor voltage or current fluctuations. It also allows C1 3904 and C2 3958 to discharge below the forward voltage of D1 3918. D1 3918 provides a path for the current through C1 3904 and C2 3958 when they are being discharged. D1 3918 also prevents avalanche of Q1's 3932 base-emitter junction when the voltage across this junction goes negative during discharge of C1 3904 and C2 3958. Q1 3932 is an NPN BJT that amplifies the base current transmitted through C1 3904 and C2 3958 when they are charged after battery pack insertion into a larger collector current that flows through R4 3936 and decreases the voltage of the battery pack detect signal to a logic low level for a brief period of time after a pack has been inserted. R3 3928 is a pullup resistor that causes the voltage of the battery pack detect signal to idle at a logic high level (near VDD). R3 3928 also allows the voltage of the battery pack detect signal to be pulled to a logic low level by Q1 3932. VDD is the positive logic supply voltage 3924 within the BMS 3906. The common signal represents the negative logic supply voltage 3926 within the BMS 3906.

When the battery pack is inserted, the voltage across the battery pack appears between the B+ terminal and the B− terminal 3912. The battery pack's 200 voltage appears across C1 3904, the base-emitter junction of Q1 3932, and C2 3958. Because the impedance of this circuit is low, the voltage across C1 3904 and C2 3958 rises very quickly, causing a current pulse to flow through C1 3904, C2 3958, and the base-emitter junction of Q1 3932. Q1 3932 amplifies the current through its base-emitter junction and draws a larger current through its collector-emitter junction. This draws current through R3 3928, decreasing the voltage of the battery pack detect signal to a logic low voltage level that the BMS 3906 will register as a pack detected signal. Once C1 3904 and C2 3958 fully charge, no more current flows through C1 3904, C2 3958, R2 3914, or the base-emitter junction of Q1 3932. Q1 3932 turns off, the current flow through R3 3928 decreases to negligible levels, and the battery pack detect signal returns to its idle state logic high voltage level. The only current drawn from the battery pack is the small current through R1 3902.

After the battery pack is removed, the capacitors C1 3904 and C2 3958 discharge through R1 3902, R2 3914 and D1 3918 until the voltage across these capacitors is very low. The circuit has been reset and can detect the connection/insertion of another battery pack. To the extent that any circuit components are not explicitly described in detail with respect to these embodiments of the circuit, the same functions of those components as previously described can be attributed to such components. However, any such components have been renumbered to start with a “39”.

A PNP BJT can also be used for Q1 3932. This configuration 3900A is shown in FIG. 39A. Circuit operation is essentially equivalent to configuration 3900, except the polarities of some voltages are inverted, and the directions of some currents are reversed. Also, VDD is used as the voltage reference for the isolation capacitors on the BMS 3906 side instead of the BMS 3906 common voltage.

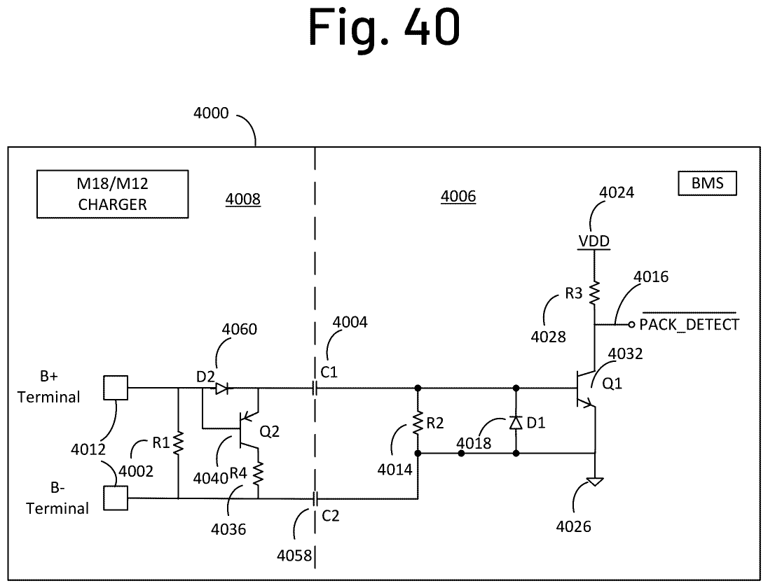

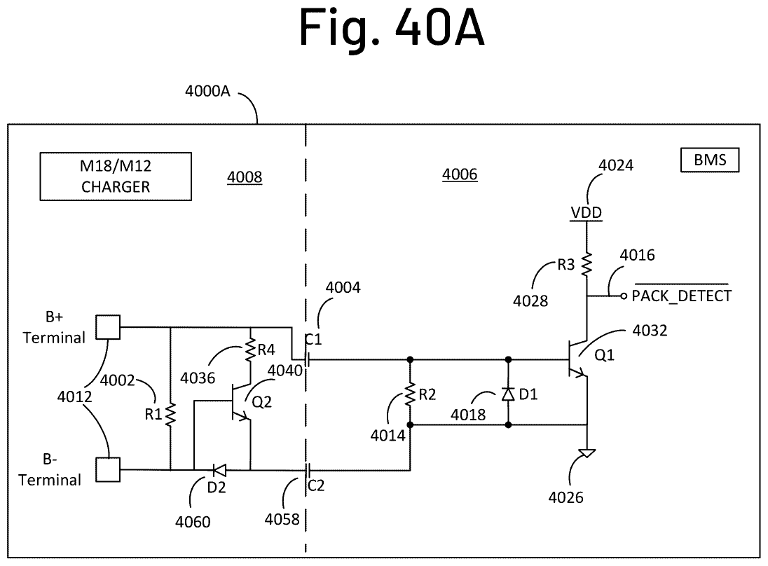

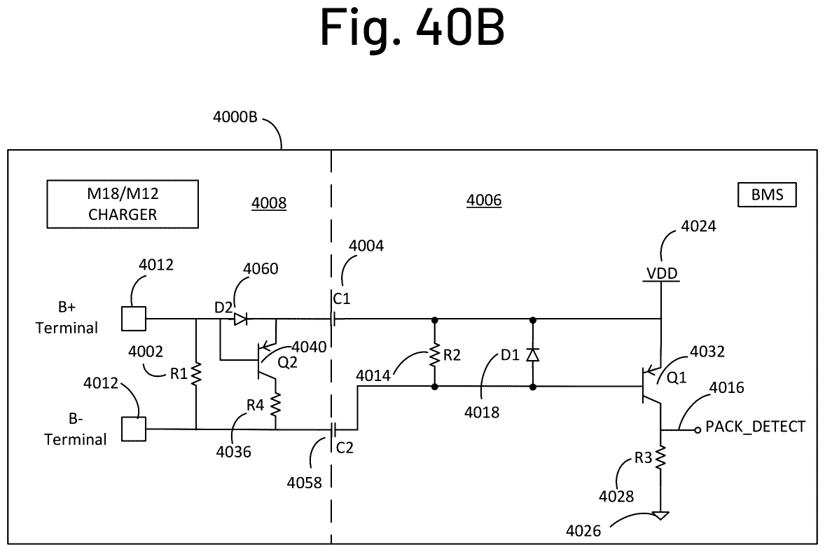

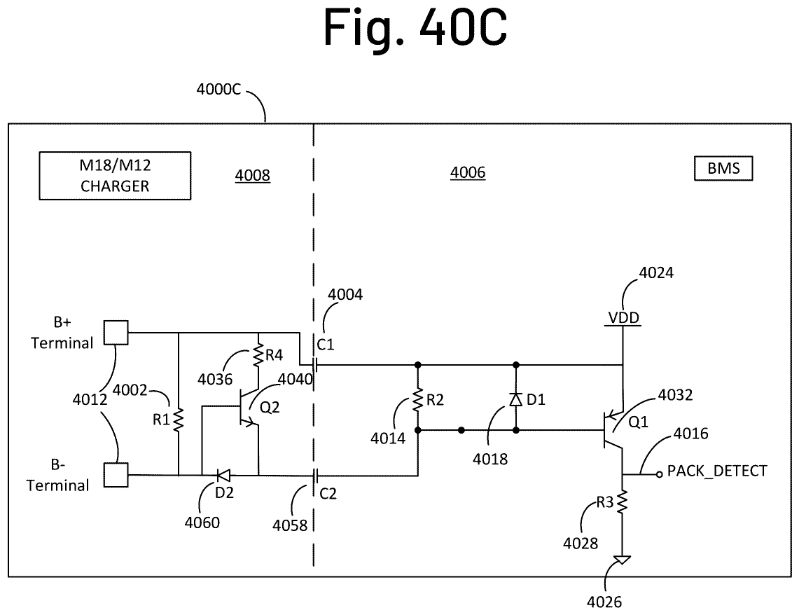

A second capacitor-based circuit configuration 4000 is shown in FIG. 40. It differs from configuration 3900 only by the addition of a fast discharge circuit for capacitors C1 4004 and C2 4058 on the charger side of the circuit. Q2 4040 is a PNP BJT that amplifies the portion of the C1 4004 and C2 4058 discharge current that flows through R1 4002 (and Q2's 4040 base-emitter junction) into a larger current that it causes to flow through its collector-emitter junction and through R4 4036. This causes C1 4004 and C2 4058 to discharge more quickly than configuration 3900. D2 4060 provides a path for current to flow through C1 4004 and C2 4058 when a battery pack is installed. D2 4060 also protects Q2's 4040 base-emitter junction from avalanche when a pack is installed. R4 4036 is an optional resistor that limits the maximum collector current of Q2 4040 when C1 4004 and C2 4058 are being discharged, if desired.

After the battery pack is removed, C1 4004 and C2 4058 begin to discharge. Some of the C1 4004 and C2 4058 discharge current flows through Q2's 4040 base-emitter junction. Q2 4040 has gain, which causes a much larger current to flow from C1 4004 and C2 4058 through Q2's 4040 collector-emitter junction and R4 4036. C1 4004 and C2 4058 quickly discharge until the voltage across them is approximately the base-emitter voltage of Q2 4040 plus the forward voltage of D1 4018. C1 4004 and C2 4058 discharge more slowly until the voltage across them is approximately the base-emitter voltage of Q2 4040. The circuit has been reset and can detect the connection/insertion of another battery pack. To the extent that any circuit components are not explicitly described in detail with respect to these embodiments of the circuit, the same functions of those components as previously described can be attributed to such components. However, any such components have been renumbered to start with a “40”.

The complement of the fast discharge circuit can be employed. This configuration 4000A is shown in FIG. 40A. Q2 4040 changes from a PNP BJT to an NPN BJT, the locations of Q2 4040, D2 4060, and R4 4036 change, but the operation of the circuit is essentially the same. Configuration 4000B of FIG. 40B combines the output circuit from configuration 3900A with the fast discharge circuit from configuration 4000. Configuration 4000C combines the output circuit from configuration 3900A with the fast discharge circuit from configuration 4000A. Corresponding common components among the embodiments are not described further, but are identified with a “40” identifier.

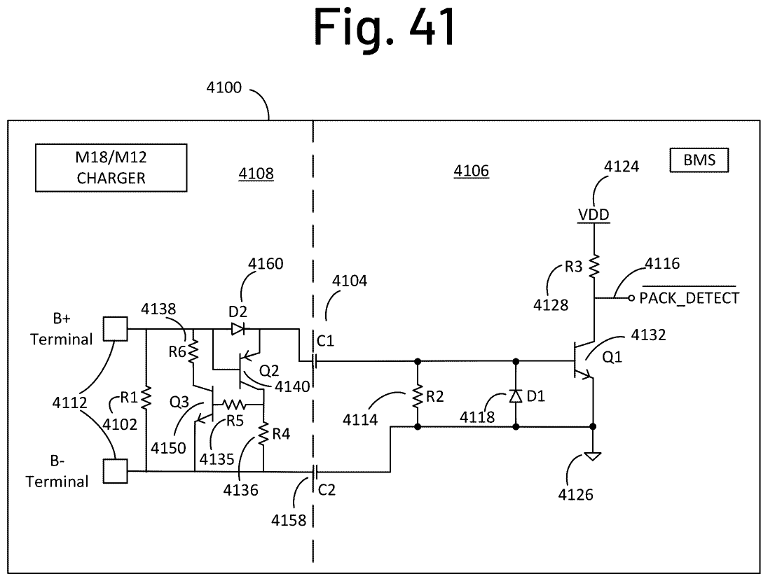

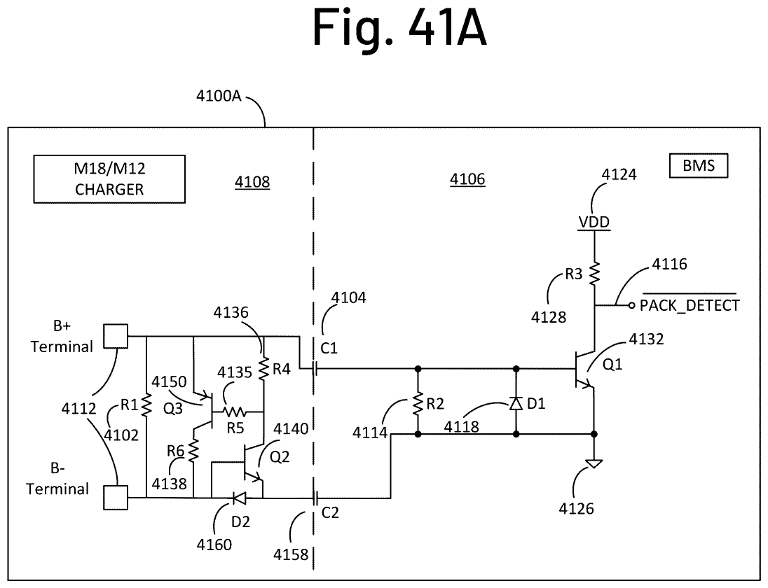

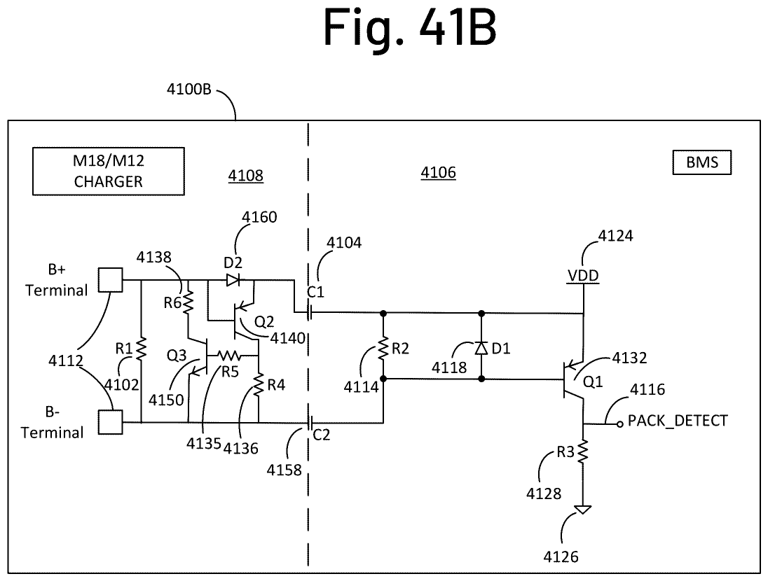

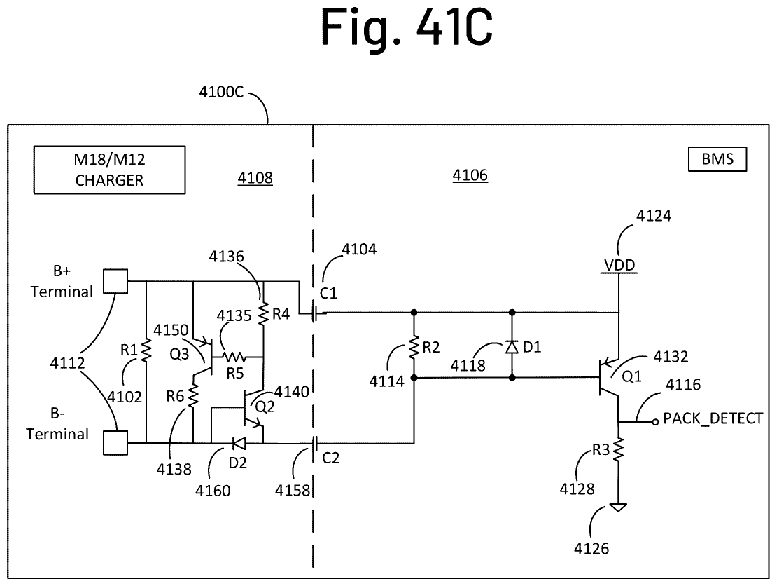

A third capacitor-based circuit configuration 4100 is shown in FIG. 41. It differs from configuration 3900 only by the addition of a very fast discharge circuit for capacitors C1 4104 and C2 4158 on the charger side of the circuit. Q2 4140 is a PNP BJT that amplifies the portion of the C1 4104 and C2 4158 discharge current that flows through R1 4102 (and the base emitter junction of Q2) into a larger current that it causes to flow through its collector-emitter junction and R5 4135 into Q3's 4150 base-emitter junction. Q3 4150 is an NPN BJT whose base is driven by Q2 4140 when C1 4104 and C2 4158 are being discharged. Q3 4150 amplifies its base current, drawing a much larger current from Q2's 4140 base through R6 4138 and Q3's 4150 collector. This forms a positive feedback loop between Q2 4140 and Q3 4150 that serves to rapidly increase the currents through these transistors and therefore to rapidly discharge C1 4104 and C2 4158. D2 4160 provides a path for current to flow through C1 4104 and C2 4158 when a battery pack is installed. D2 4160 also protects Q2's 4140 base-emitter junction from avalanche when a pack is installed. R4 4136 keeps Q3 4150 biased in cutoff against Q2's 4140 collector cutoff current when a battery pack is installed. R5 4135 limits the current into Q3's 4150 base when C1 4104 and C2 4158 are being discharged. R6 4138 limits the current drawn from Q2's 4140 base by Q3 4150 when C1 4104 and C2 4158 are being discharged.

After the battery pack is removed, C1 4104 and C2 4158 begin to discharge. Some of the C1 4104 and C2 4158 discharge current flows through Q2's 4140 base-emitter junction. Q2 4140 has gain, which causes a much larger current to flow from C1 4104 and C2 4158 through Q2's 4140 collector-emitter junction, R5 4135, and Q3's 4150 base-emitter junction. Q3 4150 also has gain. It amplifies the current driven through its base by Q2 4140, drawing a much larger current from Q2's 4140 base through Q3's 4150 collector. This forms a positive feedback loop between Q2 4140 and Q3 4150. The currents through these transistors rapidly increase until they are limited only by R5 4135, R6 4138, the saturation characteristics of Q2 4140 and Q3 4150, as well as the voltage across C1 4104 and C2 4158. C1 4104 and C2 4158 quickly discharge until the voltage across them is approximately the base-emitter voltage of Q2 4140/Q3 4150 plus the collector-emitter saturation voltage of Q3 4150/Q2 4140 plus the forward voltage of D1 4118. C1 4104 and C2 4158 discharge more slowly until the voltage across them is approximately the base-emitter voltage of Q2 4140/Q3 4150 plus the collector-emitter saturation voltage of Q3 4150/Q2 4140. At this point, the circuit has been reset and can detect the connection/insertion of another battery pack. To the extent that any circuit components are not explicitly described in detail with respect to these embodiments of the circuit, the same functions of those components as previously described can be attributed to such components. However, any such components have been renumbered to start with a “41”.

The complement of the very fast discharge circuit can be employed. This configuration 4100A is shown FIG. 41A. Q2 4140 changes from a PNP BJT to an NPN BJT, Q3 4150 changes from an NPN BJT to a PNP BJT, the locations of Q2 4140, D2 4160, Q3 4150, R4 4136, R5 4135, and R6 4138 change, but the operation of the circuit is essentially the same.

Configuration 4100B, shown in FIG. 41B, combines the output circuit from configuration 3900A with the very fast discharge circuit from configuration 4100. Corresponding common components among the embodiments are not described further, but are identified with a “41” identifier.

Configuration 4100C, shown in FIG. 41C, combines the output circuit from configuration 3900A with the fast discharge circuit from configuration 4100A. Corresponding common components among the embodiments are not described further, but are identified with a “41” identifier.

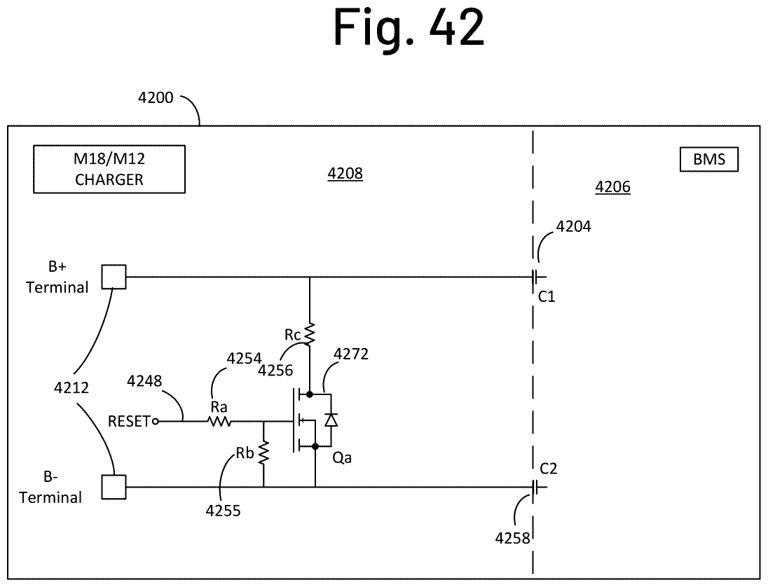

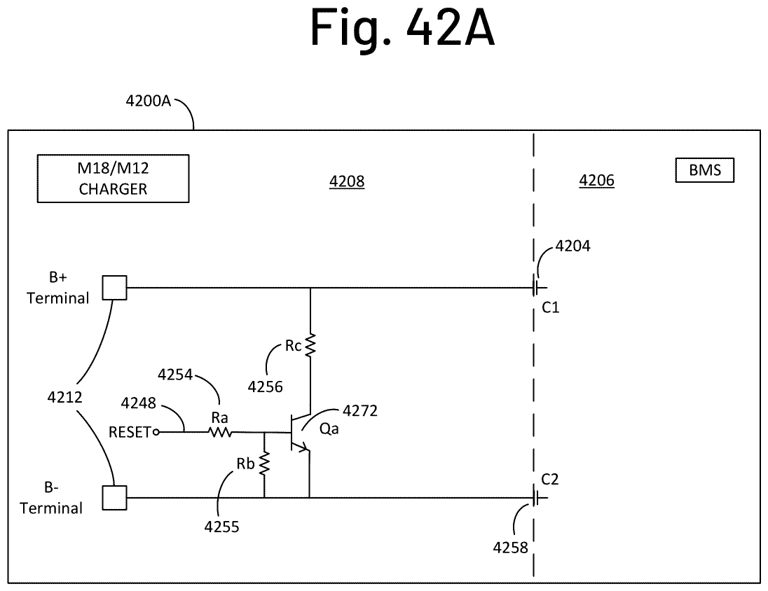

Capacitor circuit configuration 4200 is shown in FIG. 42. Only the battery pack charger 4208 side of the circuit is shown, and this configuration may be applied with any BMS 4206 side of a capacitor-based battery pack detection circuit described in this document.

Instead of automatically discharging C1 4204 and C2 4258 after a battery pack is removed, configuration 4200 requires that another circuit on the charger side actively generate a RESET signal that turns on Qa 4272 and discharges C1 4204 and C2 4258. This has the disadvantage of requiring the charger to be powered on but the advantage that Qa 4272 draws less leakage current from the pack than the R1 discharge resistor in other configurations while still permitting a quick reset of the battery pack detection circuit 4200. Qa 4272 is an N-Channel MOSFET that discharges C1 4204 and C2 4258 through R_{c} after its gate-source voltage is raised above the gate-source threshold voltage by the RESET signal. R_{c} is a resistor that limits the current through Qa's 4272 channel when Qa 4272 is turned on and discharges C1 4204 and C2 4258. Rb is an optional resistor that keeps Qa 4272 turned off against any leakage current from the circuit that generates the RESET signal. R a is a resistor that limits the current into Qa's 4272 gate should the voltage on the RESET signal quickly increase from a low voltage to a voltage high enough to enhance Qa's 4272 channel. The reset signal line 4248 is a voltage signal generated by circuitry within the battery pack charger 4208 that controls when the battery pack detection circuit 4200 is reset.

When the battery pack is inserted, the voltage on the RESET signal may be low enough to keep Qa 4272 in an off state. The only current drawn from the battery pack after C1 4204 and C2 4258 fully charge is the drain-source leakage current of Qa 4272. This is anticipated to be lower than the current drawn from the battery pack by R1 in configuration 3900. Once the insertion of the battery pack is detected, the BMS 4206 will power on the battery pack charger 4208 if permitted by the system logic. After the battery pack charger 4208 turns on and detects that the battery pack has been removed, a microcontroller 236 or other circuitry within the battery pack charger 4208 increases the voltage on the RESET signal high enough to enhance Qa's 4272 channel. Qa 4272 turns on and discharges C1 4204 and C2 4258 through R c. The voltage on C1 4204 and C2 4258 decreases to a very low level. The microcontroller 236 or other circuit sets the voltage of the RESET signal back to a near-zero level. At this point, the circuit has been reset and can detect the connection/insertion of another battery pack. To the extent that any circuit components are not explicitly described in detail with respect to these embodiments of the circuit, the same functions of those components as previously described can be attributed to such components. However, any such components have been renumbered to start with a “42”.

Qa 4272 could be an NPN BJT instead of an N-Channel MOSFET. The circuit operation is essentially equivalent. This configuration 4200A is shown in FIG. 42A.

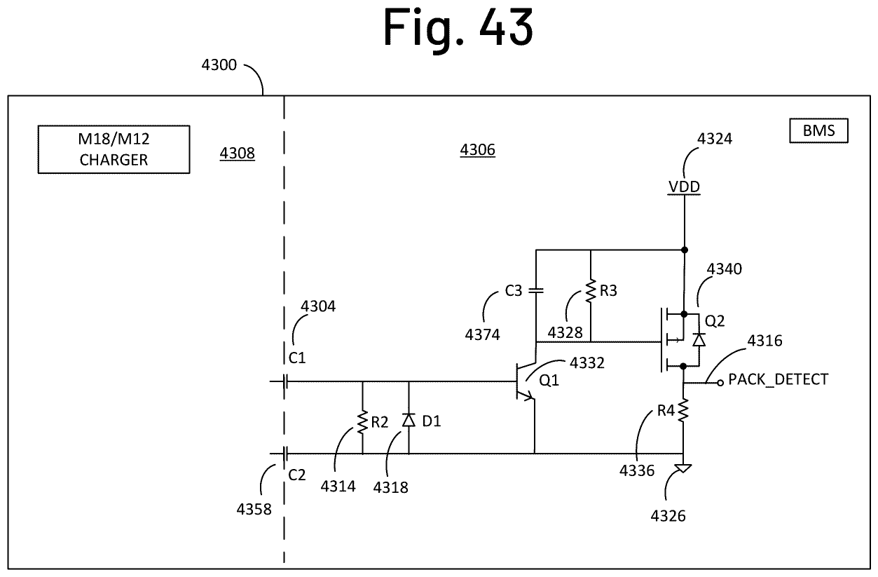

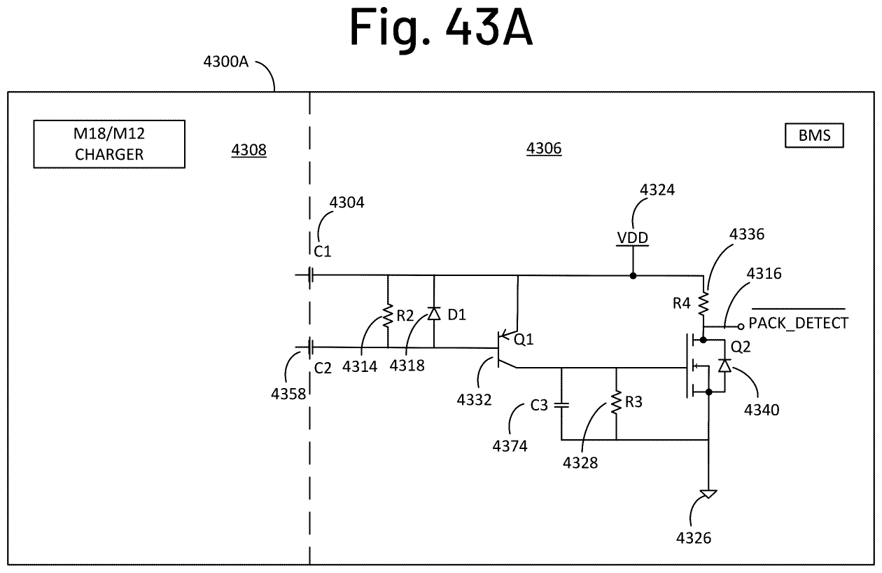

FIG. 43 shows a BMS 4306 side output circuit configuration that could be applied to any of the aforementioned capacitor circuit configurations as configuration 4300. C1 4304, C2 4358, R2 4314, D1 4318, and Q1 4332 function the same way as they do in configuration 3900. R3 4328 keeps Q2 4340 in an off state against the collector cutoff current of Q1 4332 and also discharges capacitor C3 (“C3”) 4374 in a designed period of time after Q1 4332 turns off, automatically resetting the BMS 4306 side of the circuit. C3 4374 is a capacitor that is charged by Q1 4332 when the current pulse due to battery pack insertion is flowing through C1 4304, C2 4358, and Q1 4332. C3 4374 keeps Q2 4340 turned on for longer than this current pulse persists, making the positive pulse on battery pack detect signal line 4316 longer and therefore easier to detect. R4 4336 is a pulldown resistor that causes the battery pack detect signal to idle at a logic low voltage level but also permits this signal to increase to a logic high voltage level when current flows through the channel of Q2 4340. Q2 4340 is a P-Channel MOSFET that closes when the voltage between its gate and source increases high enough to enhance Q2's 4340 channel.

When the battery pack is inserted, the current pulse through C1 4304, C2 4358, and Q1's 4332 base-emitter junction causes Q1 4332 to enter saturation, charging C3 4374 to VDD minus the collector-emitter saturation voltage of Q1 4332. The voltage from gate to source on Q2 4340 is now above the gate-source threshold voltage of Q2 4340, and it turns on, bringing the voltage of the battery pack detect signal on the battery detection signal line 4316 to logic high level, which the BMS 4306 interprets as a pack detection. The voltage across C3 4374 keeps Q2 4340 on for longer than the current pulse through Q1 4332 that charged C3 4374. This makes the battery pack detect signal easier to detect and the design of the overall circuit more flexible. R3 4328 eventually discharges C3 4374 below the gate-source threshold voltage of Q2 4340, Q2 4340 turns off, and the voltage of the battery pack detect signal returns to its idle state logic low level. To the extent that any circuit components are not explicitly described in detail with respect to these embodiments of the circuit, the same functions of those components as previously described can be attributed to such components. However, any such components have been renumbered to start with a “43”.

The complement of the configuration 4300 output circuit could also be used. This configuration 4300A is shown in FIG. 43A. The polarities of some voltages and the directions of some currents differ, but circuit operation is essentially unchanged. Also, VDD is used as the BMS 4306 side voltage reference for the isolation capacitors instead of the BMS 4306 common voltage.

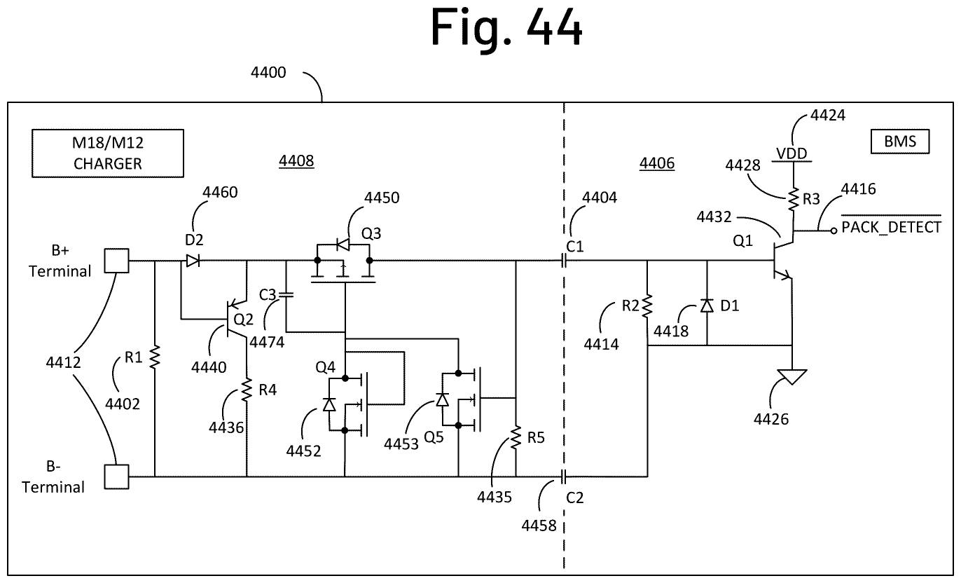

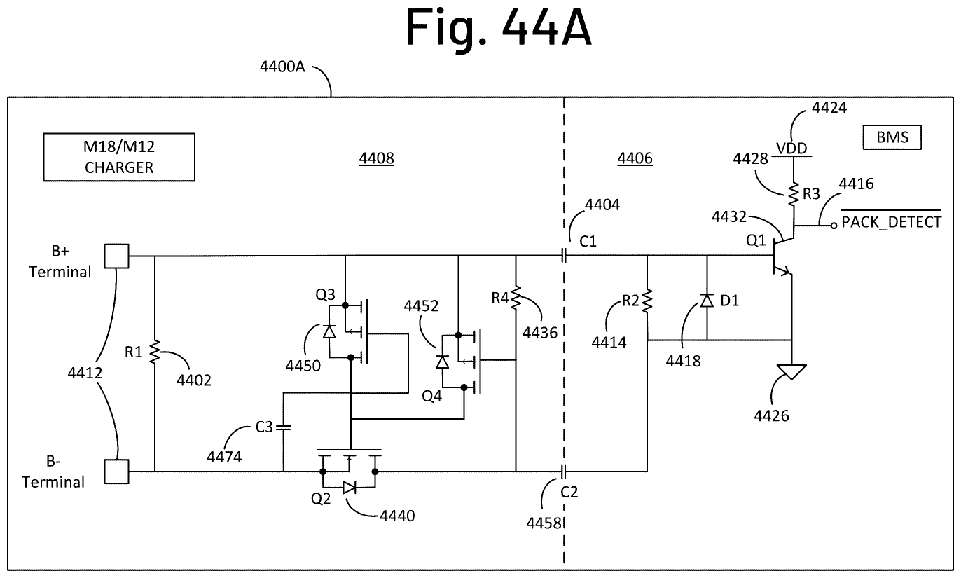

Any of the aforementioned capacitor-based circuit configurations could also apply a pulse shaping circuit in between (a) R1 4402 and any fast discharge circuit and (b) C1 4404 and C2 4458. Such a pulse shaping circuit is shown in FIG. 44 as it would be applied to configuration 4000. The pulse shaping network includes C3 4474, Q3 4450, Q4 4452, Q5 4453, and R5 4435. Its purpose is to apply a rapidly rising voltage pulse across C1 4404 and C2 4458 even if the voltage across the B+ and B− terminals 4412 rises slowly upon pack insertion due to dirty terminals, circuit inductance, or other factors.

Q3 4450 is a P-Channel MOSFET that blocks the application of voltage across C1 4404 and C2 4458 until the voltage from the battery pack has risen high enough to exceed the combined gate-source threshold voltages of Q3 4450 and Q4 4452. Q4 4452 is an N-Channel MOSFET connected in the diode-wired arrangement: its gate and drain are connected. This causes Q4 4452 to behave like a diode with anode at the combined gate/drain terminal, cathode at the source terminal, and forward voltage approximately the gate-source threshold voltage of the MOSFET when the voltage from gate/drain to source is positive. Q4 4452 raises the voltage across the B+/B− terminals 4412 at which Q3 4450 turns on. This voltage may be higher than the gate-source threshold voltage of Q5 4453 so the positive feedback loop between Q3 4450 and Q5 4453 begins as soon as Q3 4450 starts to turn on. C3 4474 is a capacitor with value significantly larger than the parasitic capacitances between Q3's 4450 gate terminal and the B− terminal. C3 4474 prevents Q3 4450 from turning on early by decreasing the amount of current that flows through Q3's 4450 gate to charge the aforementioned parasitic capacitances when the voltage across the B+ and B− terminals 4412 increases. Unlike a resistor, C3 4474 does not draw current long-term when a battery pack is installed. Q5 4453 is an N-Channel MOSFET whose gate-source voltage is increased when Q3 4450 begins to turn on. In turn, Q5 4453 increases Q3's 4450 gate-source voltage when Q5 4453 begins to turn on, forming a positive feedback loop between Q3 4450 and Q5 4453 that serves to rapidly increase the voltage applied across C1 4404 and C2 4458. The application of a rapidly rising voltage across these capacitors is accomplished via the pulse shaping circuit, as it increases the current pulse through these capacitors for a given value of capacitance. R5 4435 is a high impedance resistor that serves to keep Q5 4453 off against the drain-source leakage current of Q3 4450 before the voltage across the B+ and B-terminals has risen high enough to turn on Q3 4450. Alternatively, perhaps a capacitor could be used here as well, like C3 4474.

When the battery pack is connected/inserted, the voltage across the B+ and B-terminals 4412 increases. At some point, this voltage exceeds the combined gate-source threshold voltages of Q3 4450 and Q4 4452, causing Q3 4450 to turn on. The circuit will be designed such that the combined gate-source threshold voltages of Q3 4450 and Q4 4452 exceed the gate-source threshold voltage of Q5 4453. One way to do this is by using the same model transistor for Q4 4452 and Q5 4453. Consequently, once Q3 4450 begins to turn on, Q5's 4453 gate-source voltage will quickly exceed its threshold, turning on Q5 4453. This has the effect of increasing Q3's 4450 gate-source voltage, creating a positive feedback loop between Q3 4450 and Q5 4453 that rapidly increases the voltage across C1 4404 and C2 4458 to the voltage across the B+ and B− terminals 4412. To the extent that any circuit components are not explicitly described in detail with respect to these embodiments of the circuit, the same functions of those components as previously described can be attributed to such components. However, any such components have been renumbered to start with a “44”.

The complement of the pulse shaping circuit of configuration 4400 could also be used. This is shown as it would be applied to configuration 3900 in FIG. 44A. This configuration, so modified, is shown in FIG. 44A as configuration 4400A. N-Channel MOSFETs change to P-Channel MOSFETs and vice versa, the positions of the components change, some voltage polarities are inverted, the directions of some currents reverse, but the circuit operation is essentially unchanged.

It is contemplated that Q2 4440, Q3 4450, Q4 4452, and R4 4436 in configuration 4400A correspond to Q3 4450, Q4 4452, Q5 4453, and R5 4435 in configuration 4400, respectively. It is contemplated that multiple diode-wired MOSFETs (Q4 4452 in configuration 4400, Q3 4450 in 4400A) could be placed in series to increase the voltage at which the pass transistor (Q3 4450 in configuration 4400, Q2 4440 in 4400A) turns on, affording more flexibility in the choice of the feedback MOSFET (Q5 4453 in configuration 4400, Q4 4452 in configuration 4400A) and/or potentially increasing the rise rate of the voltage step across C1 4404 and C2 4458.

The discharge resistor R1 4402 in the aforementioned capacitor circuit configurations could be replaced by a constant current circuit made from JFETs, depletion mode MOSFETs, BJTs and resistors, current limiting diodes, or integrated circuits as described with respect to configurations 1400-1600 for optocoupler-based circuits and with respect to configurations 3200-3400 for transformer-based circuits.

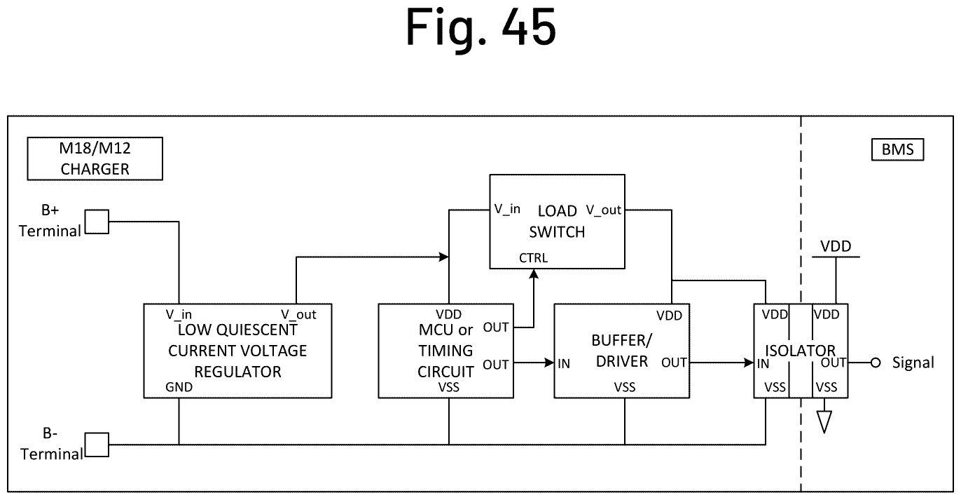

The general arrangement of other contemplated circuits is shown in FIG. 45 as a block diagram and may represent a circuit having the following components.

A low quiescent current voltage regulator circuit block is powered from the battery pack after it is installed and supplies a regulated output voltage to the other circuit blocks. It draws very little current from the battery pack to run its own internal circuitry and turns off when its input voltage drops below some level after the battery pack is removed.

An MCU 236 or timing circuit block is responsible to control the load switch (if installed), the buffer/driver (if installed), or possibly directly control the isolator to send a signal to the BMS 4406 for a brief period of time after it is initially supplied voltage from the voltage regulator after a battery pack is first installed. After sending the signal to the BMS 4406 for a brief period of time, the MCU 236 or Timing Circuit turns off all other circuits and drops to a low quiescent current state itself.

The load switch block is an optional circuit block that is used to disconnect the buffer/driver (if installed) and the isolator from the voltage regulator after the signal has been sent to the BMS 4406 so that these circuits do not draw additional quiescent current from the battery pack. The load switch may be omitted if the current draw from the buffer/driver and/or isolator is acceptable or if these circuits do not actually draw current from the voltage regulator.

The Buffer/Driver block is an optional circuit block that is used if the MCU 236 or Timing Circuit cannot directly drive the isolator circuitry. In that case, the Buffer/Driver amplifies the MCU 236 or Timing Circuit output and provides sufficient drive to the isolator circuitry.

The isolator block may be any means of conveying a signal across a voltage isolation barrier between two electronic circuits. Some examples include an Optocoupler/Optoisolator including an input including one or more LEDs, an input including circuitry mimicking the behavior of an LED, an input including digital or integrated circuits in various forms, and an output via phototransistor, an output via photodiode plus phototransistor, an output via Darlington transistor, an output via photodiode, an output via photo FET, an output via MOSFET, an output via photovoltaic, an output via photoresistor, an output via digital or integrated circuits. Another example includes a transformer configured to transmit a voltage pulse, or configured to transmit an AC signal. Another example includes capacitor(s) configured to transmit a current pulse by ramping voltage across capacitors or configured to send an AC signal through on or more capacitors. Another example includes a relay such as a spring loaded electromechanical relay, a reed relay, a latching relay, or a solid state relay. Yet another example includes transmitting acoustic signals through an electrically insulating medium, including acoustic signals of ultrasonic or infrasonic frequency. Another example includes, transmitting mechanical shock (such as from a solenoid) through an electrical insulator to be picked up by a suitable sensor, such as a piezoelectric element or accelerometer. Another example includes transmitting a radio frequency signal through an electrically insulating medium. Other examples include transmitting thermal energy through a thermally conductive electrical insulator. For example, an electrically controlled heating element on the battery pack charger side may transmit heat to a temperature sensing element (including thermal switch) on the BMS 4406 side. A thermally conductive material that is also electrically insulating, such as mica, silicone, alumina, aluminum nitride, beryllium oxide, glass, and others, may connect the heating element and the temperature sensing element.

While not shown in FIG. 45, various circuitry may be used to receive the signal sent over the isolation barrier within the BMS subsystem. The circuitry would depend upon the nature of the isolator component, the length of the signal pulse, and so forth. Note that, if the MCU or timing circuit in FIG. 45 is implemented with an MCU, this may be a separate MCU from the MCU 236 in the battery charger subsystem.

When the battery pack is inserted, the voltage across the battery pack appears between the B+ terminal and the B− terminal. Once the voltage across the B+ and B− terminals is high enough to start up the voltage regulator, it outputs some voltage to the MCU or Timing Circuit and to the Load Switch (if installed). The MCU or Timing Circuit then modulates its output signals to perform the following tasks, ultimately resulting in a signal being sent across the isolation barrier to the BMS for a defined period of time. The load switch (if installed) is turned on in order to power the buffer/driver (if installed) and the isolator (if powered by the load switch). The buffer/driver (if installed) or the isolator are controlled to transmit a signal to the BMS for a defined period of time. Subsequently, the MCU or Timing Circuit modulates its output signals to set the buffer/driver (if installed) to a low current state, set the Isolator to a low current state (if directly controlled by the MCU), turn off the load switch (if installed), and finally to put its own circuitry in a low current state, minimizing current draw from the battery pack.

After the battery pack is removed, the voltage across the B+ and B− terminals decreases. Once it drops below some threshold, the voltage regulator turns off. The circuit has been reset and can detect the connection/insertion of another battery pack.

In some embodiments, the power supply 100 is configured to provide output power (e.g., from the battery core) until the battery core reaches a low-voltage cutoff threshold. In embodiments where the power supply 100 receives removable and rechargeable battery packs, the battery packs that are used to provide output power from the power supply can be similarly discharged until reaching low-voltage cutoff thresholds.

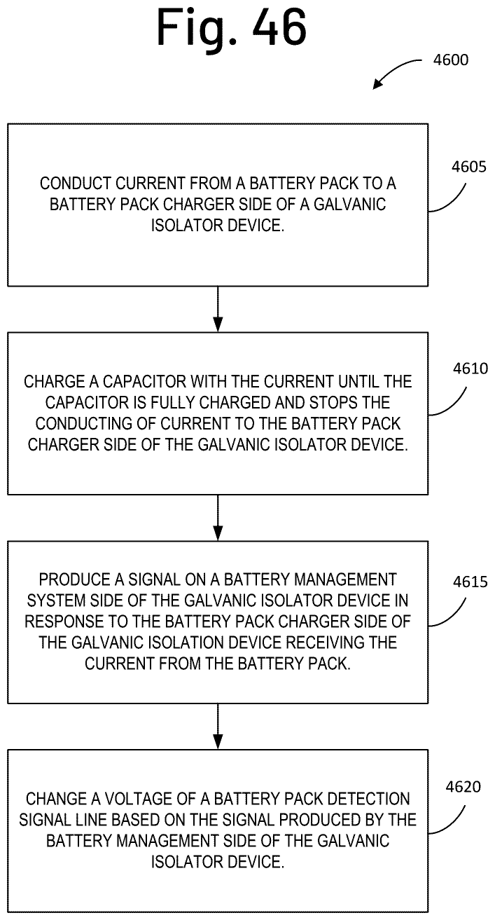

FIG. 46 is a flow chart illustrating the process 4600 for generation of a battery detect logic signal in response to a battery pack being connected to a charging port 338, 340 of the power supply 100.

At block 4605, a battery pack is connected to the terminals of the power supply 100. Current is conducting from the battery pack to a battery pack charger side of a galvanic isolator device (e.g., optocoupler 422, transformer 2222, or capacitor pair 3904 and 3958).

At block 4610, a battery management system side of the galvanic isolator device produces a signal in response to the battery charger side of the galvanic isolation device receiving the current from the battery pack.

At block 4615, a capacitor (e.g., C1 404) on the battery pack charger side of the galvanic isolator device is charged with the current until the capacitor is fully charged and stops the conducting of current to the battery pack charger side of the galvanic isolator device.

At block 4620, a voltage of a battery pack detection signal line is change based on the signal produced by the battery management side of the galvanic isolator device, the change in voltage indicating to the BMS (e.g., BMS 406) that a battery pack connection is detected.

Thus, embodiments described herein provide, among other things, a method of detecting the connection of a battery pack to a portable power supply. Various features and advantages are set forth in the following claims.

What is claimed is:

1. A portable power supply comprising:
a housing;
a control area network (“CAN”) bus disposed in the housing;
a battery core disposed in the housing and configured to be charged by a battery core charger;
a battery pack charger connected to the battery core via a power line and to the CAN bus via a galvanic isolation barrier, the battery pack charger including one or more charging modules;
a battery management system connected to the battery pack charger via the CAN bus and the power line and configured to control an operation of the battery pack charger and the battery core charger; and
a battery pack detection circuit connected to one or more charging ports of the one or more charging modules, the battery pack detection circuit configured to draw current from a battery pack connected the one or more charging ports and produce a battery pack detection signal at the battery management system via a galvanic isolation device,
wherein the battery pack charger is disposed on a battery pack charger side of the galvanic isolation device, and
wherein the battery management system is disposed on a battery management system side of the galvanic isolation device.

2. The portable power supply of claim 1, wherein the galvanic isolation device is an optocoupler.

3. The portable power supply of claim 1, wherein the galvanic isolation device is a transformer.

4. The portable power supply of claim 1, wherein the galvanic isolation device includes at least two capacitors.

5. The portable power supply of claim 1, wherein the battery management system side includes:
a transistor including a collector, a base, and an emitter; and
a positive logic supply voltage connected to a battery pack detection signal line and to the collector of the transistor.

6. The portable power supply of claim 5, wherein the battery management system side of the galvanic isolation device is configured to a produce a signal accepted by the base of the transistor in response to a battery pack charger side of the galvanic isolation device receiving current from the battery pack.

7. The portable power supply of claim 6, wherein:
a voltage of the battery pack detection signal line changes in response to the base of the transistor receiving the signal produced by the battery management system side of the galvanic isolation device; and
the change of the voltage of the battery pack detection signal line indicates to a battery management system that a battery is detected.

8. A battery detection circuit comprising:
a galvanic isolation device including a first side and a second side;
a battery management system side connected to the first side; and
a battery pack charger side connected to the second side, the battery pack charger side including:
a low quiescent voltage regulator,
a timing circuit,
a load switch, and
a driver.

9. The battery detection circuit of claim 8, wherein the galvanic isolation device is an optocoupler.

10. The battery detection circuit of claim 8, wherein the galvanic isolation device is a transformer.

11. The battery detection circuit of claim 8, wherein the galvanic isolation device includes at least two capacitors.

12. The battery detection circuit of claim 8, further comprising a diode connected antiparallel with the galvanic isolation device.

13. The battery detection circuit of claim 8, wherein the timing circuit is configured to control the load switch to change a voltage of a battery detection signal line in response to a battery being connected to the battery pack charger side of the battery detection circuit.

14. The battery detection circuit of claim 13, wherein the change of the voltage of the battery pack detection signal line indicates to a battery management system that a battery is detected.

15. A method of detecting a connection of a battery pack to a portable power source, the method comprising:
conducting a flow of current from a battery pack to a battery pack charger side of a galvanic isolator device;
charging a capacitor with the current until the capacitor is fully charged and stops the flow of current to the battery pack charger side of the galvanic isolator device;
producing a signal on a battery management system side of the galvanic isolator device in response to the battery pack charger side of the galvanic isolation device receiving the current from the battery pack; and
changing a voltage of a battery pack detection signal line based on the signal produced by the battery management system side of the galvanic isolator device.

16. The method of claim 15, wherein the galvanic isolation device is an optocoupler.

17. The method of claim 15, wherein the galvanic isolation device is a transformer.

18. The method of claim 15, wherein the galvanic isolation device includes at least two capacitors.

19. The method of claim 15, wherein the battery management system side includes:
a transistor including a collector, a base, and an emitter; and
a positive logic supply voltage connected to a battery pack detection signal line and to the collector of the transistor.

20. The method of claim 19, wherein:
a voltage of the battery pack detection signal line changes in response to the base of the transistor receiving the signal produced by the battery management system side of the galvanic isolation device; and
the change of the voltage of the battery pack detection signal line indicates to a battery management system that a battery is detected.
